(19) United States
(12) Patent Application Publication
(10) Pub. No.: US 2026/0276932 A1
(43) Pub. Date: Sep. 17, 2026

(54) SYSTEM AND METHOD FOR CONFIGURATION OF DATACENTER INFRASTRUCTURE

(71) Applicant: Oracle International Corporation, Redwood Shores, CA (US)

(72) Inventors: Suzanne Fendley Hunter, Chester, SC (US); Samuel Kevin Wooten, Rock Hill, SC (US); Panagiotis Diamantis, Chicago, IL (US); Joshua Michael Buzzell, Providence Forge, VA (US); Jagwinder Singh Brar, Bellevue, WA (US); David Dale Becker, Seattle, WA (US)

(73) Assignee: Oracle International Corporation, Redwood Shores, CA (US)

(21) Appl. No.: 19/562,428

(22) Filed: Mar. 10, 2026

Related U.S. Application Data
(60) Provisional application No. 63/770,722, filed on Mar. 12, 2025.
(60) Provisional application No. 63/779,648, filed on Mar. 28, 2025.
(60) Provisional application No. 63/875,810, filed on Sep. 4, 2025.
(60) Provisional application No. 63/890,983, filed on Sep. 30, 2025.
(60) Provisional application No. 63/891,452, filed on Oct. 1, 2025.
(60) Provisional application No. 63/948,246, filed on Dec. 24, 2025.

(51) Int. Cl. G02B 6/44; G02B 6/255

(52) U.S. Cl. CPC G02B 6/44526; G02B 6/255; G02B 6/443

(57) ABSTRACT

A datacenter includes multiple isolated datahalls, each housing a distinct set of computing devices. Structured cabling trunks interconnect these devices along predefined paths. The datahalls (e.g., DH1, DH2, DH3) can be physically isolated from each other. A first set of cabling trunks extends along a predefined path through datahall DH1, between datahalls DH1 and DH2, and within datahall DH2, for interconnecting the devices therein. A second set of cabling trunks extend along a predefined path through datahall DH3, between datahalls DH1 and DH3, and within datahall DH1, for interconnecting the devices therein. A third set of cabling trunks extend along a predefined path through datahall DH3, between datahalls DH2 and DH3, and within datahall DH2, for interconnecting the devices therein. This pre-defined cabling architecture enhances datacenter scalablability, and optimizes physical and logical separation while supporting flexible network configurations.

### CROSS-REFERENCES TO RELATED APPLICATIONS

This application claims the benefit of the filing dates of the following U.S. Provisional Application No. (i) 63/770,722, filed on Mar. 12, 2025; (ii) 63/779,648 filed on Mar. 28, 2025; (iii) 63/875,810, filed on Sep. 4, 2025; (iv) 63/890,983, filed on Sep. 30, 2025; (v) 63/891,452, filed on Oct. 1, 2025; (vi) 63/948,246, filed on Dec. 24, 2025, the contents of each being incorporated herein in its entirety for all purposes.

### FIELD OF DISCLOSURE

The present disclosure is related to datacenter and cloud computing infrastructure. More specifically, techniques are described for configuration of large datacenters including placement of computing units (e.g., GPUs, CPUs), switching units, etc., and cabling between them.

### BACKGROUND

Exponential increase in cloud computing needs has driven significant expansion in cloud infrastructure. Organizations continue to move business applications and databases to the cloud to reduce the cost of purchasing, updating, and maintaining on-premise hardware and software. High performance compute applications consistently consume all of the available compute power to achieve a specific outcome or result. Such applications require dedicated network performance, fast storage, high compute capabilities, and significant amounts of memory-resources that are in short supply in the virtualized infrastructure that constitutes today's commodity clouds.

Cloud infrastructure service providers that build cloud infrastructures (e.g., including datacenters) are facing significant challenges when scaling the cloud infrastructure. For example, it is challenging to accommodate both scale and technological complexity of the underlying cloud infrastructure. High compute demand causes an exponential increase in the number of processing, data transmission, communication, and other equipment. As such, inefficient datacenter design can impact not only scalability, operational efficiency, and maintenance overhead but also the overall reliability and performance of the cloud infrastructure.

### SUMMARY

The present disclosure relates to configuration of datacenter with high performance compute fabrics (e.g., GPU fabrics). Specifically, the present disclosure relates to mechanisms for achieving scalability of such high performance compute fabrics. Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the detailed description section, and further description is provided therein.

The foregoing, together with other features and embodiments will become more apparent upon referring to the following specification, claims, and accompanying drawings.

### BRIEF DESCRIPTION OF THE DRAWINGS

Various embodiments in accordance with the present disclosure will be described with reference to the drawings, in which:

FIG. 1 is a high level diagram of a distributed environment showing a virtual or overlay cloud network hosted by a cloud service provider infrastructure according to certain embodiments.

FIG. 2 depicts a simplified architectural diagram of the physical components in the physical network within CSPI according to certain embodiments.

FIG. 3 shows an example arrangement within CSPI where a host machine is connected to multiple network virtualization devices (NVDs) according to certain embodiments.

FIG. 4 depicts connectivity between a host machine and an NVD for providing I/O virtualization for supporting multitenancy according to certain embodiments.

FIG. 5 depicts a simplified block diagram of a physical network provided by a CSPI according to certain embodiments.

FIG. 6 illustrates a block diagram of a data center layout, according to various embodiments.

FIG. 7 illustrates an example layout of a datacenter, according to various embodiments.

FIG. 8 illustrates detail of an example layout of a pod within the datacenter of FIG. 7.

FIG. 9 illustrates an overview of an example network fabric NA cabling within the datacenter of FIG. 7.

FIG. 10 illustrates details of an example network fabric NA network cabling within a first datahall and between two datahalls of the datacenter of FIG. 7.

FIG. 11 illustrates details of an example network fabric NA network cabling between three datahalls of the datacenter of FIG. 7.

FIG. 12 illustrates an overview of an example network fabric NB cabling within the datacenter of FIG. 7.

FIG. 13 illustrates details of an example network fabric NB network cabling within a first datahall and between two datahalls of the datacenter of FIG. 7.

FIG. 14 illustrates an example cable used for cabling within the datacenter of FIG. 7.

FIG. 15 illustrates another example layout of a datacenter, according to various embodiments.

FIG. 16 is a block diagram illustrating one pattern for implementing a cloud infrastructure as a service system, according to at least one embodiment.

FIG. 17 is a block diagram illustrating another pattern for implementing a cloud infrastructure as a service system, according to at least one embodiment.

FIG. 18 is a block diagram illustrating another pattern for implementing a cloud infrastructure as a service system, according to at least one embodiment.

FIG. 19 is a block diagram illustrating another pattern for implementing a cloud infrastructure as a service system, according to at least one embodiment.

FIG. 20 is a block diagram illustrating an example computer system, according to at least one embodiment.

FIG. 21 illustrates an overview of an example network connection between a compute node, leaf switches, and spine switches using shuffle cables, according to various embodiments.

FIG. 22 illustrates an example shuffle cable, according to various embodiments.

FIG. 23 illustrates an example cable harness including multiple shuffle cables of FIG. 22.

FIG. 24 illustrates a host machine NIC into divided a plurality of sub-interfaces, according to various embodiments.

FIG. 25 is schematic of connection between host machine NICs of FIG. 24, leaf switches, and spine switches using the shuffle cables of FIG. 22, according to various embodiments.

FIG. 26 illustrates an example connection between a host machine NIC of FIG. 24, and leaf switches using patch panels and the shuffle cables of FIG. 22, according to various embodiments.

FIG. 27 illustrates an example connection between leaf switches and spine switches using patch panels and the shuffle cables of FIG. 22, according to various embodiments.

FIG. 28 illustrates an example backend network fabric, according to various embodiments.

FIG. 29 illustrates an example of interconnectivity between switches in two different buildings using an optical circuit switch (OCS), according to various embodiments.

FIG. 30 illustrates an overview of an example interconnectivity between switches in different buildings using optical circuit switches located in two different buildings, according to various embodiments.

FIG. 31 illustrates an example port configuration of optical circuit switches to facilitate interbuilding connectivity, according to various embodiments.

FIG. 32 illustrates a detailed view of an example interconnectivity between T1-tier switches located in different buildings via optical circuit switches located in different buildings, according to various embodiments.

FIG. 33 illustrates an example cabling path between T1-tier switches using an optical circuit switch and patch panels, according to various embodiments.

FIG. 34 illustrates an example cabling path between T1-tier switches using MPO/MMC panels and without using an optical circuit switch, according to various embodiments.

FIG. 35 illustrates an example cabling path between T1-tier switches using MPO/MMC panels and without using an optical circuit switch, according to various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs. In the present disclosure, counts of planes, racks, switches, optics, strands, numbers associated with other elements, are illustrative examples and not limiting.

Advancements in technology has exponentially increased the computing demand from datacenters. As such, the number of computing devices such as servers, graphic processing units (GPUs), computer processing units (CPUs), or other types of processors that should be communicably coupled to each other has increased significantly. Building datacenters with higher number of computing devices demand advanced planning of building layout, datacenter layout, cabling, thermal management systems, and other datacenter systems. Unplanned datacenters can significantly impact energy efficiencies, and data loss. Particularly, when multiple datahalls are connected using cables, the amount of cables, a length of the cables, routing between different computing devices or other factors should be considered.

In existing datacenters, all the equipment (e.g., GPUs, switches, thermal management systems, etc.) are fixed in a single room and connected to each other by adhoc cabling. However, to meet the increasing demand for computing, the equipment including computing devices need to be distributed across multiple rooms or isolated areas. This separation creates several new issues related to connecting the computing devices across different room. For example, a cabling related issue arise. Running long distance cables between different rooms can increase data loss, reduce overall energy efficiency of the datacenter, increase maintenance, or other costly issues using exiting structured or unstructured cabling. Hence, the present disclosure provides a hybrid cabling structure for advanced data centers.

The present disclosure is related to cloud computing. More specifically, techniques are described for building large datacenters including placement of computing units (e.g., GPUs, CPUs), switching units, etc., and cabling between them. The techniques herein can reduce signal loss, make accommodations for power and thermal management systems, provide organized cabling so as to minimize points of failures, and improve reliability and availability of overall datacenter.

The present disclosure provides example datacenter layouts and low-loss cable management to improve energy efficiencies, data transfer rates, and low data loss. For example, the datacenter layout, and cabling herein can reduce dB loss in fiber channel between two devices over a long distance. Shuffle cables can be utilized to expand the radix to avoid having to have an additional tier of switches.

In some embodiments, the data center configuration can involve design and implementation of cabling infrastructure, network fabrics, structural and logical positioning of computing equipment, among others. In some embodiments, the cabling infrastructure can serve as a backbone for data transmission and communication among servers, storage units, switches, and other data center components. The cabling infrastructure within a data center can be broadly categorized as either structured or unstructured. Structured cabling refers to an organized approach involving pre-defined pathways, patch panels, and modular components that facilitate easier management, scalability, and troubleshooting. Unstructured (or “point-to-point”) cabling involves in ad hoc cable runs between devices, which can lead to increased risk of tangling, signal interference, and difficulty in maintenance as the system scales. As data centers continue to grow in both size and complexity, management of cabling systems becomes increasingly important, impacting not only operational efficiency and maintenance overhead but also the overall resilience and performance of the cloud infrastructure.

The present disclosure provides data center assemblies and layouts including multiple datahalls separated from each other, and cabling infrastructure within a particular datahall, as well as between different datahalls. In some embodiments, the cabling infrastructure of a data center assembly may be driven by various factors such as network fabric design, data loss (e.g., dB loss) in cables between different devices over a long distance, number of switches and their locations, among others. In some embodiments, a datacenter assembly or layout can include configuration of a datahall, and cabling therein. In some embodiments, a data center assembly or layout can include multiple datahalls that are physically isolated from each other, and cabling infrastructure to facilitate communication between two or more datahalls.

In some embodiments, a datahall configuration can include configuration of a set of compute racks and switches with strategically assigned locations within the datahall. In some embodiments, the cabling infrastructure can include pre-defined cabling paths between a set of compute racks, and switches strategically distributed within a datahall. In some embodiments, the cabling infrastructure can include configuration of pre-defined cabling paths between computer racks and switches distributed across different datahalls, cabling support structures, different types of cables, and other cabling related components and their placements.

The data center assemblies and associated cabling infrastructures herein provide several advantages. For example, the cabling and network designs herein optimize fiber network infrastructure by reducing signal loss (e.g., dB loss) and costs through splicing fiber trunks instead of relying on connectors. Such cabling can facilitate more reliable, high-speed data transmission for high-performance computing. Additionally, splicing fibers enable sourcing of fiber optic cables from multiple vendors thereby offering greater flexibility and cost efficiency. As such, networks can be scaled easily without being tied to one supplier, making the data center more adaptable for growing infrastructure needs. As another example, shuffle cables herein are customized to maximize the use of network infrastructure, allowing expansion of high-performance computing clusters without expensive new hardware.

Furthermore, various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

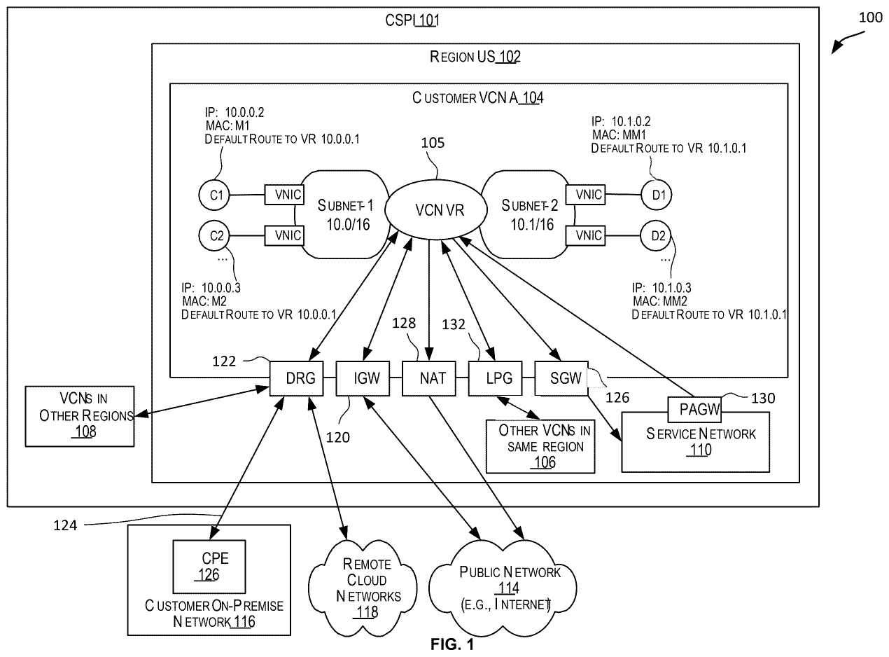

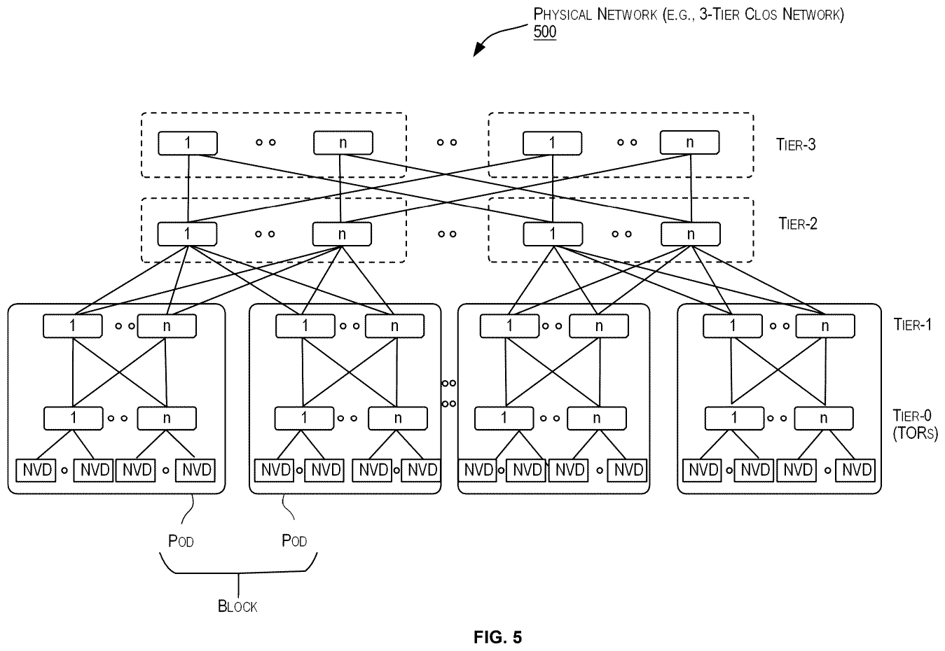

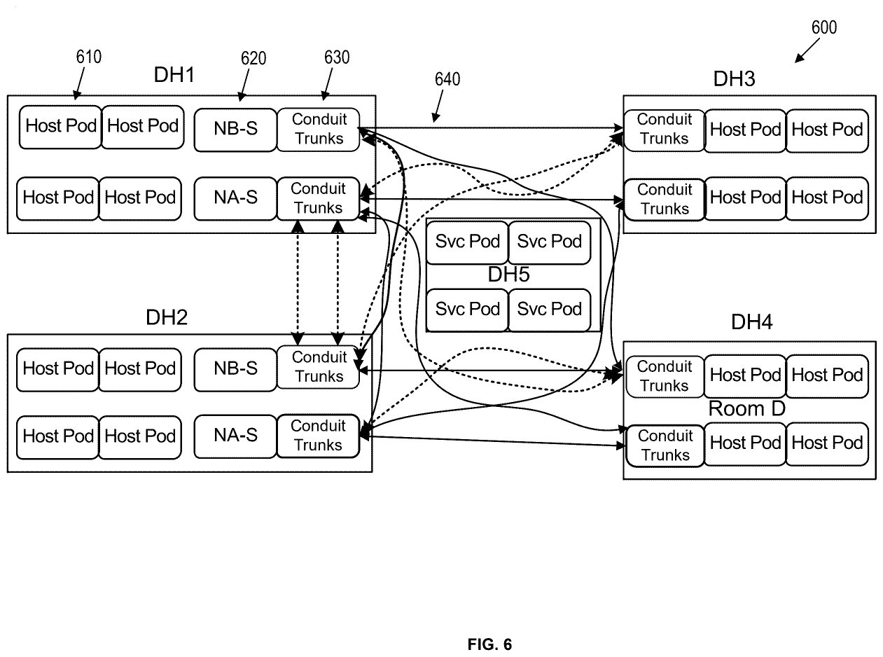

FIGS. 1-5 and the associated description provided in the “Example Virtual Networking Architecture” section below describe networking concepts including network virtualization, substrate networks, overlay networks, VNICs, etc., and provide examples of environments in which certain embodiments described in this disclosure may be implemented. FIGS. 6-7, and 15 describe examples and embodiments related to data center layouts and network designs described in this disclosure. FIGS. 1-4 depict examples of architectures for implementing cloud infrastructures for providing one or more cloud services, where the infrastructures may incorporate teachings described herein. FIG. 5 depicts a block diagram illustrating an example computer system or device, according to at least one embodiment.

### Example Virtual Networking Architecture

The term cloud service is generally used to refer to a service that is made available by a cloud services provider (CSP) to users or customers on demand (e.g., via a subscription model) using systems and infrastructure (cloud infrastructure) provided by the CSP. Typically, the servers and systems that make up the CSP's infrastructure are separate from the customer's own on-premise servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services.

There are several cloud service providers that offer various types of cloud services. There are various different types or models of cloud services including Software-as-a-Service (SaaS), Platform-as-a-Service (PaaS), Infrastructure-as-a-Service (IaaS), and others.

A customer can subscribe to one or more cloud services provided by a CSP. The customer can be any entity such as an individual, an organization, an enterprise, and the like. When a customer subscribes to or registers for a service provided by a CSP, a tenancy or an account is created for that customer. The customer can then, via this account, access the subscribed-to one or more cloud resources associated with the account.

As noted above, infrastructure as a service (IaaS) is one particular type of cloud computing service. In an IaaS model, the CSP provides infrastructure (referred to as cloud services provider infrastructure or CSPI) that can be used by customers to build their own customizable networks and deploy customer resources. The customer's resources and networks are thus hosted in a distributed environment by infrastructure provided by a CSP. This is different from traditional computing, where the customer's resources and networks are hosted by infrastructure provided by the customer.

The CSPI may comprise interconnected high-performance compute resources including various host machines, memory resources, and network resources that form a physical network, which is also referred to as a substrate network or an underlay network. The resources in CSPI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CSPI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)), Virtual Extensible LAN (VXLAN-IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

For IaaS, the infrastructure (CSPI) provided by a CSP can be configured to provide virtualized computing resources over a public network (e.g., the Internet). In an IaaS model, a cloud computing services provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance. CSPI provides infrastructure and a set of complementary cloud services that enable customers to build and run a wide range of applications and services in a highly available hosted distributed environment. CSPI offers high-performance compute resources and capabilities and storage capacity in a flexible virtual network that is securely accessible from various networked locations such as from a customer's on-premises network. When a customer subscribes to or registers for an IaaS service provided by a CSP, the tenancy created for that customer is a secure and isolated partition within the CSPI where the customer can create, organize, and administer their cloud resources.

Customers can build their own virtual networks using compute, memory, and networking resources provided by CSPI. One or more customer resources or workloads, such as compute instances, can be deployed on these virtual networks. For example, a customer can use resources provided by CSPI to build one or multiple customizable and private virtual network(s) referred to as virtual cloud networks (VCNs). A customer can deploy one or more customer resources, such as compute instances, on a customer VCN. Compute instances can take the form of virtual machines, bare metal instances, and the like. The CSPI thus provides infrastructure and a set of complementary cloud services that enable customers to build and run a wide range of applications and services in a highly available virtual hosted environment. The customer does not manage or control the underlying physical resources provided by CSPI but has control over operating systems, storage, and deployed applications; and possibly limited control of select networking components (e.g., firewalls).

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) serves a single customer or tenant. In a multi-tenancy architecture, a software or a hardware component serves multiple customers or tenants. Thus, in a multi-tenancy architecture, CSPI resources are shared between multiple customers or tenants. In a multi-tenancy situation, precautions are taken and safeguards put in place within CSPI to ensure that each tenant's data is isolated and remains invisible to other tenants.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CSPI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that is represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CSPI is physically hosted in one or more data centers in one or more regions around the world. The CSPI may include components in the physical or substrate network and virtualized components (e.g., virtual networks, compute instances, virtual machines, etc.) that are in an virtual network built on top of the physical network components. In certain embodiments, the CSPI is organized and hosted in realms, regions and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSPI resources are divided among regions such that each region has its own independent subset of CSPI resources. Each region may provide a set of core infrastructure services and resources, such as, compute resources (e.g., bare metal servers, virtual machine, containers and related infrastructure, etc.); storage resources (e.g., block volume storage, file storage, object storage, archive storage); networking resources (e.g., virtual cloud networks (VCNs), load balancing resources, connections to on-premise networks), database resources; edge networking resources (e.g., DNS); and access management and monitoring resources, and others. Each region generally has multiple paths connecting it to other regions in the realm.

Generally, an application is deployed in a region (i.e., deployed on infrastructure associated with that region) where it is most heavily used, because using nearby resources is faster than using distant resources. Applications can also be deployed in different regions for various reasons, such as redundancy to mitigate the risk of region-wide events such as large weather systems or earthquakes, to meet varying requirements for legal jurisdictions, tax domains, and other business or social criteria, and the like.

The data centers within a region can be further organized and subdivided into availability domains (ADs). An availability domain may correspond to one or more data centers located within a region. A region can be composed of one or more availability domains. In such a distributed environment, CSPI resources are either region-specific, such as a virtual cloud network (VCN), or availability domain-specific, such as a compute instance.

ADs within a region are isolated from each other, fault tolerant, and are configured such that they are very unlikely to fail simultaneously. This is achieved by the ADs not sharing critical infrastructure resources such as networking, physical cables, cable paths, cable entry points, etc., such that a failure at one AD within a region is unlikely to impact the availability of the other ADs within the same region. The ADs within the same region may be connected to each other by a low latency, high bandwidth network, which makes it possible to provide high-availability connectivity to other networks (e.g., the Internet, customers' on-premise networks, etc.) and to build replicated systems in multiple ADs for both high-availability and disaster recovery. Cloud services use multiple ADs to ensure high availability and to protect against resource failure. As the infrastructure provided by the IaaS provider grows, more regions and ADs may be added with additional capacity. Traffic between availability domains is usually encrypted.

In certain embodiments, regions are grouped into realms. A realm is a logical collection of regions. Realms are isolated from each other and do not share any data. Regions in the same realm may communicate with each other, but regions in different realms cannot. A customer's tenancy or account with the CSP exists in a single realm and can be spread across one or more regions that belong to that realm. Typically, when a customer subscribes to an IaaS service, a tenancy or account is created for that customer in the customer-specified region (referred to as the “home” region) within a realm. A customer can extend the customer's tenancy across one or more other regions within the realm. A customer cannot access regions that are not in the realm where the customer's tenancy exists.

An IaaS provider can provide multiple realms, each realm catered to a particular set of customers or users. For example, a commercial realm may be provided for commercial customers. As another example, a realm may be provided for a specific country for customers within that country. As yet another example, a government realm may be provided for a government, and the like. For example, the government realm may be catered for a specific government and may have a heightened level of security than a commercial realm. For example, Oracle Cloud Infrastructure (OCI) currently offers a realm for commercial regions and two realms (e.g., FedRAMP authorized and IL5 authorized) for government cloud regions.

In certain embodiments, an AD can be subdivided into one or more fault domains. A fault domain is a grouping of infrastructure resources within an AD to provide anti-affinity. Fault domains allow for the distribution of compute instances such that the instances are not on the same physical hardware within a single AD. This is known as anti-affinity. A fault domain refers to a set of hardware components (computers, switches, and more) that share a single point of failure. A compute pool is logically divided up into fault domains. Due to this, a hardware failure or compute hardware maintenance event that affects one fault domain does not affect instances in other fault domains. Depending on the embodiment, the number of fault domains for each AD may vary. For instance, in certain embodiments each AD contains three fault domains. A fault domain acts as a logical data center within an AD.

When a customer subscribes to an IaaS service, resources from CSPI are provisioned for the customer and associated with the customer's tenancy. The customer can use these provisioned resources to build private networks and deploy resources on these networks. The customer networks that are hosted in the cloud by the CSPI are referred to as virtual cloud networks (VCNs). A customer can set up one or more virtual cloud networks (VCNs) using CSPI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with public accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints.

The CSP may provide various services using the CSPI. In some instances, customers of CSPI may themselves act like service providers and provide services using CSPI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints.

In certain embodiments, a service provider may expose a service via an endpoint (sometimes referred to as a service endpoint) for the service. Customers of the service can then use this service endpoint to access the service. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 1. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about: the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

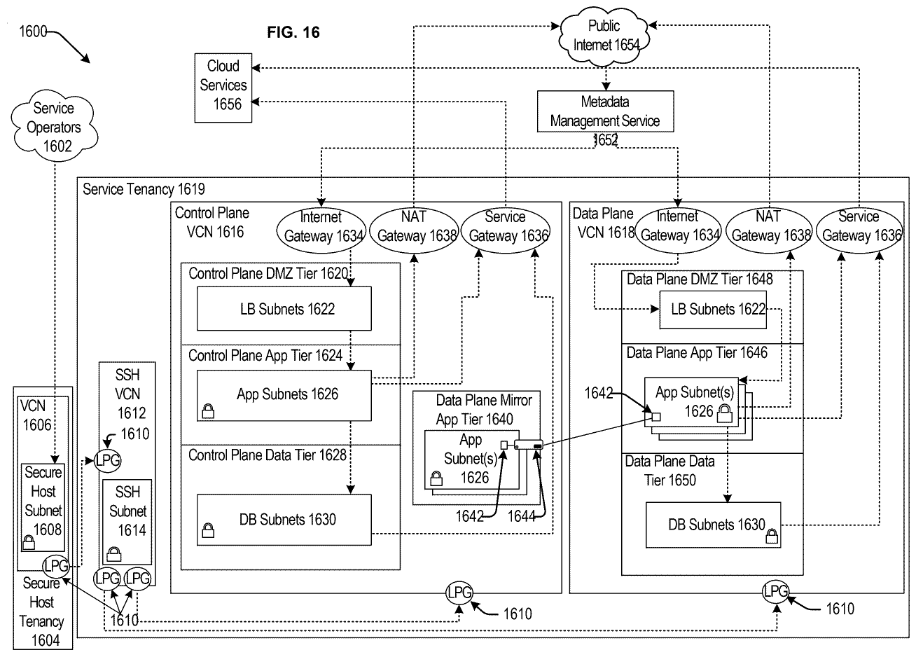

In certain embodiments, the creation of VCNs and subnets are handled by a VCN Control Plane (CP) and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane. Examples of a VCN Control Plane are also depicted in FIGS. 16, 17, 18, and 19 (see references 1616, 1716, 1816, and 1916) and described below.

A customer may create one or more VCNs using resources hosted by CSPI. A compute instance deployed on a customer VCN may communicate with different endpoints. These endpoints can include endpoints that are hosted by CSPI and endpoints outside CSPI.

Various different architectures for implementing cloud-based service using CSPI are depicted in FIGS. 1, 2, 3, 4, 5, 16, 17, 18, and 19, and are described below. FIG. 1 is a high level diagram of a distributed environment 100 showing an overlay or customer VCN hosted by CSPI according to certain embodiments. The distributed environment depicted in FIG. 1 includes multiple components in the overlay network. Distributed environment 100 depicted in FIG. 1 is merely an example and is not intended to unduly limit the scope of claimed embodiments. Many variations, alternatives, and modifications are possible. For example, in some implementations, the distributed environment depicted in FIG. 1 may have more or fewer systems or components than those shown in FIG. 1, may combine two or more systems, or may have a different configuration or arrangement of systems.

As shown in the example depicted in FIG. 1, distributed environment 100 comprises CSPI 101 that provides services and resources that customers can subscribe to and use to build their virtual cloud networks (VCNs). In certain embodiments, CSPI 101 offers IaaS services to subscribing customers. The data centers within CSPI 101 may be organized into one or more regions. One example region “Region US” 102 is shown in FIG. 1. A customer has configured a customer VCN 104 for region 102. The customer may deploy various compute instances on VCN 104, where the compute instances may include virtual machines or bare metal instances. Examples of instances include applications, database, load balancers, and the like.

In the embodiment depicted in FIG. 1, customer VCN 104 comprises two subnets, namely, “Subnet-1” and “Subnet-2”, each subnet with its own CIDR IP address range. In FIG. 1, the overlay IP address range for Subnet-1 is 10.0/16 and the address range for Subnet-2 is 10.1/16. A VCN Virtual Router 105 represents a logical gateway for the VCN that enables communications between subnets of the VCN 104, and with other endpoints outside the VCN. VCN VR 105 is configured to route traffic between VNICs in VCN 104 and gateways associated with VCN 104. VCN VR 105 provides a port for each subnet of VCN 104. For example, VR 105 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CSPI 101. A compute instance participates in a subnet via a VNIC associated with the compute instance. For example, as shown in FIG. 1, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 1, compute instance C1 has an overlay IP address of 10.0.0.2 and a MAC address of M1, while compute instance C2 has an private overlay IP address of 10.0.0.3 and a MAC address of M2. Each compute instance in Subnet-1, including compute instances C1 and C2, has a default route to VCN VR 105 using IP address 10.0.0.1, which is the IP address for a port of VCN VR 105 for Subnet-1.

Subnet-2 can have multiple compute instances deployed on it, including virtual machine instances and/or bare metal instances. For example, as shown in FIG. 1, compute instances D1 and D2 are part of Subnet-2 via VNICs associated with the respective compute instances. In the embodiment depicted in FIG. 1, compute instance D1 has an overlay IP address of 10.1.0.2 and a MAC address of MM1, while compute instance D2 has an private overlay IP address of 10.1.0.3 and a MAC address of MM2. Each compute instance in Subnet-2, including compute instances D1 and D2, has a default route to VCN VR 105 using IP address 10.1.0.1, which is the IP address for a port of VCN VR 105 for Subnet-2.

VCN A 104 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 104 can communicate with various different endpoints. These endpoints may include endpoints that are hosted by CSPI 200 and endpoints outside CSPI 200. Endpoints that are hosted by CSPI 101 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 106 or 110, communications between a compute instance in Subnet-1 and an endpoint in service network 110 in the same region); or an endpoint in a VCN in a different region (e.g., communications between a compute instance in Subnet-1 and an endpoint in a VCN in a different region 108). A compute instance in a subnet hosted by CSPI 101 may also communicate with endpoints that are not hosted by CSPI 101 (i.e., are outside CSPI 101). These outside endpoints include endpoints in the customer's on-premise network 116, endpoints within other remote cloud hosted networks 118, public endpoints 114 accessible via a public network such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 1 wants to send a packet to compute instance D1 in Subnet-2, the packet is first processed by the VNIC associated with compute instance C1. The VNIC associated with compute instance C1 is configured to route the packet to the VCN VR 105 using default route or port 10.0.0.1 of the VCN VR. VCN VR 105 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 104 to an endpoint that is outside VCN 104, the communication is facilitated by the VNIC associated with the source compute instance, VCN VR 105, and gateways associated with VCN 104. One or more types of gateways may be associated with VCN 104. A gateway is an interface between a VCN and another endpoint, where the another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 104. The packet may be first processed by the VNIC associated with source compute instance C1. The VNIC processing determines that the destination for the packet is outside the Subnet-1 of C1. The VNIC associated with C1 may forward the packet to VCN VR 105 for VCN 104. VCN VR 105 then processes the packet and as part of the processing, based upon the destination for the packet, determines a particular gateway associated with VCN 104 as the next hop for the packet. VCN VR 105 may then forward the packet to the particular identified gateway. For example, if the destination is an endpoint within the customer's on-premise network, then the packet may be forwarded by VCN VR 105 to Dynamic Routing Gateway (DRG) gateway 122 configured for VCN 104. The packet may then be forwarded from the gateway to a next hop to facilitate communication of the packet to it final intended destination.

Various different types of gateways may be configured for a VCN. Examples of gateways that may be configured for a VCN are depicted in FIG. 1 and described below. Examples of gateways associated with a VCN are also depicted in FIGS. 16, 17, 18, and 19 (for example, gateways referenced by reference numbers 1634, 1636, 1638, 1734, 1736, 1738, 1834, 1836, 1838, 1934, 1936, and 1938) and described below. As shown in the embodiment depicted in FIG. 1, a Dynamic Routing Gateway (DRG) 122 may be added to or be associated with customer VCN 104 and provides a path for private network traffic communication between customer VCN 104 and another endpoint, where the another endpoint can be the customer's on-premise network 116, a VCN 108 in a different region of CSPI 101, or other remote cloud networks 118 not hosted by CSPI 101. Customer on-premise network 116 may be a customer network or a customer data center built using the customer's resources. Access to customer on-premise network 116 is generally very restricted. For a customer that has both a customer on-premise network 116 and one or more VCNs 104 deployed or hosted in the cloud by CSPI 101, the customer may want their on-premise network 116 and their cloud-based VCN 104 to be able to communicate with each other. This enables a customer to build an extended hybrid environment encompassing the customer's VCN 104 hosted by CSPI 101 and their on-premises network 116. DRG 122 enables this communication. To enable such communications, a communication channel 124 is set up where one endpoint of the channel is in customer on-premise network 116 and the other endpoint is in CSPI 101 and connected to customer VCN 104. Communication channel 124 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 116 that forms one end point for communication channel 124 is referred to as the customer premise equipment (CPE), such as CPE 126 depicted in FIG. 1. On the CSPI 101 side, the endpoint may be a host machine executing DRG 122.

In certain embodiments, a Remote Peering Connection (RPC) can be added to a DRG, which allows a customer to peer one VCN with another VCN in a different region. Using such an RPC, customer VCN 104 can use DRG 122 to connect with a VCN 108 in another region. DRG 122 may also be used to communicate with other remote cloud networks 118, not hosted by CSPI 101 such as a Microsoft Azure cloud, Amazon AWS cloud, and others.

As shown in FIG. 1, an Internet Gateway (IGW) 120 may be configured for customer VCN 104 the enables a compute instance on VCN 104 to communicate with public endpoints 114 accessible over a public network such as the Internet. IGW 120 is a gateway that connects a VCN to a public network such as the Internet. IGW 120 enables a public subnet (where the resources in the public subnet have public overlay IP addresses) within a VCN, such as VCN 104, direct access to public endpoints 112 on a public network 114 such as the Internet. Using IGW 120, connections can be initiated from a subnet within VCN 104 or from the Internet.

A Network Address Translation (NAT) gateway 128 can be configured for customer's VCN 104 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 104, with private access to public endpoints on the Internet. In NAT gateways, connections can be initiated only from the private subnet to the public Internet and not from the Internet to the private subnet.

In certain embodiments, a Service Gateway (SGW) 126 can be configured for customer VCN 104 and provides a path for private network traffic between VCN 104 and supported services endpoints in a service network 110. In certain embodiments, service network 110 may be provided by the CSP and may provide various services. An example of such a service network is Oracle's Services Network, which provides various services that can be used by customers. For example, a compute instance (e.g., a database system) in a private subnet of customer VCN 104 can back up data to a service endpoint (e.g., Object Storage) without needing public IP addresses or access to the Internet. In certain embodiments, a VCN can have only one SGW, and connections can only be initiated from a subnet within the VCN and not from service network 110. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 126 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 132 is a gateway that can be added to customer VCN 104 and enables VCN 104 to peer with another VCN in the same region. Peering means that the VCNs communicate using private IP addresses, without the traffic traversing a public network such as the Internet or without routing the traffic through the customer's on-premises network 116. In preferred embodiments, a VCN has a separate LPG for each peering it establishes. Local Peering or VCN Peering is a common practice used to establish network connectivity between different applications or infrastructure management functions.

Service providers, such as providers of services in service network 110, may provide access to services using different access models. According to a public access model, services may be exposed as public endpoints that are publicly accessible by compute instance in a customer VCN via a public network such as the Internet and or may be privately accessible via SGW 126. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 130 is a gateway resource that can be attached to a service provider VCN (e.g., a VCN in service network 110) that acts as an ingress/egress point for all traffic from/to customer subnet private endpoints. PAGW 130 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 130 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 132 and the PE in the customer's VCN.

A customer can control routing in a VCN at the subnet level, so the customer can specify which subnets in the customer's VCN, such as VCN 104, use each gateway. A VCN's route tables are used to decide if traffic is allowed out of a VCN through a particular gateway. For example, in a particular instance, a route table for a public subnet within customer VCN 104 may send non-local traffic through IGW 120. The route table for a private subnet within the same customer VCN 104 may send traffic destined for CSP services through SGW 126. All remaining traffic may be sent via the NAT gateway 128. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked and the response is automatically allowed without an explicit security list rule for the response traffic) or stateless.

Access from a customer VCN (i.e., by a resource or compute instance deployed on VCN 104) can be categorized as public access, private access, or dedicated access. Public access refers to an access model where a public IP address or a NAT is used to access a public endpoint. Private access enables customer workloads in VCN 104 with private IP addresses (e.g., resources in a private subnet) to access services without traversing a public network such as the Internet. In certain embodiments, CSPI 101 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CSPI may offer dedicated public access using technologies such as FastConnect public peering where customer on-premises instances can access one or more services in a customer VCN using a FastConnect connection and without traversing a public network such as the Internet. CSPI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CSPI and its services. FastConnect provides an easy, elastic, and economical way to create a dedicated and private connection with higher bandwidth options and a more reliable and consistent networking experience when compared to Internet-based connections.

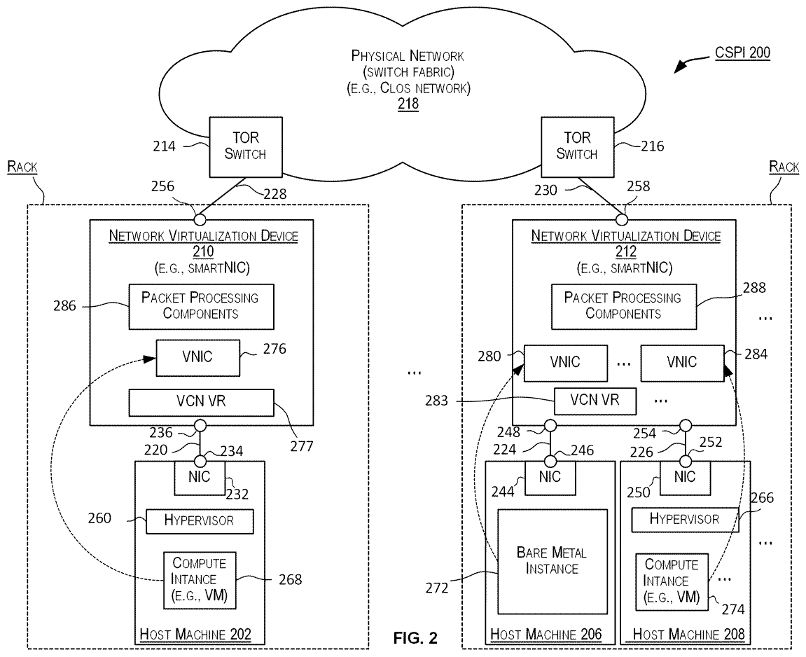

FIG. 1 and the accompanying description above describes various virtualized components in an example virtual network. As described above, the virtual network is built on the underlying physical or substrate network. FIG. 2 depicts a simplified architectural diagram of the physical components in the physical network within CSPI 200 that provide the underlay for the virtual network according to certain embodiments. As shown, CSPI 200 provides a distributed environment comprising components and resources (e.g., compute, memory, and networking resources) provided by a cloud service provider (CSP). These components and resources are used to provide cloud services (e.g., IaaS services) to subscribing customers, i.e., customers that have subscribed to one or more services provided by the CSP. Based upon the services subscribed to by a customer, a subset of resources (e.g., compute, memory, and networking resources) of CSPI 200 are provisioned for the customer. Customers can then build their own cloud-based (i.e., CSPI-hosted) customizable and private virtual networks using physical compute, memory, and networking resources provided by CSPI 200. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CSPI 200 provides infrastructure and a set of complementary cloud services that enable customers to build and run a wide range of applications and services in a highly available hosted environment.

In the example embodiment depicted in FIG. 2, the physical components of CSPI 200 include one or more physical host machines or physical servers (e.g., 202, 206, 208), network virtualization devices (NVDs) (e.g., 210, 212), top-of-rack (TOR) switches (e.g., 214, 216), and a physical network (e.g., 218), and switches in physical network 218. The physical host machines or servers may host and execute various compute instances that participate in one or more subnets of a VCN. The compute instances may include virtual machine instances, and bare metal instances. For example, the various compute instances depicted in FIG. 1 may be hosted by the physical host machines depicted in FIG. 2. The virtual machine compute instances in a VCN may be executed by one host machine or by multiple different host machines. The physical host machines may also host virtual host machines, container-based hosts or functions, and the like. The VNICs and VCN VR depicted in FIG. 1 may be executed by the NVDs depicted in FIG. 2. The gateways depicted in FIG. 1 may be executed by the host machines and/or by the NVDs depicted in FIG. 2.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 2, host machines 202 and 208 execute hypervisors 260 and 266, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 2, hypervisor 260 may sit on top of the OS of host machine 202 and enables the computing resources (e.g., processing, memory, and networking resources) of host machine 202 to be shared between compute instances (e.g., virtual machines) executed by host machine 202. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 2 may have the same or different types of hypervisors.

A compute instance can be a virtual machine instance or a bare metal instance. In FIG. 2, compute instances 268 on host machine 202 and 274 on host machine 208 are examples of virtual machine instances. Host machine 206 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 2, host machine 202 executes a virtual machine compute instance 268 that is associated with VNIC 276, and VNIC 276 is executed by NVD 210 connected to host machine 202. As another example, bare metal instance 272 hosted by host machine 206 is associated with VNIC 280 that is executed by NVD 212 connected to host machine 206. As yet another example, VNIC 284 is associated with compute instance 274 executed by host machine 208, and VNIC 284 is executed by NVD 212 connected to host machine 208.

For compute instances hosted by a host machine, an NVD connected to that host machine also executes VCN VRs corresponding to VCNs of which the compute instances are members. For example, in the embodiment depicted in FIG. 2, NVD 210 executes VCN VR 277 corresponding to the VCN of which compute instance 268 is a member. NVD 212 may also execute one or more VCN VRs 283 corresponding to VCNs corresponding to the compute instances hosted by host machines 206 and 208.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 2, host machine 202 is connected to NVD 210 using link 220 that extends between a port 234 provided by a NIC 232 of host machine 202 and between a port 236 of NVD 210. Host machine 206 is connected to NVD 212 using link 224 that extends between a port 246 provided by a NIC 244 of host machine 206 and between a port 248 of NVD 212. Host machine 208 is connected to NVD 212 using link 226 that extends between a port 252 provided by a NIC 250 of host machine 208 and between a port 254 of NVD 212.

The NVDs are in turn connected via communication links to top-of-the-rack (TOR) switches, which are connected to physical network 218 (also referred to as the switch fabric). In certain embodiments, the links between a host machine and an NVD, and between an NVD and a TOR switch are Ethernet links. For example, in FIG. 2, NVDs 210 and 212 are connected to TOR switches 214 and 216, respectively, using links 228 and 230. In certain embodiments, the links 220, 224, 226, 228, and 230 are Ethernet links. The collection of host machines and NVDs that are connected to a TOR is sometimes referred to as a rack.

Physical network 218 provides a communication fabric that enables TOR switches to communicate with each other. Physical network 218 can be a multi-tiered network. In certain implementations, physical network 218 is a multi-tiered Clos network of switches, with TOR switches 214 and 216 representing the leaf level nodes of the multi-tiered and multi-node physical switching network 218. Different Clos network configurations are possible including but not limited to a 2-tier network, a 3-tier network, a 4-tier network, a 5-tier network, and in general a “n”-tiered network. An example of a Clos network is depicted in FIG. 5 and described below.

Various different connection configurations are possible between host machines and NVDs such as one-to-one configuration, many-to-one configuration, one-to-many configuration, and others. In a one-to-one configuration implementation, each host machine is connected to its own separate NVD. For example, in FIG. 2, host machine 202 is connected to NVD 210 via NIC 232 of host machine 202. In a many-to-one configuration, multiple host machines are connected to one NVD. For example, in FIG. 2, host machines 206 and 208 are connected to the same NVD 212 via NICs 244 and 250, respectively.

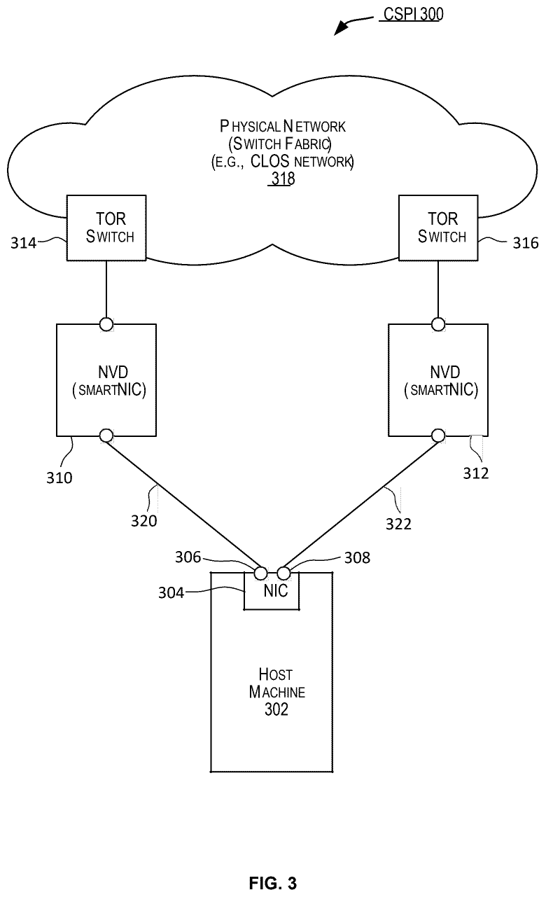

In a one-to-many configuration, one host machine is connected to multiple NVDs. FIG. 3 shows an example within CSPI 300 where a host machine is connected to multiple NVDs. As shown in FIG. 3, host machine 302 comprises a network interface card (NIC) 304 that includes multiple ports 306 and 308. Host machine 300 is connected to a first NVD 310 via port 306 and link 320, and connected to a second NVD 312 via port 308 and link 322. Ports 306 and 308 may be Ethernet ports and the links 320 and 322 between host machine 302 and NVDs 310 and 312 may be Ethernet links. NVD 310 is in turn connected to a first TOR switch 314 and NVD 312 is connected to a second TOR switch 316. The links between NVDs 310 and 312, and TOR switches 314 and 316 may be Ethernet links. TOR switches 314 and 316 represent the Tier-0 switching devices in multi-tiered physical network 318.

The arrangement depicted in FIG. 3 provides two separate physical network paths to and from physical switch network 318 to host machine 302: a first path traversing TOR switch 314 to NVD 310 to host machine 302, and a second path traversing TOR switch 316 to NVD 312 to host machine 302. The separate paths provide for enhanced availability (referred to as high availability) of host machine 302. If there are problems in one of the paths (e.g., a link in one of the paths goes down) or devices (e.g., a particular NVD is not functioning), then the other path may be used for communications to/from host machine 302.

In the configuration depicted in FIG. 3, the host machine is connected to two different NVDs using two different ports provided by a NIC of the host machine. In other embodiments, a host machine may include multiple NICs that enable connectivity of the host machine to multiple NVDs.

Referring back to FIG. 2, an NVD is a physical device or component that performs one or more network and/or storage virtualization functions. An NVD may be any device with one or more processing units (e.g., CPUs, Network Processing Units (NPUs), FPGAs, packet processing pipelines, etc.), memory including cache, and ports. The various virtualization functions may be performed by software/firmware executed by the one or more processing units of the NVD.

An NVD may be implemented in various different forms. For example, in certain embodiments, an NVD is implemented as an interface card referred to as a smartNIC or an intelligent NIC with an embedded processor onboard. A smartNIC is a separate device from the NICs on the host machines. In FIG. 2, the NVDs 210 and 212 may be implemented as smartNICs that are connected to host machines 202, and host machines 206 and 208, respectively.

A smartNIC is however just one example of an NVD implementation. Various other implementations are possible. For example, in some other implementations, an NVD or one or more functions performed by the NVD may be incorporated into or performed by one or more host machines, one or more TOR switches, and other components of CSPI 200. For example, an NVD may be embodied in a host machine where the functions performed by an NVD are performed by the host machine. As another example, an NVD may be part of a TOR switch or a TOR switch may be configured to perform functions performed by an NVD that enables the TOR switch to perform various complex packet transformations that are used for a public cloud. A TOR that performs the functions of an NVD is sometimes referred to as a smart TOR. In yet other implementations, where virtual machines (VMs) instances, but not bare metal (BM) instances, are offered to customers, functions performed by an NVD may be implemented inside a hypervisor of the host machine. In some other implementations, some of the functions of the NVD may be offloaded to a centralized service running on a fleet of host machines.

In certain embodiments, such as when implemented as a smartNIC as shown in FIG. 2, an NVD may comprise multiple physical ports that enable it to be connected to one or more host machines and to one or more TOR switches. A port on an NVD can be classified as a host-facing port (also referred to as a “south port”) or a network-facing or TOR-facing port (also referred to as a “north port”). A host-facing port of an NVD is a port that is used to connect the NVD to a host machine. Examples of host-facing ports in FIG. 2 include port 236 on NVD 210, and ports 248 and 254 on NVD 212. A network-facing port of an NVD is a port that is used to connect the NVD to a TOR switch. Examples of network-facing ports in FIG. 2 include port 256 on NVD 210, and port 258 on NVD 212. As shown in FIG. 2, NVD 210 is connected to TOR switch 214 using link 228 that extends from port 256 of NVD 210 to the TOR switch 214. Likewise, NVD 212 is connected to TOR switch 216 using link 230 that extends from port 258 of NVD 212 to the TOR switch 216.

An NVD receives packets and frames from a host machine (e.g., packets and frames generated by a compute instance hosted by the host machine) via a host-facing port and, after performing the necessary packet processing, may forward the packets and frames to a TOR switch via a network-facing port of the NVD. An NVD may receive packets and frames from a TOR switch via a network-facing port of the NVD and, after performing the necessary packet processing, may forward the packets and frames to a host machine via a host-facing port of the NVD.

In certain embodiments, there may be multiple ports and associated links between an NVD and a TOR switch. These ports and links may be aggregated to form a link aggregator group of multiple ports or links (referred to as a LAG). Link aggregation allows multiple physical links between two end-points (e.g., between an NVD and a TOR switch) to be treated as a single logical link. All the physical links in a given LAG may operate in full-duplex mode at the same speed. LAGs help increase the bandwidth and reliability of the connection between two endpoints. If one of the physical links in the LAG goes down, traffic is dynamically and transparently reassigned to one of the other physical links in the LAG. The aggregated physical links deliver higher bandwidth than each individual link. The multiple ports associated with a LAG are treated as a single logical port. Traffic can be load-balanced across the multiple physical links of a LAG. One or more LAGs may be configured between two endpoints. The two endpoints may be between an NVD and a TOR switch, between a host machine and an NVD, and the like.

An NVD implements or performs network virtualization functions. These functions are performed by software/firmware executed by the NVD. Examples of network virtualization functions include without limitation: packet encapsulation and de-capsulation functions; functions for creating a VCN network; functions for implementing network policies such as VCN security list (firewall) functionality; functions that facilitate the routing and forwarding of packets to and from compute instances in a VCN; and the like. In certain embodiments, upon receiving a packet, an NVD is configured to execute a packet processing pipeline for processing the packet and determining how the packet is to be forwarded or routed. As part of this packet processing pipeline, the NVD may execute one or more virtual functions associated with the overlay network such as executing VNICs associated with compute instances in the VCN, executing a Virtual Router (VR) associated with the VCN, the encapsulation and decapsulation of packets to facilitate forwarding or routing in the virtual network, execution of certain gateways (e.g., the Local Peering Gateway), the implementation of Security Lists, Network Security Groups, network address translation (NAT) functionality (e.g., the translation of Public IP to Private IP on a host by host basis), throttling functions, and other functions.

In certain embodiments, the packet processing data path in an NVD may comprise multiple packet pipelines, each composed of a series of packet transformation stages. In certain implementations, upon receiving a packet, the packet is parsed and classified to a single pipeline. The packet is then processed in a linear fashion, one stage after another, until the packet is either dropped or sent out over an interface of the NVD. These stages provide basic functional packet processing building blocks (e.g., validating headers, enforcing throttle, inserting new Layer-2 headers, enforcing L4 firewall, VCN encapsulation/decapsulation, etc.) so that new pipelines can be constructed by composing existing stages, and new functionality can be added by creating new stages and inserting them into existing pipelines.

An NVD may perform both control plane and data plane functions corresponding to a control plane and a data plane of a VCN. Examples of a VCN Control Plane are also depicted in FIGS. 16, 17, 18, and 19 (see references 1616, 1716, 1816, and 1916) and described below. Examples of a VCN Data Plane are depicted in FIGS. 16, 17, 18, and 19 (see references 1618, 1718, 1818, and 1918) and described below. The control plane functions include functions used for configuring a network (e.g., setting up routes and route tables, configuring VNICs, etc.) that controls how data is to be forwarded. In certain embodiments, a VCN Control Plane is provided that computes all the overlay-to-substrate mappings centrally and publishes them to the NVDs and to the virtual network edge devices such as various gateways such as the DRG, the SGW, the IGW, etc. Firewall rules may also be published using the same mechanism. In certain embodiments, an NVD only gets the mappings that are relevant for that NVD. The data plane functions include functions for the actual routing/forwarding of a packet based upon configuration set up using control plane. A VCN data plane is implemented by encapsulating the customer's network packets before they traverse the substrate network. The encapsulation/decapsulation functionality is implemented on the NVDs. In certain embodiments, an NVD is configured to intercept all network packets in and out of host machines and perform network virtualization functions.

As indicated above, an NVD executes various virtualization functions including VNICs and VCN VRs. An NVD may execute VNICs associated with the compute instances hosted by one or more host machines connected to the VNIC. For example, as depicted in FIG. 2, NVD 210 executes the functionality for VNIC 276 that is associated with compute instance 268 hosted by host machine 202 connected to NVD 210. As another example, NVD 212 executes VNIC 280 that is associated with bare metal compute instance 272 hosted by host machine 206, and executes VNIC 284 that is associated with compute instance 274 hosted by host machine 208. A host machine may host compute instances belonging to different VCNs, which belong to different customers, and the NVD connected to the host machine may execute the VNICs (i.e., execute VNICs-relate functionality) corresponding to the compute instances.

An NVD also executes VCN Virtual Routers corresponding to the VCNs of the compute instances. For example, in the embodiment depicted in FIG. 2, NVD 210 executes VCN VR 277 corresponding to the VCN to which compute instance 268 belongs. NVD 212 executes one or more VCN VRs 283 corresponding to one or more VCNs to which compute instances hosted by host machines 206 and 208 belong. In certain embodiments, the VCN VR corresponding to that VCN is executed by all the NVDs connected to host machines that host at least one compute instance belonging to that VCN. If a host machine hosts compute instances belonging to different VCNs, an NVD connected to that host machine may execute VCN VRs corresponding to those different VCNs.

In addition to VNICs and VCN VRs, an NVD may execute various software (e.g., daemons) and include one or more hardware components that facilitate the various network virtualization functions performed by the NVD. For purposes of simplicity, these various components are grouped together as “packet processing components” shown in FIG. 2. For example, NVD 210 comprises packet processing components 286 and NVD 212 comprises packet processing components 288. For example, the packet processing components for an NVD may include a packet processor that is configured to interact with the NVD's ports and hardware interfaces to monitor all packets received by and communicated using the NVD and store network information. The network information may, for example, include network flow information identifying different network flows handled by the NVD and per flow information (e.g., per flow statistics). In certain embodiments, network flows information may be stored on a per VNIC basis. The packet processor may perform packet-by-packet manipulations as well as implement stateful NAT and L4 firewall (FW). As another example, the packet processing components may include a replication agent that is configured to replicate information stored by the NVD to one or more different replication target stores. As yet another example, the packet processing components may include a logging agent that is configured to perform logging functions for the NVD. The packet processing components may also include software for monitoring the performance and health of the NVD and, also possibly of monitoring the state and health of other components connected to the NVD.

FIG. 1 shows the components of an example virtual or overlay network including a VCN, subnets within the VCN, compute instances deployed on subnets, VNICs associated with the compute instances, a VR for a VCN, and a set of gateways configured for the VCN. The overlay components depicted in FIG. 1 may be executed or hosted by one or more of the physical components depicted in FIG. 2. For example, the compute instances in a VCN may be executed or hosted by one or more host machines depicted in FIG. 2. For a compute instance hosted by a host machine, the VNIC associated with that compute instance is typically executed by an NVD connected to that host machine (i.e., the VNIC functionality is provided by the NVD connected to that host machine). The VCN VR function for a VCN is executed by all the NVDs that are connected to host machines hosting or executing the compute instances that are part of that VCN. The gateways associated with a VCN may be executed by one or more different types of NVDs. For example, certain gateways may be executed by smartNICs, while others may be executed by one or more host machines or other implementations of NVDs.

As described above, a compute instance in a customer VCN may communicate with various different endpoints, where the endpoints can be within the same subnet as the source compute instance, in a different subnet but within the same VCN as the source compute instance, or with an endpoint that is outside the VCN of the source compute instance. These communications are facilitated using VNICs associated with the compute instances, the VCN VRs, and the gateways associated with the VCNs.

For communications between two compute instances on the same subnet in a VCN, the communication is facilitated using VNICs associated with the source and destination compute instances. The source and destination compute instances may be hosted by the same host machine or by different host machines. A packet originating from a source compute instance may be forwarded from a host machine hosting the source compute instance to an NVD connected to that host machine. On the NVD, the packet is processed using a packet processing pipeline, which can include execution of the VNIC associated with the source compute instance. Since the destination endpoint for the packet is within the same subnet, execution of the VNIC associated with the source compute instance results in the packet being forwarded to an NVD executing the VNIC associated with the destination compute instance, which then processes and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs). The VNICs may use routing/forwarding tables stored by the NVD to determine the next hop for the packet.

For a packet to be communicated from a compute instance in a subnet to an endpoint in a different subnet in the same VCN, the packet originating from the source compute instance is communicated from the host machine hosting the source compute instance to the NVD connected to that host machine. On the NVD, the packet is processed using a packet processing pipeline, which can include execution of one or more VNICs, and the VR associated with the VCN. For example, as part of the packet processing pipeline, the NVD executes or invokes functionality corresponding to the VNIC (also referred to as executes the VNIC) associated with source compute instance. The functionality performed by the VNIC may include looking at the VLAN tag on the packet. Since the packet's destination is outside the subnet, the VCN VR functionality is next invoked and executed by the NVD. The VCN VR then routes the packet to the NVD executing the VNIC associated with the destination compute instance. The VNIC associated with the destination compute instance then processes the packet and forwards the packet to the destination compute instance. The VNICs associated with the source and destination compute instances may be executed on the same NVD (e.g., when both the source and destination compute instances are hosted by the same host machine) or on different NVDs (e.g., when the source and destination compute instances are hosted by different host machines connected to different NVDs).

If the destination for the packet is outside the VCN of the source compute instance, then the packet originating from the source compute instance is communicated from the host machine hosting the source compute instance to the NVD connected to that host machine. The NVD executes the VNIC associated with the source compute instance. Since the destination end point of the packet is outside the VCN, the packet is then processed by the VCN VR for that VCN. The NVD invokes the VCN VR functionality, which may result in the packet being forwarded to an NVD executing the appropriate gateway associated with the VCN. For example, if the destination is an endpoint within the customer's on-premise network, then the packet may be forwarded by the VCN VR to the NVD executing the DRG gateway configured for the VCN. The VCN VR may be executed on the same NVD as the NVD executing the VNIC associated with the source compute instance or by a different NVD. The gateway may be executed by an NVD, which may be a smartNIC, a host machine, or other NVD implementation. The packet is then processed by the gateway and forwarded to a next hop that facilitates communication of the packet to its intended destination endpoint. For example, in the embodiment depicted in FIG. 2, a packet originating from compute instance 268 may be communicated from host machine 202 to NVD 210 over link 220 (using NIC 232). On NVD 210, VNIC 276 is invoked since it is the VNIC associated with source compute instance 268. VNIC 276 is configured to examine the encapsulated information in the packet, and determine a next hop for forwarding the packet with the goal of facilitating communication of the packet to its intended destination endpoint, and then forward the packet to the determined next hop.

A compute instance deployed on a VCN can communicate with various different endpoints. These endpoints may include endpoints that are hosted by CSPI 200 and endpoints outside CSPI 200. Endpoints hosted by CSPI 200 may include instances in the same VCN or other VCNs, which may be the customer's VCNs, or VCNs not belonging to the customer. Communications between endpoints hosted by CSPI 200 may be performed over physical network 218. A compute instance may also communicate with endpoints that are not hosted by CSPI 200, or are outside CSPI 200. Examples of these endpoints include endpoints within a customer's on-premise network or data center, or public endpoints accessible over a public network such as the Internet. Communications with endpoints outside CSPI 200 may be performed over public networks (e.g., the Internet) (not shown in FIG. 2) or private networks (not shown in FIG. 2) using various communication protocols.

The architecture of CSPI 200 depicted in FIG. 2 is merely an example and is not intended to be limiting. Variations, alternatives, and modifications are possible in alternative embodiments. For example, in some implementations, CSPI 200 may have more or fewer systems or components than those shown in FIG. 2, may combine two or more systems, or may have a different configuration or arrangement of systems. The systems, subsystems, and other components depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

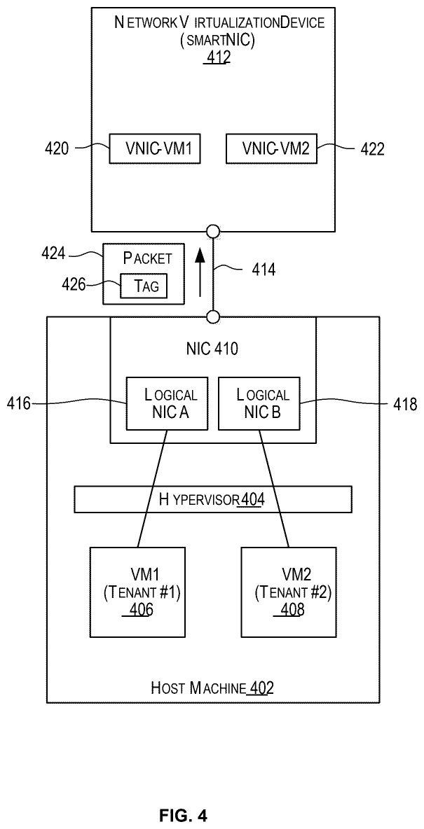

FIG. 4 depicts connectivity between a host machine and an NVD for providing I/O virtualization for supporting multitenancy according to certain embodiments. As depicted in FIG. 4, host machine 402 executes a hypervisor 404 that provides a virtualized environment. Host machine 402 executes two virtual machine instances, VM1 406 belonging to customer/tenant #1 and VM2 408 belonging to customer/tenant #2. Host machine 402 comprises a physical NIC 410 that is connected to an NVD 412 via link 414. Each of the compute instances is attached to a VNIC that is executed by NVD 412. In the embodiment in FIG. 4, VM1 406 is attached to VNIC-VM1 420 and VM2 408 is attached to VNIC-VM2 422.

As shown in FIG. 4, NIC 410 comprises two logical NICs, logical NIC A 416 and logical NIC B 418. Each virtual machine is attached to and configured to work with its own logical NIC. For example, VM1 406 is attached to logical NIC A 416 and VM2 408 is attached to logical NIC B 418. Even though host machine 402 comprises only one physical NIC 410 that is shared by the multiple tenants, due to the logical NICs, each tenant's virtual machine believes they have their own host machine and NIC.

In certain embodiments, each logical NIC is assigned its own VLAN ID. Thus, a specific VLAN ID is assigned to logical NIC A 416 for Tenant #1 and a separate VLAN ID is assigned to logical NIC B 418 for Tenant #2. When a packet is communicated from VM1 406, a tag assigned to Tenant #1 is attached to the packet by the hypervisor and the packet is then communicated from host machine 402 to NVD 412 over link 414. In a similar manner, when a packet is communicated from VM2 408, a tag assigned to Tenant #2 is attached to the packet by the hypervisor and the packet is then communicated from host machine 402 to NVD 412 over link 414. Accordingly, a packet 424 communicated from host machine 402 to NVD 412 has an associated tag 426 that identifies a specific tenant and associated VM. On the NVD, for a packet 424 received from host machine 402, the tag 426 associated with the packet is used to determine whether the packet is to be processed by VNIC-VM1 420 or by VNIC-VM2 422. The packet is then processed by the corresponding VNIC. The configuration depicted in FIG. 4 enables each tenant's compute instance to believe that they own their own host machine and NIC. The setup depicted in FIG. 4 provides for I/O virtualization for supporting multi-tenancy.

FIG. 5 depicts a simplified block diagram of a physical network 500 according to certain embodiments. The embodiment depicted in FIG. 5 is structured as a Clos network. A Clos network is a particular type of network topology designed to provide connection redundancy while maintaining high bisection bandwidth and maximum resource utilization. A Clos network is a type of non-blocking, multistage or multi-tiered switching network, where the number of stages or tiers can be two, three, four, five, etc. The embodiment depicted in FIG. 5 is a 3-tiered network comprising tiers 1, 2, and 3. The TOR switches 504 represent Tier-0 switches in the Clos network. One or more NVDs are connected to the TOR switches. Tier-0 switches are also referred to as edge devices of the physical network. The Tier-0 switches are connected to Tier-1 switches, which are also referred to as leaf switches. In the embodiment depicted in FIG. 5, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 500 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:
ocid1.<RESOURCE TYPE>.<REALM>. [REGION][.FUTURE USE].<UNIQUE ID> where,
   ocid1: The literal string indicating the version of the CID;
   resource type: The type of resource (for example, instance, volume, VCN, subnet, user, group, and so on);
   realm: The realm the resource is in. Example values are “c1” for the commercial realm, “c2” for the Government Cloud realm, or “c3” for the Federal Government Cloud realm, etc. Each realm may have its own domain name;
   region: The region the resource is in. If the region is not applicable to the resource, this part might be blank;
   future use: Reserved for future use.
   unique ID: The unique portion of the ID. The format may vary depending on the type of resource or service.

### Data Center Layout

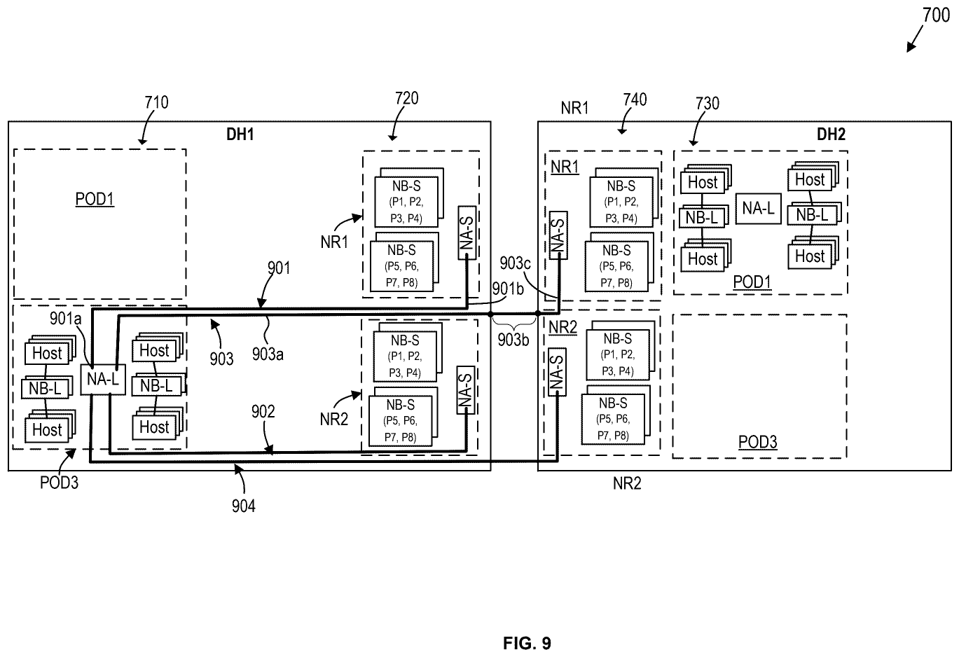

FIG. 6 is a simplified block diagram illustrating an example layout of a data center 600. The data center 600 can include a plurality of datahalls, and cabling infrastructure within and between the datahalls. In the illustrated example, the data center 600 includes a first datahall DH1, and a second datahall DH2. Additionally or alternatively, the data center 600 may be expanded to include a third datahall DH3, a fourth datahall DH4, a fifth datahall DH5, or other number of datahalls. In some embodiments, the first datahall DH1 and the second datahall DH2 may have similar configuration. In some embodiments, the first datahall DH1 and the second datahall DH2 can be referred as a datahall-with-spine-leaf, and the datahall DH3, DH4 can be referred as data-hall-with-leaf. The datahalls DH1-DH4 can include compute nodes, and networking equipment (e.g., switches, patch panels, network fabric racks, etc.) configured to facilitate communication between the compute nodes. For example, in FIG. 6, at locations represented by dotted boxes labelled host pod 610 can include host machines (e.g., GPU, CPU, TPU, servers, etc.), compute nodes and networking equipment, at locations represented by solid boxes labelled spine 620 can correspond to only networking equipment. Furthermore, location of boxes labelled conduit 630 and solid connecting lines 640 between conduits can correspond to part of the cabling infrastructure. Cabling within each datahall is omitted in FIG. 1 for simplicity, but discussed in greater detail later in the disclosure. Example layouts of datahalls DH1-DH5 and the cabling infrastructure is discussed in further detail in FIGS. 9-20 and discussed in detail below.

In the present disclosure, the compute nodes, networking equipment, and cabling infrastructure are a strategically located within a datahall and strategically distributed across the datahalls to facilitate communication between different datahalls over a large distance (e.g., up to 10 km) with minimum latency, and high-speeds. The cabling infrastructure and networking equipment are configured such that each compute node within a particular datahall can communicate with each other, as well as with other compute nodes across different datahalls. For example, a part of the cabling infrastructure can form Remote Direct Memory Access (RDMA) network clusters to enable direct memory access between compute nodes without involving the CPU. This provides significant advantages such as low latency, high throughput, lower CPU overhead, and better scalability for different applications. For example, these features allow training large AI models across multiple host machines.

In various embodiments, the data center design is configured to place a set of first type of switches (e.g., T0-tier or leaf switches, top-of-rack switches) near host racks, consolidate a set of second type of switches (e.g., T1-tier or spine switches) in datahalls DH1 and DH2, and cross-connect the second type of switches (e.g., T1-tier switches) across the datahalls so that both datahalls actively serve network traffic, and if one datahall is unavailable or fails, workloads continue via the other datahall without a cold start. Datahalls DH3 and DH4 can be configured to house host machines and a set of first type of switches (e.g., T0-tier) but no second type of switches (e.g., T1-tier) and connect with datahalls DH1 and DH2 using long, high-count optical fiber trunks (e.g., 6,912 strands built from 288-strand cables) and splicing technology, rather than connectors to preserve RDMA high throughput over distance. Additionally, the fiber trunks herein enables minimizing patch panels. This way, the data center can minimize data loss, operate at low latency, and high bandwidth even though datahalls may be distributed over long distances. The illustrated datahalls DH1-DH5 are only examples without limiting the scope of the present disclosure. More or less number of datahalls are possible. Furthermore, one or more datahall be configured to include, but is not limited to, host machines and a first type of switches (i.e., leaf switches) but not the second type of switches (i.e., spine switches). Similarly, another datahall or another set of datahalls may be configured to include the host machines, the first type of switches (i.e., leaf switches) and the second type of switches (i.e., spine switches), among others. In other words, some datahalls may have leaf switches, while some datahalls may have both leaf switches and spine switches.

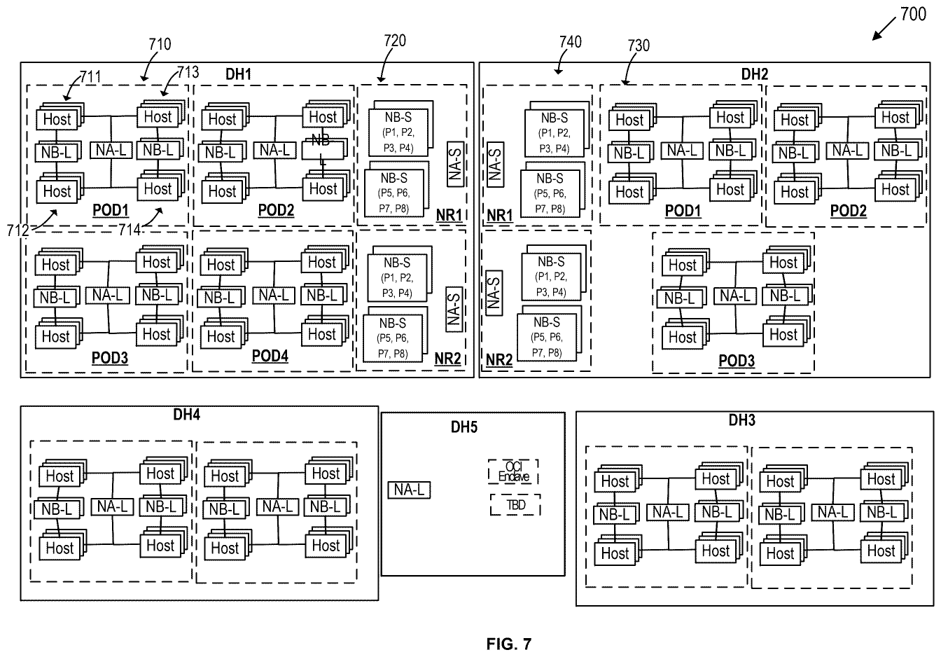

FIGS. 7-10 illustrate an example layout of a data center 700. The data center 700 can include the datahalls DH1-DH5 physically isolated from each other, while being communicably coupled to each other via cabling and networking equipment. The datahalls DH1 and DH2 can have similar or substantially the same layout. The datahalls DH3 and DH4 may have similar or substantially the same layout, but include different networking setup from datahalls DH1, DH2. For example, datahalls DH1 and DH2 may include leaf switches and spine switches. On the other hand, datahalls DH3 and DH4 may include only leaf switches, but no spine switches. The connections between different switches and between datahalls DH1-DH4 are further discussed in detail below.

### Network Design

The data center 700 can implement a multi-tier network design to enable high-performance computing. In some embodiments, the network design of the data center can include a management fabric, a network fabric A (NA), and a network fabric B (NB). Different network fabrics, such as fabric NA and fabric NB serve different needs of the workload such as access to Compute/ML/GPU resources, Storage, External networks etc. The management network can provide administrative access to the could resources. The management network can include a set of management switches (e.g., TOR) to provide connectivity between the management nodes and compute nodes. The network fabric NA network can be configured to handle inbound traffic from internet, or external networks directed towards customer-facing applications or services. For example, the network fabric NA network facilitates communication between hosts in one datahall and internet, hosts in different datahalls, storage, etc. The network fabric NA can facilitate communication via CPUs of computing nodes. The network fabric NB handles internal communication between applications and data sources. For example, the network fabric NB provides RDMA traffic between GPUs and does not need direct internet connectivity therebetween. RDMA can bypass the operating system kernel, CPU, and can move data from one host memory to another host memory, for example.

In some embodiments, a network fabric can include a network of switches arranged within specified datahalls in a hierarchical manner corresponding to a two-tier CLOS network including a first tier of switches (T0-tier), and a second tier of switches (T1-tier). In some embodiments, the first tier of switches (T0-tier) may be referred as leaf switches. In various embodiments, the T0-tier switches may be arranged in one or more leaf racks, also referred as T0-tier racks. The second tier of switches (T1-tier) may be referred as spine switches. In various embodiments, the T1-tier switches may be arranged in one or more spine racks, also referred as T1-tier racks. Additionally or alternatively, other network fabric may be implemented without limiting the scope of the present disclosure. In some embodiments, the network fabric can include optical fiber cables installed for both north-south and east-west connectivity. The fiber installation for north-south connectivity can be same as the fiber installation for east-west connectivity. This design reduces average time to setup a new host machine rack or pod. Also, error rate associated with mispatch incidents or failed acceptance tests per 100 links can be reduced.

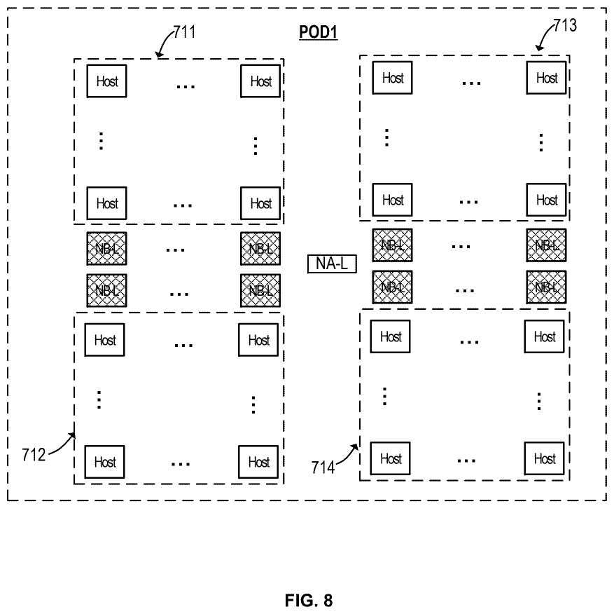

Referring to FIGS. 7-8, a datahall (e.g., DH1) can include a data center assembly comprising one or more pods (e.g., POD1, POD2, POD3, POD4) or clusters distributed within a first location (e.g., 710 in the datahall DH1 and 730 in the datahall DH2), and one or more network racks (e.g., NR1, NR2) distributed within a second location (e.g., 720 in the datahall DH1 and 740 in the datahall DH2) adjacent to the first location (e.g., 710 or 730). The illustrated example shows four pods POD1, POD2, POD3, POD4. Each of the pods POD1-POD4 can have the same configuration. Each of the pods POD1-POD4 may be associated with a predetermined maximum number of racks, and network switches. However, the present disclosure is not limited to a number of pods or same configuration of pods. It is possible to configure a data center assembly with less than four, more than four pods, pods with different rack arrangements, or other variations. Such variations can be supported by the cabling infrastructure in place.

A pod can be configured as a modular and scalable unit of a datahall. For example, a first pod POD1 can include a set of host machine racks 711-714, at least one network fabric NA leaf rack NA-L, and a set of network fabric NB leaf racks NB-L. The set of network fabric NB leaf racks NB-L can be part of a network fabric NB and configured to provide interconnections between e.g., GPUs within the host racks 711-714. The at least one NA leaf racks NA-L can be part of the network NA to allow communication between the GPUs within the first pod POD1, and devices outside the first pod POD1, services, internet, etc. In some embodiments, the first pod POD1 can further include a management rack (e.g., MTOR) which can be part of the management network.

In some embodiments, the at least one NA leaf racks NA-L can be placed in predetermined positions and associated cabling can be provided even before the host racks 711-714 are placed within the pod. As computing demand increases, host racks can be added and positioned within the pod at pre-determined locations. Then host racks can be instantaneously connected to the NA leaf racks NA-L of the network fabric so that the host racks are immediately serviceable upon connection. This can significantly improve datacenter scalability and reduce setup timing as the cabling and network infrastructure will be in place within a datahall. In some embodiments, each pod (e.g., POD1) can include a single NA leaf rack NA-L located such that all the host machines within the host machine racks 711-714 can be connected to the NA leaf rack NA-L. However, the present disclosure is not limited to a single NA leaf rack NA-L, and

FIG. 8 illustrates an enlarged view of the first pod POD1 showing an example locations assignment for computing and networking equipment in grid format, the first pod POD1 can include host machines (e.g., 711-714) arranged in rows and columns. Each of the rows can include predefined locations for host machine racks. Similarly, the network fabric NB leaf racks NB-L may be arranged in rows between a subset of host machines. For example, two consecutive locations for the network fabric NB leaf racks NB-L may be surrounded by consecutive locations for host machine racks. This design allows compact layout to establish connections between host machines through to the network fabric NB leafs NB-L. In some embodiments, the host machines (e.g., 711-714) can be connected to the NA leaf rack NA-L via overhead rack switches and breakout cables. The present disclosure is not limited the illustrated configuration, and other number of host machine rows, a number of host machines, locations for other networking equipment or computing devices are possible.

Referring back to FIG. 7, each of the datahalls DH1 and DH2 can include one or more network racks (e.g., NR1, NR2) provided at predefined locations (e.g., the second locations 720, 740). The network racks NR1, NR2 can be configured to facilitate communication between host machines distributed across different datahalls DH1-DH4. The network racks NR1, NR2 can be located close to a wall between the datahalls DH1 and DH2. This way, the cabling distance between the network racks NR1, NR2 of two different datahalls DH1, DH2 can be reduced, or minimized. A smaller cabling length can correspond faster data transmission rate with less transmission loss.

In some embodiments, the network rack NR1 can include a set of NB spine racks NB-S. Additionally or alternatively, the network rack NR1 can include a set of NA spine racks NA-S. The spine racks NA-S and NB-S can include switches (i.e., T1-tier switches). The set of NB spine racks NB-S can be arranged in an array or grid structure, and the set of NA spine racks NA-S can be arranged in a row or grid structure within the location 720. This layout allows access to T1-tier switches within a same location of the datahall (e.g., DH2). The network racks NR1 and NR2 can have the same configuration. Accordingly, the network racks NR1, NR2 can provide redundancy and improve reliability and availability of computing resources of the datacenter 700. In some embodiments, the number of NB spine racks can be more than the number of NA spine racks. The set of NB spine racks NB-S can be part of the network fabric NB network, and the set of NA spine racks NA-S can be part of the network fabric NA.

In some embodiments, the set of NB spine racks NB-S includes switches (i.e., T1-tier switches) connectable with switches (i.e., T0-tier switches) of the set of NB leaf racks NB-L associated with the host machine racks (e.g., 711-714) within the pods POD1-POD4. Furthermore, the set of NB spine racks NB-S can be divided into sub-groups. Each sub-group of the NB spine racks NB-S can be part of a network fabric plane. Each fabric plane can be labelled on the spine racks NB-S for easy visual identification during cabling. For example, in the illustrated example, in FIG. 8, the network rack NR1 includes a pre-determined number of spine racks (e.g., 32, 40, 50, 64, etc.) arranged in an array. The spine racks can be equally divided into a pre-determined number of NB spine planes (e.g., P1 through P8). As an example, each NB spine plane (e.g., P1) can include 4 spine racks. The network rack NR2 has the same configuration as the network rack NR1.

In some embodiments, the set of NA spine racks NA-S includes switches (i.e., T1-tier switches) connectable with switches (i.e., T0-tier switches) of the set of NA leaf racks NA-L associated with the host machine racks within the pods POD1-POD4. The set of NA spine racks NA-S can be part of another network fabric plane.

Within the datahall DH1, a network comprising a plurality of network fabrics (also referred to herein as fabric planes (FP) or planes) can be implemented. For example, the plurality of network fabric planes can include eight planes P1 through P8 comprising the NB spine racks NB-S, and a ninth plane P9 comprising the NA spine racks NA-S. Each fabric plane can include a network of switches arranged in a hierarchical two-tier fashion (including T0-tier of switches and a T1-tier of switches).

### Cabling Infrastructure

In the present disclosure, the datacenter 700 follows a combination of structured and unstructured cabling to leverage benefits of both the approaches. In the present disclosure, the structured cabling design follows predefined standards with preset connection points and pathways. In some embodiments, a number of connections points and associated cabling can be designed based on the system's bandwidth specification. The structured cabling is tested, organized, and labeled. Structured cabling can be expensive and time-consuming, but the benefits of operational efficiency, lower maintenance costs, and improved lifespan far outweigh the alternative.

Unstructured cabling, or point-to-point cabling, lacks an organized approach of structured cabling. With no predetermined cabling design, unstructured cabling can often be installed cheaply and quickly thereby providing higher degree of flexibility compared to the structured cabling. However, excessive use of unstructured cabling can causes serious issues with scalability and operational costs.

The cabling infrastructure can include a first set of cabling conduits configured to support cables (e.g., cabling trunks) internal to a particular datahall (e.g., DH1, DH2, DH3, or DH4), a second set of cabling conduits extending externally between two or more datahalls. The second set of cabling conduits can be configured to receive cabling extending between two or more datahalls to facilitate communication between compute nodes distributed across different datahalls. In some embodiments, the cabling infrastructure can be configured such that each compute node within a datahall (e.g., DH1) can communicate not only with each other compute node within that particular datahall (e.g., DH1), but also with each other compute nodes in other datahalls (e.g., DH2, DH3, DH4).

The present disclosure provides at least following advantages when using the structured and unstructured cabling. For example, point to point optical cable design for GPU/RDMA network within datahalls can have minimum db loss. A long fused cable (e.g., 560 feet) in conduit between two data halls can be used. Fiber trunks having groups of fiber strands can be designed and routed between data halls and later distributed into base 8, base 16 other number of strand counts. Example cabling is illustrated in FIGS. 9-14 and discussed in detail later in the disclosure.

In some embodiments of the hybrid structured cabling, each end-to-end optical link between active devices in the front-end and back-end fabrics is engineered to include a single passive patch panel, with all other mid-span interconnections realized via fusion splicing of bulk trunks to rack-level trunks inside sealed splice enclosures. This configuration applies to intra-hall host machine-to-leaf and leaf-to-spine paths as well as inter-hall leaf-to-spine paths routed through closed conduits. A closed conduits can be a physically enclosed raceway inaccessible to general personnel without tools or authorization. Active optical cables (AOCs) are not used; instead, discrete pluggable optics (for example, OSFP or QSFP form factors carrying DR-class or FR-class single-mode interfaces) mate to pre-terminated MPO and/or LC interfaces at the equipment face and at the single patch panel in order to minimize connector insertion loss, preserve RDMA link budgets over inter-hall distances, improve reliability by reducing points of failure, and maintain serviceability with field-replaceable transceivers. This single-patch-panel and no-AOC policy is compatible with the fused bulk trunk architecture (for example, 6,912-strand aggregates spliced to 288-strand trunks at hall boundaries) and the use of shuffle assemblies that split and merge optical lanes at rack patch panels to achieve the desired channel striping, and may be implemented across a variety of room layouts, strand counts, and optics types without departing from the scope of the invention.

### Cabling Infrastructure: Network Fabric NA

FIGS. 9-12 illustrates an example of a network fabric NA cabling within a datahall and between different datahalls. In the figures some of the components are omitted for visual clarity only and for explaining the concepts without limiting the scope of the present disclosure. The cabling can be provided based on a network design of the network fabric NB network. In some embodiments, each of the datahall DH1 and the datahall DH2 includes a plurality of network fabric NA planes, each plane can correspond to one rack. For example, each datahall DH1 and B can include one rack from each NA spine network fabric plane, and one rack for each of the NA leaf network fabric plane. In some embodiments, the network fabric NA can include a first plurality of planes to create the NA leaf network, and a second plurality of planes to create the NA spine network. As an example, cabling (e.g., base 16 fiber optic cable) can be provided to connect each leaf rack to a specified number (e.g., 8) of spine racks in datahall DH1 and another specified number (e.g., 8) of spine racks in the datahall DH2.

FIG. 9 is a simplified representation of cabling (e.g., 901, 902) between a NA leaf rack NA-L and the set of NA spine racks NA-S within the datahall DH1, and the cabling (e.g., 903, 904) between the NA leaf rack NA-L of the datahall DH1 and the set of NA spine racks NA-S within the datahall DH2. For example, the cabling 901-904 can be fiber optic cables configured to connect switches (e.g., T0-tier switches) in the NA leaf rack NA-L to switches (e.g., T1-tier switches) distributed across multiple spine racks NA-S. The cabling 901-904 can be supported by open conduits, closed conduits, shelves, other cable routing structures mountable against a wall or a ceiling, or a combination thereof. The cable supporting can be positioned at the wall, suspended from a ceiling, or other building structure. The cable supporting structure is not explicitly shown in the drawings for simplicity, however the cabling (e.g., 901-904) also indicates a cabling path between different equipment within the datahalls, and between datahalls. In some embodiments, the cable supporting structure can be a closed conduit so that the cables therein are inaccessible and secured from external intrusion or unsecured connections.

The cabling 901-904 can include fiber optic cables. The fiber optic cable can be configured to have a specified length, a maximum number of strands, and/or a specified number of breakouts to facilitate device-to-device connections. Based on equipment layout in the datacenter and the cabling infrastructure, one or more cabling may not be readily available and need to be configured or specifically constructed as discussed herein. For example, the cable trunks 901, 902 can be configured so that all the fiber optic strands are grouped together, some of the fiber optics are sub-grouped, and/or break outs are created at one or more ends.

For example, a first cable trunk 901 can include one end portion 901a connected to the T0-tier switches within one NA leaf rack NA-L, and a second end portion 901b configured to break out into multiple group of strands to enable connection with switches (e.g., T1-tier switches) within each of the NA spine racks NA-S of the network rack R1. The second cable trunk 902 can be same as the first cable trunk 901. In some embodiments, although the first cable trunk 901 and the second cable trunk 902 are shown as two separate cables, the cable trunks 901, 902 can be part of a single continuous cable comprising groups and sub-groups of strands. The groups and/or sub-groups of strands can correspond to a number of connections to be made at the leaf side and/or the spine side. The cable trunks 901, 902 do not have any spliced portions. In other words, all the strands of the cable trunks 901, 902 are continuous with no intermediate joints.

A third cable trunk 903 can be a composite cable having a first portion 903a extending within the datahall DH1, a second portion 903b extending along an outside space between the datahall DH1 and the datahall DH2, and a third portion 903c extending within the datahall DH2. In some embodiments, the first portion 903a of the third cable trunk 903 can be connected to the T0-tier switches within the NA leaf rack NA-L within the datahall DH1. The third portion 903c can be configured to break out into multiple group of strands to enable connection with switches (e.g., T1-tier switches) within each of the NA spine racks NA-S of the network rack R1 in the datahall DH2. In some embodiments, ends of the second portion 903b can be spliced to the first portion 903a and the third portion 903c. The fourth cable trunk 904 can be same as the third cable trunk 903.

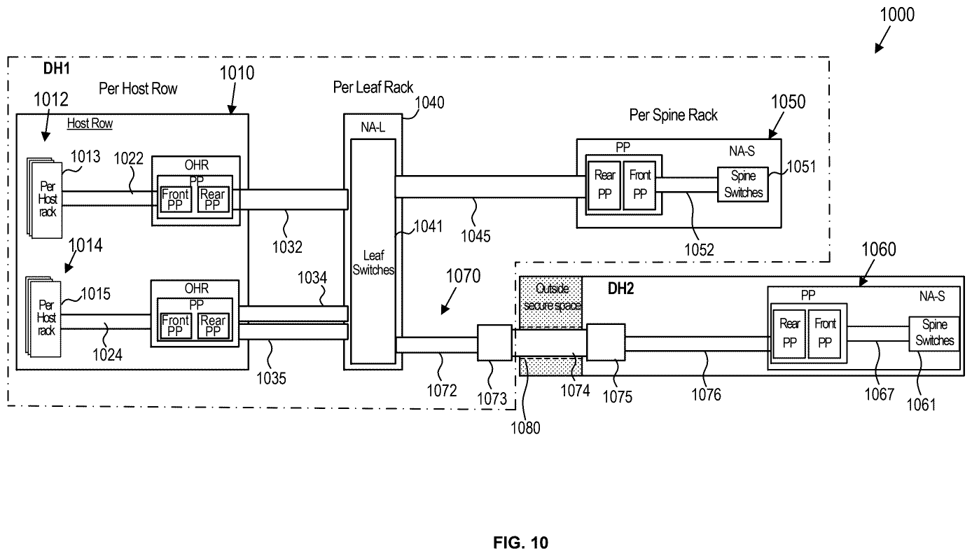

FIG. 10 illustrates an example of a network fabric NA fiber optic cable assembly 1000 within datahall DH1, and between datahalls DH1 and DH2. The network fabric NA fiber optic cable assembly 1000 can be employed within the data center 700 (in FIG. 7). The datahall DH1 includes a plurality of host machine rows, where each host machine row 1010 includes a plurality of host machine racks 1012. Each host machine rack 1013 (and 1015) can include a plurality of host machines, among other equipment. In some embodiments, a patch panel PP can be used to connect host machines within each host machine rack 1013 to leaf switches 1041 (i.e., T0-tier switches) within a NA leaf rack 1040. In some embodiments, a first patch panel PP can be located above a center of a first group of host machine racks 1012 (an example of 712 in FIG. 7), and a second patch panel PP can be located above a center of a second group of host machine racks 1014 (an example of 711 in FIG. 7).

### Cabling Infrastructure: Network Fabric NA-Datahall DH1

Referring to FIG. 10, cables 1022, 1024 between the patch panels PP and host machine racks 1012, 1014 can be of unstructured type providing point-to-point connections. For example, cables 1022 can be split-cables (e.g., Y-cables, shuffle cables), cables with multi-fiber push on (MPO) connectors, or other types of cables. The MPO cable may have pinned or unpinned ends, also referred as male or female ends, respectively. The cables 1022 may integrate 8, 12, 24, or other number of fiber strands into a single ferrule allowing high-density cable deployment for datacenter.

In some embodiments, cables 1032, 1034, 1035 between the patch panels PP and the NA leaf rack 1040 can be cable trunks having a large number of fiber strands. For example, the cable trunks 1032, 1034 can integrate 288 or more fiber strands. Accordingly, the cables 1032, 1034, 1035 can also be referred as cable trunks. The cables 1032, 1034, 1035 can be fiber optic cable trunks with connectors attached and tested at both ends. For example, a MPO connector at one end can be complementary to the patch panel PP and another MPO connector at the opposite end can be complementary to leaf switches 1041. This way, one or more host machine racks to be added and connected to the patch panels PP, thereby instantly connecting the added host machine racks to the network via the NA leaf rack 1040. The cables 1032, 1034, 1035 may have extra or more fiber strands than the total number of switches to be connected. These extra strands may be left unused or be readily available for scaling or other purposes.

In some embodiments, a cable 1045 can be provided to connect the NA leaf rack 1040 to one or more NA spine racks 1050. In some embodiments, the cable 1045 can be configured to break-out at a spine end to allow the NA leaf rack 1040 to connect with multiple spine racks 1050. For example, the cable 1045 can be examples of the cable trunks 901, 902 (in FIG. 9), the NA leaf rack 1040 can be an example of the leaf rack within the pods POD1-POD4 (in FIGS. 7-9), and the NA spine racks 1050 can be an example of the spine racks within the network rack NR1 (in FIGS. 7-9). Accordingly, the cable trunk 1045 may have predefined paths and supported by cable supporting structures along the path within the datahall DH1. The spine end of the cable 1045 can be configured to break-out into four subgroups of strands to allow one NA leaf rack 1040 to connect to four NA spine racks (NA-S in FIG. 7).

In some embodiments, a patch panel PP can be provided at the NA spine rack 1050. The cable 1045 can be connected to the switches 1041 of the NA leaf rack 1040 at one end, and the patch panel PP of the spine rack 1050 at the opposite end. The patch panel PP can be further connected to switches 1051 within the spine rack 1050 via cables 1052 (e.g., shuffle cables). For example, cables 1052 can be shuffle cables having at least two MPO connectors at one end and at least two MPO connectors at the opposite end. This way, one leaf switch 1041 within the leaf rack NA-L can be connected, via the patch panel, to two spine switches 1051 within the spine rack NA-S. Multiple such shuffle cables 1052 can be configured within a harness with visual identifiers (e.g., color coding and switch identifier) to simplify or minimize cable management.

The cables 1045 can be cable trunks having a large number of fiber strands. Similar to the cables 1032-1035, the cable 1045 can be fiber optic cable trunk with connectors attached and tested at both ends. For example, a connector at one end can be complementary to the patch panel PP associated with the spine racks 1050, and another connector at the opposite end can be complementary to the leaf switches 1041 of the NA leaf rack 1040.

Accordingly, in the above cabling infrastructure, the leaf switches 1041 of the NA leaf rack 1040 and the spine switches 1051 of the NA spine racks 1050 can be pre-connected. The cabling path between the NA leaf rack 1040 and the NA spine rack 1050 can be predefined. This cabling infrastructure provides a plug-and-play solution that allows one or more host machine racks to be added and connected to the patch panels PP, thereby instantly connecting the added host machine racks to the network via the NA leaf rack 1040. Thus, scalability of the datacenter can be increased without having to do complex cabling reruns or re-cabling. Furthermore, each of the cables 1022, 1024, 1032, 1034, 1035, 1045, 1052 can be labelled. This prevents misconnection between network devices, allows easy maintenance of the cabling infrastructure, and increases network reliability.

### Cabling Infrastructure: Network Fabric NA Network-Between Datahall DH1 and Datahall DH2

Referring to FIG. 10, the cabling infrastructure 1000 can further include cabling 1070 from the NA leaf rack 1040 within the datahall DH1 to one or more NA spines 1060 within another datahall DH2. The cabling 1070 can be an example of cabling 903, 904 in FIG. 9. The cabling 1070 can extend from the NA leaf rack 1040 into a conduit 1080 between the datahalls DH1 and DH2 to the NA spines 1060 in the datahall DH2. The length of the cabling 1070 can be less than 10 km. The cabling 1070 can be configured to include a pre-determined number of strands or a pre-determined group of strands to facilitate one-to-one, one-to-many, or many-to-many connections between the leaf switches of the rack 1040 and the spine switches of the rack 1060. Accordingly, one or more network topologies can be implemented within the datacenter to improve the reliability and availability of the datacenter.

In various embodiments, the cabling 1070 can be made from multiple fiber cables spliced together to create one contiguous fiber trunk to establish a device-to-device connection that minimizes dB loss over the fiber connection. This device-to-device cabling 1070 minimizes use of fiber connectors or does not use fiber connectors at all to connect fiber cables together. In some embodiments, using fiber splice methods can be used to join together fiber cables from different manufacturers. For example, high strand count Base-16 ribbon fibers can be distributed from datahalls DH1 and DH2 into multiple Base-8 fiber ribbons, in order to distribute multiple lower strand count fiber trunks within a particular datahall.

As shown in FIG. 10, the cabling 1070 can include a first cable portion 1072, a second cable portion 1074, and a third cable portion 1076. The first cable portion 1072 includes one end configured to connect with switches of the NA leaf rack 1040 in datahall DH1 and an opposite end configured to be spliced and connect with one end of the second cable portion 1074. For example, the first cable portion 1072 can be open at the one end and include connectors at opposite ends. For example, the leaf-side end of the first cable portion 1072 may include MPO connectors to connect with leaf switches 1041 and the opposite end may not include any connectors so that the fibers can be spliced. The second cable portion 1074 can extend outside the datahalls DH1 and DH2 within a conduit 1080. The conduit 1080 can be a closed conduit so that the second cable portion 1074 is not accessible so that data transmitted through the cables 1070 is not accessible outside the datahalls DH1 and DH2. The second cable portion 1074 includes one end configured to be spliced and connect with one end of the first cable portion 1072, and an opposite end configured to be spliced and connect with one end of the third cable portion 1076. In some embodiments, the second cable portion 1074 can be open at both ends. The third cable portion 1076 can extend within the datahall DH2 and connect with switches within the NA spine rack 1060. The third cable portion 1076 can include one end configured to be spliced and connect with one end of the second cable portion 1074, and an opposite end configured to connect with switches of the NA spine rack 1060 in datahall DH2. For example, the third cable portion 1076 can include a connectors (e.g., including MPO connector to connect with the spine switches or patch panels) at one end and open at the opposite end (e.g., splicing end). Accordingly, the cabling 1070 can establish a network connection between the host machines in the datahall DH1 and datahall DH2 and facilitate secure data transmission therebetween.

In some embodiments, the second cable portion 1074 may also be referred as a bulk cable trunk, which can be formed by splicing together multiple cables 1072 to form a single integrated cable. For example, the cable 1072 at one end (and 1076 at another end) may have 288 strands, while the bulk cable 1074 may have 6912 strands obtained by splicing 24 of the cables 1072 (and 1076) together into a single bulk cable. This way, all the fiber stands can be conveyed between the datahalls DH1 and DH2 as a single bulk cable rather than handling individual smaller cables. This reduced maintenance issues and also reduces data loss as no connectors are needed between the cables 1072, 1076 located in different datahalls. The bulk cable 1074 can be substantially heavy and may be supported in a conduit sized to receive the bulk cable 1074. Depending on the number of spine racks and leaf racks to be connected between the datahalls DH1, DH2, the total number of bulk cables 1074 passing through the conduit 1080 can be 10, 15, 20, or more.

In some embodiments, the cabling 1070 also referred as the cabling trunks 1070 running from the NA leaf switches in the datahall DH1 to the NA spine switches in the datahall DH2 can pass through optical splice enclosures 1073, 1075. The optical splice enclosure 1073, 1075 can be a devices where the ends of cables (e.g., 1072 and 1074, and 1074 and 1076) can be joined together via fusion splicing. Accordingly, the enclosure 1073, 1075 may be referred as a fusion panel. The enclosures 1073, 1075 can be located within respective datahalls DH1, DH2 at locations close to walls between the datahalls DH1 and DH2.

In some embodiments, cables 1067 (similar to the cable 1052) can be utilized to efficiently and economically grow the size of the high-performance compute cluster by utilizing every channel available across all switch ports on the network nodes in the high-performance cluster. For example, the cables 1067 can be shuffle cables or breakout cables configured to couple patch panels to the spine switches in the NA spine rack NA-S. For example, cables 1067 can be shuffle cables having at least two MPO connectors at one end and at least two MPO connectors at the opposite end. This way, one leaf switch 1041 can be connected, via the patch panel, to two spine switches 1061 within the spine rack NA-S in Datahall DH2. The shuffle cables 1067 can be configured within a harness with visual identifiers (e.g., color coding and switch identifier) to simplify or minimize cable management.

The cabling 1000 above discusses connections within datahall DH1 and from the datahall DH1 to the datahall DH2. Similarly, the cabling 1000 can be employed to establish connections within the datahall DH2 and from the datahall DH2 to the datahall DH1. For example, instances of cabling 1022, 1024, 1032, 1034, 1035, 1045, 1052 can be used to connect host machines, leaf switches and spine switches within the datahall DH2. Instances of the cabling 1070 can be used to connect leaf switches of the NA leaf rack (e.g., NA-L) in POD1-POD4 in datahall DH1 to spine switches of the NA leaf racks (e.g., in racks NR1, NR2) in datahall DH2. This way, redundancy between host machines in datahall DH1 and the datahall DH2 can be achieved so that even if one datahall (e.g., A) is unavailable or under maintenance, the other datahall (e.g., B) can be available to provide any cloud infrastructure and services.

Accordingly, in the above cabling infrastructure (e.g., 1070) provided between the datahalls DH1 and DH2, the leaf switches 1041 of the NA leaf rack 1040 of the datahall DH1 can be pre-connected to and the spine switches of the NA spine racks 1060 of the datahall DH2. The cabling path between the NA leaf rack 1040 and the NA spine rack 1060 can be predefined. This cabling infrastructure provides a plug-and-play solution that allows one or more host machine racks to be added to either the datahall DH1 or the datahall DH2, or both, and be instantly connected to the network between the datahalls DH1 and DH2. Thus, scalability of the datacenter can be multiplied without having to do complex cabling reruns or re-cabling. Furthermore, each of the cables can be labelled to indicate the leaf switch, spine switch, a datahall, or other identifying network devices. This prevents misconnection between network devices, allows easy maintenance of the cabling infrastructure, and increases network reliability.

Cabling Infrastructure: Network Fabric NA Network-Between Datahall DH1, Datahall DH2, and Datahall DH3 and/or DH4.

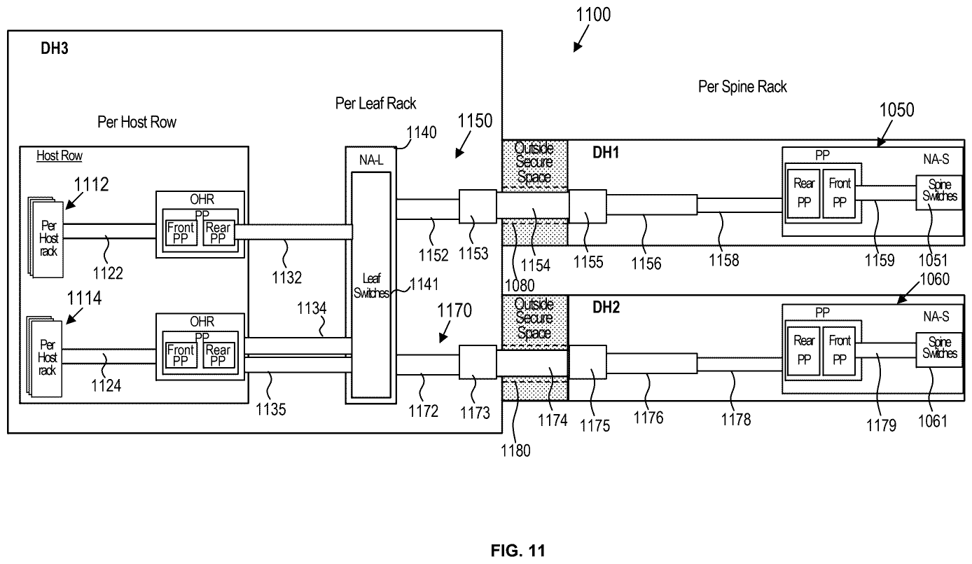

FIG. 11 illustrates an example of a network fabric NA fiber optic cable assembly 1100 within datahall DH3, and between datahalls DH1, DH2, and DH3. The datahall DH3 can include host machines 1112, 1114, and leaf switches within a NA leaf rack 1140. Note, the datahall DH3 does not include any spine switches, unlike in the datahalls DH2 and DH2. The datahall DH4 can have the same layout and cabling as datahall DH3. In some embodiments, the datahall DH3 can include similar cabling as the datahall DH1.

In some embodiments, the datahall DH3 includes cabling 1122, 1124, 1132, 1134, 1135, 1152 that can be same as the cabling 1022, 1024, 1032, 1034, 1035, 1052 within the datahall DH1 (in FIG. 10). Furthermore, cabling 1150 can be provided between the datahall DH3 and the datahall DH1, and cabling 1170 can be provided between the datahall DH3 and the datahall DH2. The cabling 1150 and 1170 can be the same, and configured to connect devices in datahall DH3 to the respective datahalls DH1 and DH2. For example, the cabling 1150 can be configured to connect the leaf switches 1141 in the leaf rack 1140 to the spine switches 1051 in the NA spine racks 1050 in the datahall DH1. Similarly, the cabling 1170 can be configured to connect the leaf switches 1141 in the leaf rack 1140 to the spine switches 1061 in the NA spine racks 1060 in the datahall DH2. This way, the host machines 1112, 1114 can be connected with host machines of the datahalls DH1 and DH2 thereby scaling the computing capacity of the datacenter.

In some embodiments, the cabling 1150 and 1170 can be same as the cabling 1070 discussed with respect to FIG. 10. For example, the cabling 1150 can include cable portions 1152, 1154, 1156, similar to the cable portions 1072, 1074, 1076 (in FIG. 10), respectively. Similarly, the cabling 1170 can include cable portions 1172, 1174, 1176, similar to the cable portions 1052, 1054, 1056 (in FIG. 10), respectively. The cable 1174 can be a spliced cable passing through a closed conduit 1180 within an outside space between the datahalls DH3 and DH2. Discussion of each of the cable portions is omitted herein for brevity. Furthermore, optical splice enclosure 1153, 1155 (and 1173, 1175) can be similar to the enclosures 1073, 1075, respectively. In some embodiments, the cabling portion 1156 (and 1176) can break out into a smaller group of fiber optic cables 1158 (and 1178). In some embodiments, cables such as shuffle cables 1159, 1179 may be used to connect the patch panels to the spine switches.

### Cabling Infrastructure: Network Fabric NB-Withing Datahall DH1, and Between Datahalls DH1 and DH2

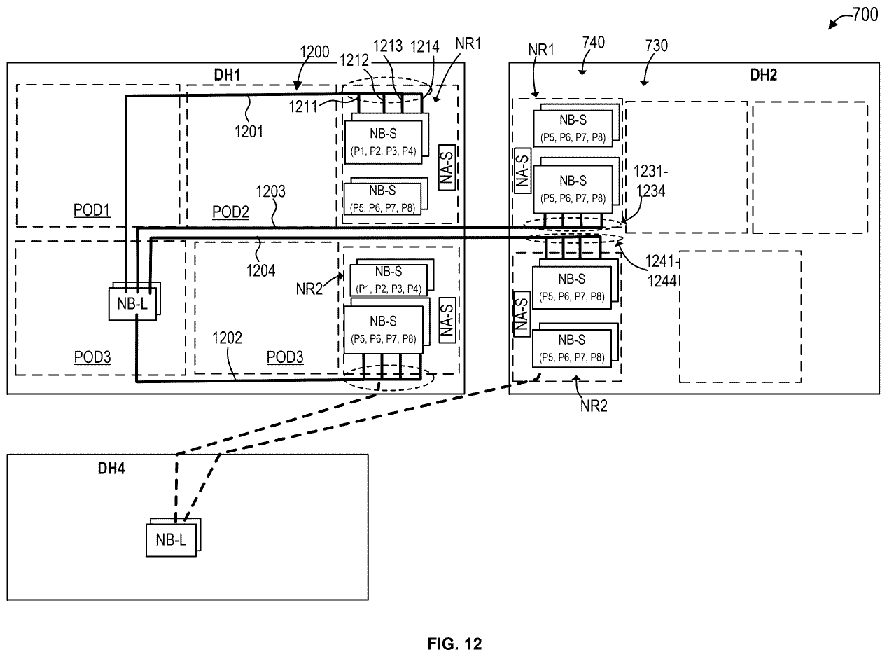

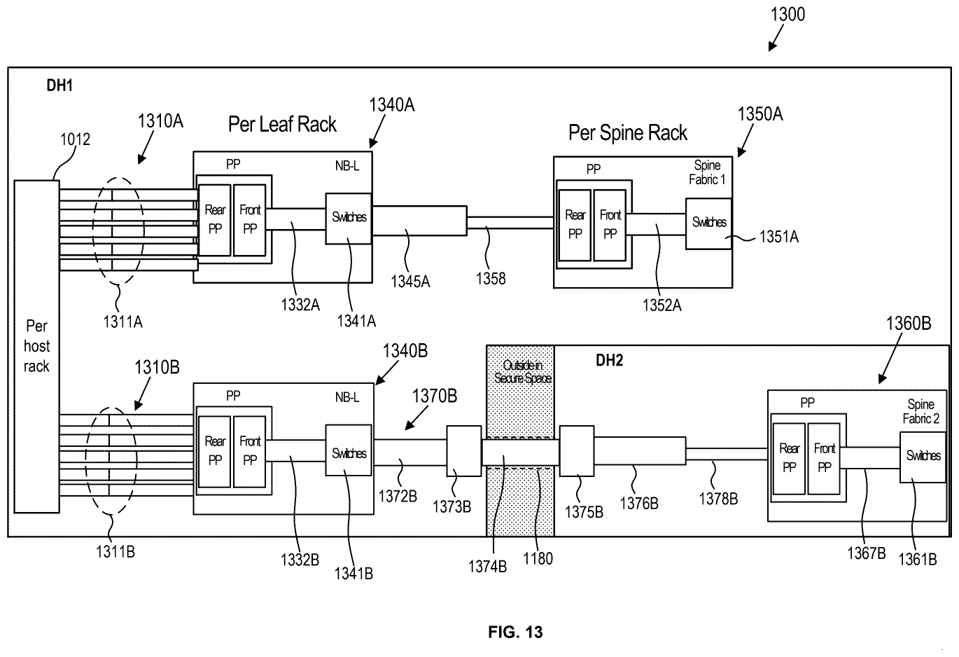

FIGS. 12 and 13 illustrates an example of a network fabric NB fiber optic cable assembly 1200 within datahall DH3, and between datahalls DH1, DH2, and DH3. The cabling 1200 can be provided based on a network design of the network fabric NB. In some embodiments, each of the datahall DH1 and the datahall DH2 includes a plurality of network fabric NB planes, each plane can correspond to one rack. For example, each datahall DH1 and DH2 can include one rack from each NB spine network fabric plane, and one rack for each of the NB leaf network fabric plane. In some embodiments, the network fabric NB can include a first plurality of planes to create the leaf network, and a second plurality of planes to create the spine network. This network configuration provides redundancy, for example, if one datahall (e.g., B) is unavailable then the datahall DH1 can be used to fulfil the computing needs. Such network fabric also allows a customer to start using all host machines if the datahall DH1 becomes available first.

In some embodiments, each NB leaf rack is cabled to spine switches belonging to the corresponding fabric planes in both spine rooms (e.g., DH1 and DH2), so that every leaf rack has deterministic, dual-room leaf-to-spine trunks into the same set of disjoint RDMA planes. Datahalls DH1 and DH2 may each include half of the spine capacity, and each NB leaf rack connects to both spine rooms to provide path diversity, remove single points of failure at the datahall level, and enable active-active service continuity because both datahalls concurrently carry production traffic for the same planes and can absorb a loss of either room without cold start. This dual-datahall attachment is implemented using high-count, fused bulk trunks between rooms that are transitioned to rack-level e.g., 288-strand trunks and pre-terminated MPO interfaces, with a single patch panel per cable path and shuffle assemblies used to split and merge optical lanes at the rack boundary. Accordingly, only a single patch point may be included between the network fabric tiers. Thereby, RDMA link budgets are preserved and serviceability can be maintained while the full set of network fabric NB fabric planes remain present and active across both datahalls to achieve immediate redundancy and operability even if one spine datahall comes online earlier than the other.

FIG. 12 is a simplified representation of cabling (e.g., 1201, 1202) between a NB leaf rack NB-L and a subset of NB spine racks NB-S within the datahall DH1, and the cabling (e.g., 1203, 1204) between the NB leaf rack NB-L of the datahall DH1 and a subset of NB spine racks NB-S within the datahall DH2. For visual reference and better clarity, the subsets of NB leaf and the subset of NB spines are represented with same shading without limiting the scope of the present disclosure to a particular number of leaf-spine connections.

As an example, the cabling 1201 establishes connections between a first NB leaf rack NB-L and a first subset of NB spine racks NB-S in the first network rack NR1 in the datahall DH1. The cabling 1202 establishes connections between the first NB leaf rack NB-L and a second subset of NB spine racks NB-S in the second network rack NR2 in the datahall DH1. Additionally or alternatively, the cabling 1203 establishes connections between the first NB leaf NB-L and a first subset of NB spine racks NB-S in the first network rack NR1 in the datahall DH2. The cabling 1204 establishes connections to the first NB leaf NB-L and a second subset of NB spine racks NB-S in the second network rack NR2 in the datahall DH2. This allows each host machine to communicate with each other host machine within the datahall DH1, and also with each host machine within the datahall DH2.

The cabling 1201-1204 can be fiber optic cables configured to connect switches (e.g., T0-tier switches) in the NB leaf rack NB-L to switches (e.g., T1-tier switches) distributed across multiple spine racks NB-S. The cabling 1201-1204 can be supported by open conduits, closed conduits, shelves, other cable routing structures mountable against a wall or a ceiling, or a combination thereof. The cable supporting can be positioned at the wall, suspended from a ceiling, or other building structure. The cable supporting structure is not explicitly shown in the drawings for simplicity, however the cabling (e.g., 1201-1204) also indicates a cabling path between different equipment within the datahalls, and between datahalls. In some embodiments, the cable supporting structure can be a closed conduit so that the cables therein are not accessible.

The cabling 1201-1204 can be configured to have a specified length, a maximum number of fiber optic strands, and/or a specified number of breakouts to facilitate device-to-device connections. Based on equipment layout in the datacenter and the cabling infrastructure, one or more cabling may not be readily available and need to be configured or specifically constructed as discussed herein. For example, the cable trunks 1201, 1202 can be configured so that all the fiber optic strands are grouped together, some of the fiber optics are sub-grouped, and/or break outs are created at one or more ends.

For example, a first cable trunk 1201 can include a first end connected to the T0-tier switches within the NB leaf rack NB-L, and a second end configured to break out into multiple group of strands to enable connection with switches (e.g., T1-tier switches) within the subset 1211-1214 of the NB spine racks NA-S of the network rack R1. The second cable trunk 1202 can be same as the first cable trunk 1201. In some embodiments, although the first cable trunk 1201 and the second cable trunk 1202 are shown as two separate cables, the cable trunks 1201, 1202 can be part of a single continuous cable comprising groups and sub-groups of strands. The groups and/or sub-groups of strands can correspond to a number of connections to be made at the leaf side and/or the spine side. The cable trunks 1201, 1202 do not have any spliced portions. In other words, all the strands of the cable trunks 1201, 1202 are continuous with no intermediate joints.

A third cable trunk 1203 can be similar to the cable trunk 903. For example, the third cable trunk 1203 can be a composite cable having a first portion extending within the datahall DH1, a second portion extending along an outside space between the datahall DH1 and the datahall DH2, and a third portion extending within the datahall DH2. In some embodiments, the first portion of the third cable trunk 1203 can be connected to the T0-tier switches within the NA leaf rack NA-L within the datahall DH1. The third portion can be configured to break out into multiple group of strands to enable connection with switches (e.g., T1-tier switches) within a subset of the NA spine racks NA-S of the network rack R1 in the datahall DH2. In some embodiments, ends of the second portion can be spliced to the first portion and the third portion. The fourth cable trunk 1204 can be same as the third cable trunk 1203.

FIG. 12 also illustrates example cabling paths 1231, 1232 between the NB leaf rack NB-L in the datahall DH4 and the NB spine racks NB-S in the respective datahall DH1 and B. Similar cabling paths (not illustrated) can be predefined between the NB leaf rack NB-L in the datahall DH3 and the NB spine racks NB-S in the respective datahalls DH1 and DH2. It can be understood that several components shown in FIGS. 7-8 are omitted in FIG. 12 to better illustrate some example cabling paths without limiting the scope of the present disclosure.

FIG. 13 illustrates an example of a network fabric NB fiber optic cable assembly 1300 within datahall DH1, and between datahalls DH1 and DH2. The network fabric NB fiber optic cable assembly 1300 can be employed within the data center 700 (in FIG. 7). In FIG. 13, the reference numbers ending with letters ‘A’ indicate corresponding component (e.g., cabling, switches, etc.) located within and extending within the datahall DH1, and reference numbers ending with letter ‘B’ indicate corresponding component (e.g., cabling, switches, etc.) along a cabling path leading to the datahall DH2. Same components across different figures may have the same reference number (except for the ending letters A or B).

The datahall DH1 includes a plurality of host machine racks, where host machines within each host machine rack 1012 are connected to leaf switches 1341A (i.e., T0-tier switches) within a NB leaf rack 1340A via patch panels, as shown. The leaf switches 1341A can be further connected to the spine switches 1351A. Since the datahall DH1 and the datahall DH2 have the same configuration, similar network fabric NB connections can be established in the datahall DH2. Furthermore, any modular arrangements such as POD1-POD4 (see FIG. 7) within other datahalls (e.g., DH3 or DH4) can also have corresponding network fabric NB cabling arrangements. The NB leaf rack 1340A can be an example of the NB leaf rack NB-L located within a pod (e.g., POD1) in FIG. 7. The NB spine rack 1350A can be an example of the NB spine rack NB-S located within a network rack NR1/NR2 in FIG. 7.

In some embodiments, cabling 1310A and 1310B establishing the network fabric NB connections can include cables similar to one or more cabling used to establish network fabric NA connections (shown in FIGS. 9-12). For example, the cabling for network fabric NB connections can also be fiber optic cables or cable trunks having a specified length, a particular grouping of fiber strands, a predefined cabling paths, and cable supporting structures. Furthermore, cables can be configured to include one end with MPOs and an opposite bare end for splicing. A MPO can be pinned (e.g., male part) or unpinned (e.g., female part). In some embodiments, adapters may be used to between pinned and unpinned ends of the MPOs. Furthermore, cables with break outs, and shuffle cables may be also be included within the network fabric NB cabling infrastructure 1310A and 1310B. The break out or shuffle cables may have unpinned ends.

Network Fabric NB Cabling within the Datahall DH1

In some embodiments, the cabling 1310A can include a set of cables 1311A configured to connect host machines within each host machine rack 1012 at one end and to the patch panel PP at the opposite end. For example, the host machine end of each cable 1311A can include MPOs corresponding to a number of host machines within the host machine rack 1012. As an example, each cable 1311A can include 144 fiber strands with the host machine end having 18 MPOs. In some embodiments, a spare cable having unconnected strands may be included within the set of cables 1311A. The spare cable may include MPOs and fiber strands that may be used to connect an increased capacity as a back up in case of any cable or connection failure.

In some embodiments, the cabling 1310A can include shuffle cables 1332A configured to connect the patch panel PP to the leaf switches 1341A within the NB leaf rack 1340A. The shuffle cables 1332A can be configured in different ways to split a host machine port into multiple links to increase connectivity to the host machines. For example, the shuffle cable can be configured to split 800 Gb/s host machine port can be split into 4 200 Gb/s links, 8 100 Gb/s links, or other number of links. In some embodiments, the shuffle cables 1332A can be configured to establish connections across different fabric planes.

In some embodiments, the cabling 1310A can include a cable trunk 1345A configured to connect the leaf switches 1341A of the NB leaf rack 1340A to the patch panel PP of NB spine rack 1350A. As an example, the cable trunk 1345A can be a group of 16 cables, each cables having a specified number of fiber strands (e.g., 288 or more), or a group of 64 cables having a specified number of fiber strands (e.g., 72 or more), or other number of cables and fiber strands. The cable trunk 1345A can included pinned or unpinned MPOs to connect to the leaf switches 1341A at one end. The opposite end of the cable trunk 1345A can break out into one or more cables 1358 having smaller number of group of strands (e.g., group of 72 strands) with ends including pinned or unpinned MPOs to connect to the patch panels PP of the NB spine rack 1350A.

In some embodiments, the cabling 1310A can include shuffle cables 1352A configured to connect the patch panel PP to the spine switches 1351A within the NB spine rack 1340A. The shuffle cables 1352A can be configured similar to the shuffle cables 1332A.

### Network Fabric NB Cabling Between the Datahall DH1 and the Datahall DH2

In some embodiments, the cabling 1310B can be similar to cable 1310A. The cabling 1310B can include a set of cables 1311B configured to connect host machines within each host machine rack 1012 to the leaf switches 1341B of the NB leaf rack 1340B. The cabling 1310A can establish such connection through the patch panel PP and shuffle cables 1332B (similar to the shuffle cable 1332A).

In some embodiments, the cabling 1310B can include a cabling 1370B configured to connect the leaf switches 1341B in datahall DH1 to NB spine switches 1361B in the datahall DH2. The NB spine switches 1361B can be example of the spine switches within the network racks NR1, NR2 (see FIGS. 7 and 12) in the datahall DH2. The cabling 1370B can be made from multiple fiber cables spliced together to create one contiguous fiber trunk, similar to the cable trunk 1070 (in FIG. 10). The cabling 1370B can include a first cable portion 1372B, a second cable portion 1374B, and a third cable portion 1376B. These cable portions 1372B, 1374B, and 1376B can be same as the cable portions 1072, 1074, and 1076, respectively discussed with respect to FIG. 10 above. Hence, detailed discussion of these cable portions is omitted here for brevity. The cabling 1370B can establish a network connection between the host machines in the datahall DH1 and datahall DH2 and facilitate secure data transmission therebetween.

Furthermore, similar to the cabling 1070, the cabling 1370B extending from the NB leaf switches in the datahall DH1 to the NB spine switches in the datahall DH2 can pass through optical splice enclosures 1373B, 1375B (same as the enclosures 1073, 1075). For example, the optical splice enclosure 1373B, 1375B can be a device where the ends of cables (e.g., 1372B and 1374B, and 1374B and 1376B) are joined together via fusion splicing.

In some embodiments, an end of the cable trunk 1376B may be configured to connect with spine switches. Hence, the cable trunk 1376B can be configured different from the cable 1076 as the number of leaf switches can be different from the spine switches. For example, an end of the cable trunk 1378B can break out into one or more cables 1378B having smaller number of group of strands (e.g., group of 72 strands) with ends including pinned or unpinned MPOs to connect to the patch panels PP of the NB spine rack 1360B.

In some embodiments, the cabling 1370B can include shuffle cables 1367B configured to connect the patch panel PP to the spine switches 1361B within the NB spine rack 1360B in the datahall DH2. The shuffle cables 1367B can be configured similar to the shuffle cables 1352A. For example, the shuffle cables 1332A, 1352A, 1332B, 1367B can be similar to the shuffle cables 1052 or 1067.

In some embodiments, the network fabric NB planes are implemented as a plurality of disjoint fabric planes that are not interconnected at a second switching layer (e.g., L2 of two-tier CLOS). Instead, any cross-plane communication between host machines can be accomplished via the intra-rack switch subsystem configured to convey data between GPUs independently of the network fabric (e.g., Ethernet fabric) so that per-plane forwarding domains remain electrically and logically isolated. This segregation localizes failures, preserves deterministic per-plane routing, and avoids inter-plane bridging or routing complexity in the network fabric while still enabling all-to-all host machines connectivity through the combination of multi-plane NIC breakout at each host machine and data movement at the node/rack layer. Plane isolation further supports predictable latency and scalable expansion by allowing additional planes and capacity to be added across datahalls while maintaining uniform hop counts in the two-tier CLOS fabric, and coexists with the active-active, dual-datahall leaf-to-spine attachments and fused inter-datahall trunks described herein.

In some embodiments, the network fabric NA and network fabric NB may both use the same network plane topology. For example, there can be 9 total planes: one network fabric NA plane and 8 network fabric NB planes. Each disjoint plane can include: (i) 2-tier CLOS with 128 Spine switches, (ii) 256 leaf switches, and (iii) all leaf and spine network racks can use 8 switches. The NB leaf racks can include, but not limited to: shuffle cables in each NB leaf rack to route (e.g., 100 Gbps, 200 Gbps, etc.) links to ports on rack systems. Each network fabric NB leaf rack can include 8 switches, 2 leaf switches per plane, and 4 planes per rack. All 8 leaf switches in a leaf rack can connect to NB spine planes in a single datahall (e.g., A or B). The NA leaf racks can include, but not limited to: 2-way breakout cables in NA leaf racks connect to 2 rack systems with specified Gbps (e.g., 100 Gbps, 200 Gbps) channel using DR4 optics. Compute tors and transit can connect to NA leaf racks with DR1 100 Gbps optics to 4×100 breakouts from 2×DR4 optics on leaf. Spine racks can include, but not limited to: striping: links (e.g., 200 Gbps) from every leaf switch to every spine switch via shuffle. Shuffle cables of each spine rack can swap 200 Gbps channels between 400 Gbps physical MPO8 connectors. It can be understood that the above number of switches, speeds, breakouts, type of optics, etc. are only examples and other numbers and optics are possible without limiting the scope of the present disclosure.

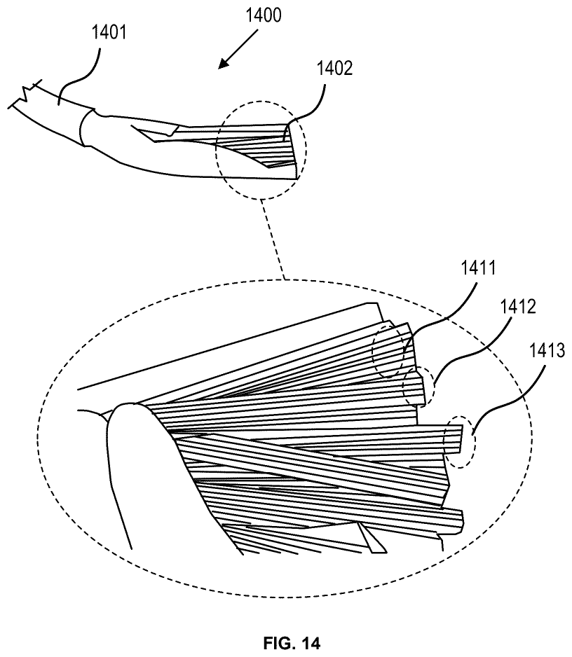

FIG. 14 illustrates an example of a bulk cable trunk 1400. The bulk cable trunk 1400 can be used as a portion of cables extending outside the two datahalls (e.g., DH1 and DH2). For example, the bulk cable trunk 1400 can be an example of the cable portions 1074 (in FIG. 10) and 1374B (in FIG. 13). The ends of the bulk cable trunk 1400 can be open (or not pinned or terminated with a connector) so that the strands therein may be spliced together. The bulk cable trunk 1400 includes an outer sheath 1401 within which a plurality fiber strands 1402 may be aggregated. The fiber stands 1402 can be further grouped into a subset of cable trunks e.g., 1411, 1412, 1413. For example, the total number of fibers can be 6912 integrated within the outer sheath 1401. The subset of cable trunks 1411, 1412, 1413 can include, for example, 288 fiber strands. The cable trunks 1411, 1412, 1413 may include visual identification such as colors, tags, ties, etc. to identify different leaf switches and/or spine switches.

The present disclosure can provide several advantages. For example, significant performance improvements and cost savings by optimizing fiber connections can be achieved. Splicing fiber trunks together minimizes signal loss and reduces the need for costly connectors, which helps maintain better network performance and lower operational costs. Additionally, it improves reliability, minimizing points of failure and ensuring higher uptime for critical services. Using fiber splice methods to combine materials from multiple OEMs provides flexibility in choosing optical fibers from different manufacturers and achieve scalability. For example, different fibers can be mixed and matched without being constraint into one supplier, enabling cost-effective and easier scaling of infrastructure. Distributing high strand count fibers (e.g., 144, 288 or more) into smaller groups or base (e.g., base-8, 12, 14, or other number) fibers allows for more precise bandwidth management, reducing waste and increasing resource utilization. Utilizing shuffle cables can provide efficient grow in high-performance compute clusters by maximizing the use of available switch ports and channels. This leads to more balanced networks, allowing for cost-effective scaling without needing significant new infrastructure. These methods collectively enhance overall performance, reduce costs, and provide flexibility for future growth.

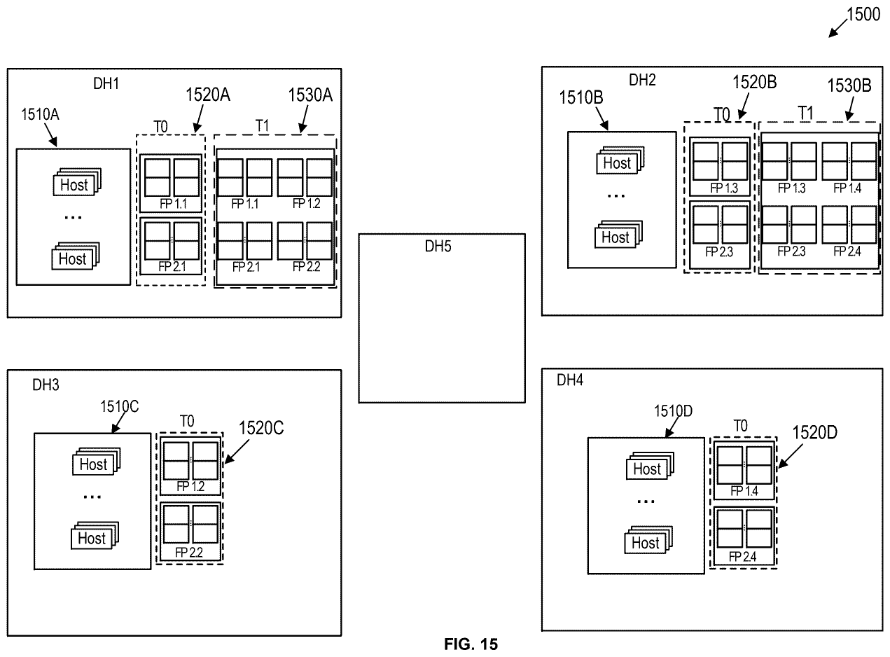

FIG. 15 illustrates another example layout of a data center 1500. The data center 1500 can include the datahalls DH1-DH5 physically isolated from each other, while being communicably coupled to each other via cabling and networking equipment. Similar components between the datahalls have same numbering followed by a letter A, B, C, or D corresponding respective datahalls DH1-DH4. The datahalls DH1 and DH2 can have similar or substantially the same layout. The datahalls DH3 and DH4 may have similar or substantially the same layout, but include different networking setup from datahalls DH1, DH2. For example, datahalls DH1 and DH2 may include leaf switches and spine switches. On the other hand, datahalls DH1 and DH4 may include only leaf switches, but no spine switches. Although, the datahalls DH1-DH5 are positioned similar to that in the data center 700, the computing and networking equipment may be located differently. The data center 1500 may implement same network design as the data center 700. For example, the data center 1500 can include a two-tier CLOS network including a leaf switches (T0-tier), and a spine switches (T1-tier).

In the illustrated embodiment. in FIG. 15, the datahall DH1 can include a plurality of host machine racks 1510A positioned within a first location, a plurality of leaf racks 1520A positioned within a second location, and a plurality of spine racks 1530A positioned within a third location. The host machines within the host machine racks 1510A can be connected to T0-tier switches within the leaf racks 1520A. The T0-tier switches can be connected to T1-tier switches within the spine racks 1530A. In the datahall DH2, host machine racks 1510B, leaf racks 1520B, and spine racks 1530B can be positioned similar to datahall DH2. In datahalls DH3 and DH4, the host machine racks 1510C, 1510D, and leaf racks 1520C, 1520D can be placed. No spine racks are provided in the datahalls DH3 and DH4.

Although FIG. 15 does not illustrate cabling, it can be similar to cables used in the data center 700 discussed above. For example, cabling between host machines to the leaf switches can be similar to cabling between host machines and NA leaf switches in FIG. 9-13, cabling between T0-tier and T1-tier switches can be similar to that shown in FIG. 9-13. Furthermore, cabling (e.g., including spliced cabling) extending between the datahalls DH1 and DH2 can be similar to the that shown in FIG. 9-13. Cabling within datahall DH3/D and between datahalls DH1, DH1, DH3/DH4 can be similar to that discussed with respect to FIG. 11. For example, the cabling between host machines 1510C and T0-tier switches in the leaf racks 1520C, and cabling between the leaf racks 1520C and the T1-tier switches in datahalls DH1 and DH2 can be similar to that shown and discussed with respect to FIG. 11. As such, detailed discussion of cabling is omitted herein for brevity.

### Example Cloud Infrastructure Embodiment

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 16 is a block diagram 1600 illustrating an example pattern of an IaaS architecture, according to at least one embodiment. Service operators 1602 can be communicatively coupled to a secure host tenancy 1604 that can include a virtual cloud network (VCN) 1606 and a secure host subnet 1608. In some examples, the service operators 1602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1606 and/or the Internet.

The VCN 1606 can include a local peering gateway (LPG) 1610 that can be communicatively coupled to a secure shell (SSH) VCN 1612 via an LPG 1610 contained in the SSH VCN 1612. The SSH VCN 1612 can include an SSH subnet 1614, and the SSH VCN 1612 can be communicatively coupled to a control plane VCN 1616 via the LPG 1610 contained in the control plane VCN 1616. Also, the SSH VCN 1612 can be communicatively coupled to a data plane VCN 1618 via an LPG 1610. The control plane VCN 1616 and the data plane VCN 1618 can be contained in a service tenancy 1619 that can be owned and/or operated by the IaaS provider.

The control plane VCN 1616 can include a control plane demilitarized zone (DMZ) tier 1620 that acts as a perimeter network (e.g., portions of a corporate network between the corporate intranet and external networks). The DMZ-based servers may have restricted responsibilities and help keep breaches contained. Additionally, the DMZ tier 1620 can include one or more load balancer (LB) subnet(s) 1622, a control plane app tier 1624 that can include app subnet(s) 1626, a control plane data tier 1628 that can include database (DB) subnet(s) 1630 (e.g., frontend DB subnet(s) and/or backend DB subnet(s)). The LB subnet(s) 1622 contained in the control plane DMZ tier 1620 can be communicatively coupled to the app subnet(s) 1626 contained in the control plane app tier 1624 and an Internet gateway 1634 that can be contained in the control plane VCN 1616, and the app subnet(s) 1626 can be communicatively coupled to the DB subnet(s) 1630 contained in the control plane data tier 1628 and a service gateway 1636 and a network address translation (NAT) gateway 1638. The control plane VCN 1616 can include the service gateway 1636 and the NAT gateway 1638.

The control plane VCN 1616 can include a data plane mirror app tier 1640 that can include app subnet(s) 1626. The app subnet(s) 1626 contained in the data plane mirror app tier 1640 can include a virtual network interface controller (VNIC) 1642 that can execute a compute instance 1644. The compute instance 1644 can communicatively couple the app subnet(s) 1626 of the data plane mirror app tier 1640 to app subnet(s) 1626 that can be contained in a data plane app tier 1646.

The data plane VCN 1618 can include the data plane app tier 1646, a data plane DMZ tier 1648, and a data plane data tier 1650. The data plane DMZ tier 1648 can include LB subnet(s) 1622 that can be communicatively coupled to the app subnet(s) 1626 of the data plane app tier 1646 and the Internet gateway 1634 of the data plane VCN 1618. The app subnet(s) 1626 can be communicatively coupled to the service gateway 1636 of the data plane VCN 1618 and the NAT gateway 1638 of the data plane VCN 1618. The data plane data tier 1650 can also include the DB subnet(s) 1630 that can be communicatively coupled to the app subnet(s) 1626 of the data plane app tier 1646.

The Internet gateway 1634 of the control plane VCN 1616 and of the data plane VCN 1618 can be communicatively coupled to a metadata management service 1652 that can be communicatively coupled to public Internet 1654. Public Internet 1654 can be communicatively coupled to the NAT gateway 1638 of the control plane VCN 1616 and of the data plane VCN 1618. The service gateway 1636 of the control plane VCN 1616 and of the data plane VCN 1618 can be communicatively coupled to cloud services 1656.

In some examples, the service gateway 1636 of the control plane VCN 1616 or of the data plane VCN 1618 can make application programming interface (API) calls to cloud services 1656 without going through public Internet 1654. The API calls to cloud services 1656 from the service gateway 1636 can be one-way: the service gateway 1636 can make API calls to cloud services 1656, and cloud services 1656 can send requested data to the service gateway 1636. But, cloud services 1656 may not initiate API calls to the service gateway 1636.

In some examples, the secure host tenancy 1604 can be directly connected to the service tenancy 1619, which may be otherwise isolated. The secure host subnet 1608 can communicate with the SSH subnet 1614 through an LPG 1610 that may enable two-way communication over an otherwise isolated system. Connecting the secure host subnet 1608 to the SSH subnet 1614 may give the secure host subnet 1608 access to other entities within the service tenancy 1619.

The control plane VCN 1616 may allow users of the service tenancy 1619 to set up or otherwise provision desired resources. Desired resources provisioned in the control plane VCN 1616 may be deployed or otherwise used in the data plane VCN 1618. In some examples, the control plane VCN 1616 can be isolated from the data plane VCN 1618, and the data plane mirror app tier 1640 of the control plane VCN 1616 can communicate with the data plane app tier 1646 of the data plane VCN 1618 via VNICs 1642 that can be contained in the data plane mirror app tier 1640 and the data plane app tier 1646.

In some examples, users of the system, or customers, can make requests, for example create, read, update, or delete (CRUD) operations, through public Internet 1654 that can communicate the requests to the metadata management service 1652. The metadata management service 1652 can communicate the request to the control plane VCN 1616 through the Internet gateway 1634. The request can be received by the LB subnet(s) 1622 contained in the control plane DMZ tier 1620. The LB subnet(s) 1622 may determine that the request is valid, and in response to this determination, the LB subnet(s) 1622 can transmit the request to app subnet(s) 1626 contained in the control plane app tier 1624. If the request is validated and requires a call to public Internet 1654, the call to public Internet 1654 may be transmitted to the NAT gateway 1638 that can make the call to public Internet 1654. Metadata that may be desired to be stored by the request can be stored in the DB subnet(s) 1630.

In some examples, the data plane mirror app tier 1640 can facilitate direct communication between the control plane VCN 1616 and the data plane VCN 1618. For example, changes, updates, or other suitable modifications to configuration may be desired to be applied to the resources contained in the data plane VCN 1618. Via a VNIC 1642, the control plane VCN 1616 can directly communicate with, and can thereby execute the changes, updates, or other suitable modifications to configuration to, resources contained in the data plane VCN 1618.

In some embodiments, the control plane VCN 1616 and the data plane VCN 1618 can be contained in the service tenancy 1619. In this case, the user, or the customer, of the system may not own or operate either the control plane VCN 1616 or the data plane VCN 1618. Instead, the IaaS provider may own or operate the control plane VCN 1616 and the data plane VCN 1618, both of which may be contained in the service tenancy 1619. This embodiment can enable isolation of networks that may prevent users or customers from interacting with other users', or other customers', resources. Also, this embodiment may allow users or customers of the system to store databases privately without needing to rely on public Internet 1654, which may not have a desired level of threat prevention, for storage.

In other embodiments, the LB subnet(s) 1622 contained in the control plane VCN 1616 can be configured to receive a signal from the service gateway 1636. In this embodiment, the control plane VCN 1616 and the data plane VCN 1618 may be configured to be called by a customer of the IaaS provider without calling public Internet 1654. Customers of the IaaS provider may desire this embodiment since database(s) that the customers use may be controlled by the IaaS provider and may be stored on the service tenancy 1619, which may be isolated from public Internet 1654.

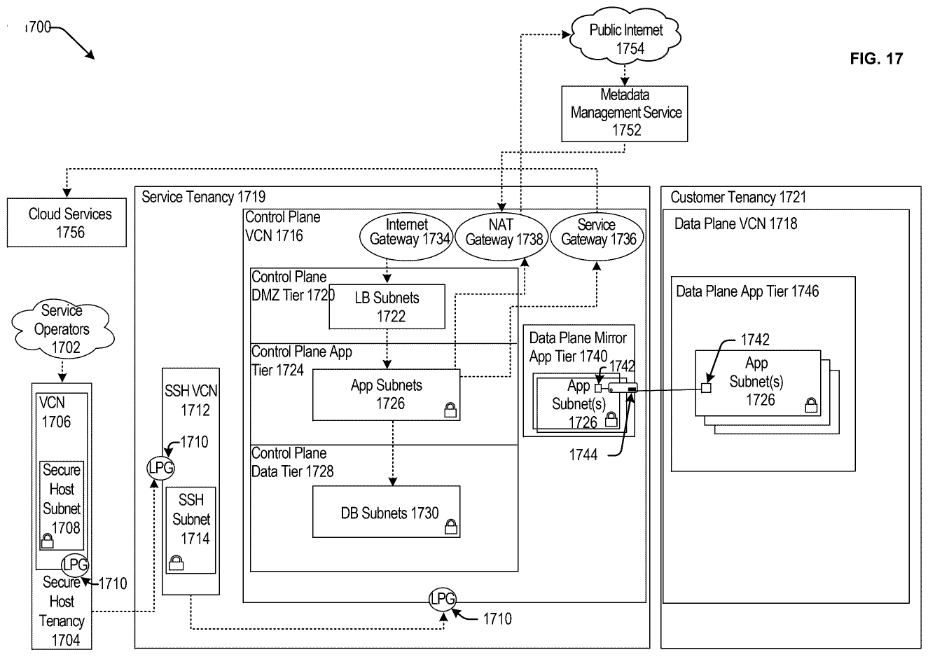

FIG. 17 is a block diagram 1700 illustrating another example pattern of an IaaS architecture, according to at least one embodiment. Service operators 1702 (e.g., service operators 1602 of FIG. 16) can be communicatively coupled to a secure host tenancy 1704 (e.g., the secure host tenancy 1604 of FIG. 16) that can include a virtual cloud network (VCN) 1706 (e.g., the VCN 1606 of FIG. 16) and a secure host subnet 1708 (e.g., the secure host subnet 1608 of FIG. 16). The VCN 1706 can include a local peering gateway (LPG) 1710 (e.g., the LPG 1610 of FIG. 16) that can be communicatively coupled to a secure shell (SSH) VCN 1712 (e.g., the SSH VCN 1612 of FIG. 16) via an LPG 1610 contained in the SSH VCN 1712. The SSH VCN 1712 can include an SSH subnet 1714 (e.g., the SSH subnet 1614 of FIG. 16), and the SSH VCN 1712 can be communicatively coupled to a control plane VCN 1716 (e.g., the control plane VCN 1616 of FIG. 16) via an LPG 1710 contained in the control plane VCN 1716. The control plane VCN 1716 can be contained in a service tenancy 1719 (e.g., the service tenancy 1619 of FIG. 16), and the data plane VCN 1718 (e.g., the data plane VCN 1618 of FIG. 16) can be contained in a customer tenancy 1721 that may be owned or operated by users, or customers, of the system.

The control plane VCN 1716 can include a control plane DMZ tier 1720 (e.g., the control plane DMZ tier 1620 of FIG. 16) that can include LB subnet(s) 1722 (e.g., LB subnet(s) 1622 of FIG. 16), a control plane app tier 1724 (e.g., the control plane app tier 1624 of FIG. 16) that can include app subnet(s) 1726 (e.g., app subnet(s) 1626 of FIG. 16), a control plane data tier 1728 (e.g., the control plane data tier 1628 of FIG. 16) that can include database (DB) subnet(s) 1730 (e.g., similar to DB subnet(s) 1630 of FIG. 16). The LB subnet(s) 1722 contained in the control plane DMZ tier 1720 can be communicatively coupled to the app subnet(s) 1726 contained in the control plane app tier 1724 and an Internet gateway 1734 (e.g., the Internet gateway 1634 of FIG. 16) that can be contained in the control plane VCN 1716, and the app subnet(s) 1726 can be communicatively coupled to the DB subnet(s) 1730 contained in the control plane data tier 1728 and a service gateway 1736 (e.g., the service gateway 1636 of FIG. 16) and a network address translation (NAT) gateway 1738 (e.g., the NAT gateway 1638 of FIG. 16). The control plane VCN 1716 can include the service gateway 1736 and the NAT gateway 1738.

The control plane VCN 1716 can include a data plane mirror app tier 1740 (e.g., the data plane mirror app tier 1640 of FIG. 16) that can include app subnet(s) 1726. The app subnet(s) 1726 contained in the data plane mirror app tier 1740 can include a virtual network interface controller (VNIC) 1742 (e.g., the VNIC of 1642) that can execute a compute instance 1744 (e.g., similar to the compute instance 1644 of FIG. 16). The compute instance 1744 can facilitate communication between the app subnet(s) 1726 of the data plane mirror app tier 1740 and the app subnet(s) 1726 that can be contained in a data plane app tier 1746 (e.g., the data plane app tier 1646 of FIG. 16) via the VNIC 1742 contained in the data plane mirror app tier 1740 and the VNIC 1742 contained in the data plane app tier 1746.

The Internet gateway 1734 contained in the control plane VCN 1716 can be communicatively coupled to a metadata management service 1752 (e.g., the metadata management service 1652 of FIG. 16) that can be communicatively coupled to public Internet 1754 (e.g., public Internet 1654 of FIG. 16). Public Internet 1754 can be communicatively coupled to the NAT gateway 1738 contained in the control plane VCN 1716. The service gateway 1736 contained in the control plane VCN 1716 can be communicatively coupled to cloud services 1756 (e.g., cloud services 1656 of FIG. 16).

In some examples, the data plane VCN 1718 can be contained in the customer tenancy 1721. In this case, the IaaS provider may provide the control plane VCN 1716 for each customer, and the IaaS provider may, for each customer, set up a unique compute instance 1744 that is contained in the service tenancy 1719. Each compute instance 1744 may allow communication between the control plane VCN 1716, contained in the service tenancy 1719, and the data plane VCN 1718 that is contained in the customer tenancy 1721. The compute instance 1744 may allow resources, that are provisioned in the control plane VCN 1716 that is contained in the service tenancy 1719, to be deployed or otherwise used in the data plane VCN 1718 that is contained in the customer tenancy 1721.

In other examples, the customer of the IaaS provider may have databases that live in the customer tenancy 1721. In this example, the control plane VCN 1716 can include the data plane mirror app tier 1740 that can include app subnet(s) 1726. The data plane mirror app tier 1740 can reside in the data plane VCN 1718, but the data plane mirror app tier 1740 may not live in the data plane VCN 1718. That is, the data plane mirror app tier 1740 may have access to the customer tenancy 1721, but the data plane mirror app tier 1740 may not exist in the data plane VCN 1718 or be owned or operated by the customer of the IaaS provider. The data plane mirror app tier 1740 may be configured to make calls to the data plane VCN 1718 but may not be configured to make calls to any entity contained in the control plane VCN 1716. The customer may desire to deploy or otherwise use resources in the data plane VCN 1718 that are provisioned in the control plane VCN 1716, and the data plane mirror app tier 1740 can facilitate the desired deployment, or other usage of resources, of the customer.

In some embodiments, the customer of the IaaS provider can apply filters to the data plane VCN 1718. In this embodiment, the customer can determine what the data plane VCN 1718 can access, and the customer may restrict access to public Internet 1754 from the data plane VCN 1718. The IaaS provider may not be able to apply filters or otherwise control access of the data plane VCN 1718 to any outside networks or databases. Applying filters and controls by the customer onto the data plane VCN 1718, contained in the customer tenancy 1721, can help isolate the data plane VCN 1718 from other customers and from public Internet 1754.

In some embodiments, cloud services 1756 can be called by the service gateway 1736 to access services that may not exist on public Internet 1754, on the control plane VCN 1716, or on the data plane VCN 1718. The connection between cloud services 1756 and the control plane VCN 1716 or the data plane VCN 1718 may not be live or continuous. Cloud services 1756 may exist on a different network owned or operated by the IaaS provider. Cloud services 1756 may be configured to receive calls from the service gateway 1736 and may be configured to not receive calls from public Internet 1754. Some cloud services 1756 may be isolated from other cloud services 1756, and the control plane VCN 1716 may be isolated from cloud services 1756 that may not be in the same region as the control plane VCN 1716. For example, the control plane VCN 1716 may be located in “Region 1,” and cloud service “Deployment 16,” may be located in Region 1 and in “Region 2.” If a call to Deployment 16 is made by the service gateway 1736 contained in the control plane VCN 1716 located in Region 1, the call may be transmitted to Deployment 16 in Region 1. In this example, the control plane VCN 1716, or Deployment 16 in Region 1, may not be communicatively coupled to, or otherwise in communication with, Deployment 16 in Region 2.

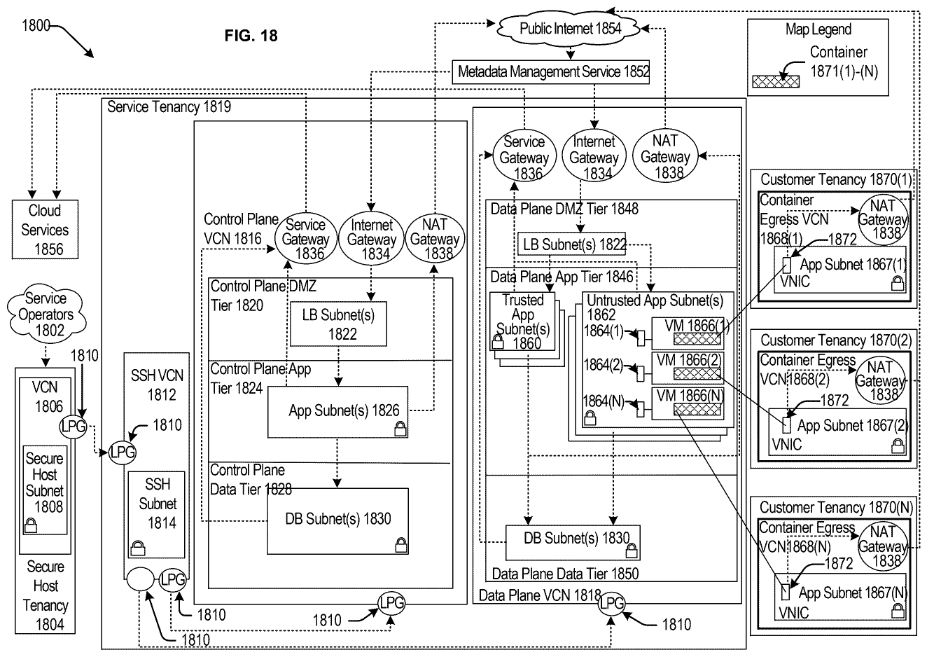

FIG. 18 is a block diagram 1800 illustrating another example pattern of an IaaS architecture, according to at least one embodiment. Service operators 1802 (e.g., service operators 1602 of FIG. 16) can be communicatively coupled to a secure host tenancy 1804 (e.g., the secure host tenancy 1604 of FIG. 16) that can include a virtual cloud network (VCN) 1806 (e.g., the VCN 1606 of FIG. 16) and a secure host subnet 1808 (e.g., the secure host subnet 1608 of FIG. 16). The VCN 1806 can include an LPG 1810 (e.g., the LPG 1610 of FIG. 16) that can be communicatively coupled to an SSH VCN 1812 (e.g., the SSH VCN 1612 of FIG. 16) via an LPG 1810 contained in the SSH VCN 1812. The SSH VCN 1812 can include an SSH subnet 1814 (e.g., the SSH subnet 1614 of FIG. 16), and the SSH VCN 1812 can be communicatively coupled to a control plane VCN 1816 (e.g., the control plane VCN 1616 of FIG. 16) via an LPG 1810 contained in the control plane VCN 1816 and to a data plane VCN 1818 (e.g., the data plane 1618 of FIG. 16) via an LPG 1810 contained in the data plane VCN 1818. The control plane VCN 1816 and the data plane VCN 1818 can be contained in a service tenancy 1819 (e.g., the service tenancy 1619 of FIG. 16).

The control plane VCN 1816 can include a control plane DMZ tier 1820 (e.g., the control plane DMZ tier 1620 of FIG. 16) that can include load balancer (LB) subnet(s) 1822 (e.g., LB subnet(s) 1622 of FIG. 16), a control plane app tier 1824 (e.g., the control plane app tier 1624 of FIG. 16) that can include app subnet(s) 1826 (e.g., similar to app subnet(s) 1626 of FIG. 16), a control plane data tier 1828 (e.g., the control plane data tier 1628 of FIG. 16) that can include DB subnet(s) 1830. The LB subnet(s) 1822 contained in the control plane DMZ tier 1820 can be communicatively coupled to the app subnet(s) 1826 contained in the control plane app tier 1824 and to an Internet gateway 1834 (e.g., the Internet gateway 1634 of FIG. 16) that can be contained in the control plane VCN 1816, and the app subnet(s) 1826 can be communicatively coupled to the DB subnet(s) 1830 contained in the control plane data tier 1828 and to a service gateway 1836 (e.g., the service gateway of FIG. 16) and a network address translation (NAT) gateway 1838 (e.g., the NAT gateway 1638 of FIG. 16). The control plane VCN 1816 can include the service gateway 1836 and the NAT gateway 1838.

The data plane VCN 1818 can include a data plane app tier 1846 (e.g., the data plane app tier 1646 of FIG. 16), a data plane DMZ tier 1848 (e.g., the data plane DMZ tier 1648 of FIG. 16), and a data plane data tier 1850 (e.g., the data plane data tier 1650 of FIG. 16). The data plane DMZ tier 1848 can include LB subnet(s) 1822 that can be communicatively coupled to trusted app subnet(s) 1860 and untrusted app subnet(s) 1862 of the data plane app tier 1846 and the Internet gateway 1834 contained in the data plane VCN 1818. The trusted app subnet(s) 1860 can be communicatively coupled to the service gateway 1836 contained in the data plane VCN 1818, the NAT gateway 1838 contained in the data plane VCN 1818, and DB subnet(s) 1830 contained in the data plane data tier 1850. The untrusted app subnet(s) 1862 can be communicatively coupled to the service gateway 1836 contained in the data plane VCN 1818 and DB subnet(s) 1830 contained in the data plane data tier 1850. The data plane data tier 1850 can include DB subnet(s) 1830 that can be communicatively coupled to the service gateway 1836 contained in the data plane VCN 1818.

The untrusted app subnet(s) 1862 can include one or more primary VNICs 1864(1)-(N) that can be communicatively coupled to tenant virtual machines (VMs) 1866(1)-(N). Each tenant VM 1866(1)-(N) can be communicatively coupled to a respective app subnet 1867(1)-(N) that can be contained in respective container egress VCNs 1868(1)-(N) that can be contained in respective customer tenancies 1870(1)-(N). Respective secondary VNICs 1872(1)-(N) can facilitate communication between the untrusted app subnet(s) 1862 contained in the data plane VCN 1818 and the app subnet contained in the container egress VCNs 1868(1)-(N). Each container egress VCNs 1868(1)-(N) can include a NAT gateway 1838 that can be communicatively coupled to public Internet 1854 (e.g., public Internet 1654 of FIG. 16).

The Internet gateway 1834 contained in the control plane VCN 1816 and contained in the data plane VCN 1818 can be communicatively coupled to a metadata management service 1852 (e.g., the metadata management system 1652 of FIG. 16) that can be communicatively coupled to public Internet 1854. Public Internet 1854 can be communicatively coupled to the NAT gateway 1838 contained in the control plane VCN 1816 and contained in the data plane VCN 1818. The service gateway 1836 contained in the control plane VCN 1816 and contained in the data plane VCN 1818 can be communicatively coupled to cloud services 1856.

In some embodiments, the data plane VCN 1818 can be integrated with customer tenancies 1870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1846. Code to run the function may be executed in the VMs 1866(1)-(N), and the code may not be configured to run anywhere else on the data plane VCN 1818. Each VM 1866(1)-(N) may be connected to one customer tenancy 1870. Respective containers 1871(1)-(N) contained in the VMs 1866(1)-(N) may be configured to run the code. In this case, there can be a dual isolation (e.g., the containers 1871(1)-(N) running code, where the containers 1871(1)-(N) may be contained in at least the VM 1866(1)-(N) that are contained in the untrusted app subnet(s) 1862), which may help prevent incorrect or otherwise undesirable code from damaging the network of the IaaS provider or from damaging a network of a different customer. The containers 1871(1)-(N) may be communicatively coupled to the customer tenancy 1870 and may be configured to transmit or receive data from the customer tenancy 1870. The containers 1871(1)-(N) may not be configured to transmit or receive data from any other entity in the data plane VCN 1818. Upon completion of running the code, the IaaS provider may kill or otherwise dispose of the containers 1871(1)-(N).

In some embodiments, the trusted app subnet(s) 1860 may run code that may be owned or operated by the IaaS provider. In this embodiment, the trusted app subnet(s) 1860 may be communicatively coupled to the DB subnet(s) 1830 and be configured to execute CRUD operations in the DB subnet(s) 1830. The untrusted app subnet(s) 1862 may be communicatively coupled to the DB subnet(s) 1830, but in this embodiment, the untrusted app subnet(s) may be configured to execute read operations in the DB subnet(s) 1830. The containers 1871(1)-(N) that can be contained in the VM 1866(1)-(N) of each customer and that may run code from the customer may not be communicatively coupled with the DB subnet(s) 1830.

In other embodiments, the control plane VCN 1816 and the data plane VCN 1818 may not be directly communicatively coupled. In this embodiment, there may be no direct communication between the control plane VCN 1816 and the data plane VCN 1818. However, communication can occur indirectly through at least one method. An LPG 1810 may be established by the IaaS provider that can facilitate communication between the control plane VCN 1816 and the data plane VCN 1818. In another example, the control plane VCN 1816 or the data plane VCN 1818 can make a call to cloud services 1856 via the service gateway 1836. For example, a call to cloud services 1856 from the control plane VCN 1816 can include a request for a service that can communicate with the data plane VCN 1818.

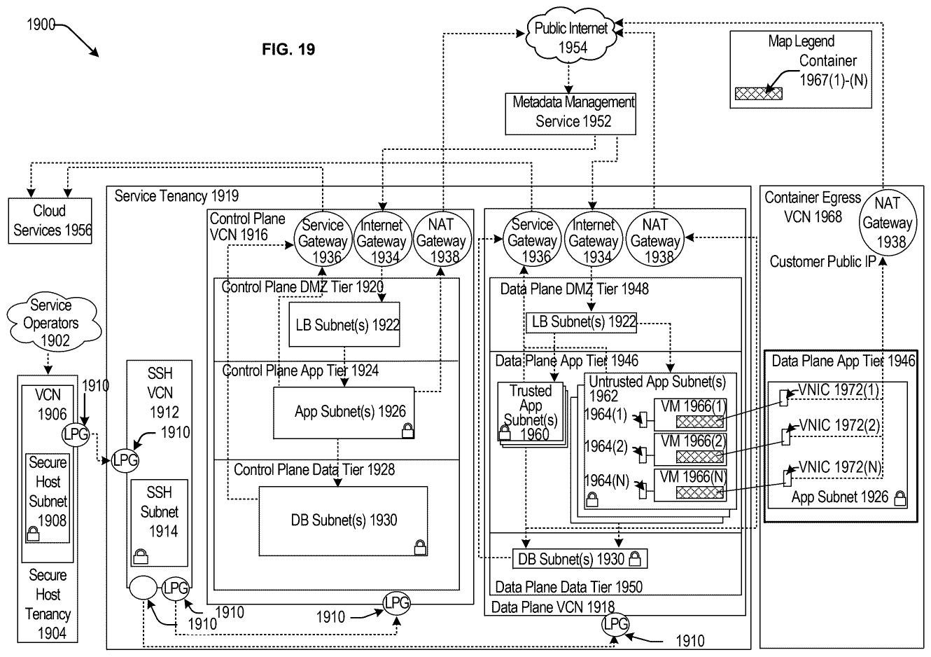

FIG. 19 is a block diagram 1900 illustrating another example pattern of an IaaS architecture, according to at least one embodiment. Service operators 1902 (e.g., service operators 1602 of FIG. 16) can be communicatively coupled to a secure host tenancy 1904 (e.g., the secure host tenancy 1604 of FIG. 16) that can include a virtual cloud network (VCN) 1906 (e.g., the VCN 1606 of FIG. 16) and a secure host subnet 1908 (e.g., the secure host subnet 1608 of FIG. 16). The VCN 1906 can include an LPG 1910 (e.g., the LPG 1610 of FIG. 16) that can be communicatively coupled to an SSH VCN 1912 (e.g., the SSH VCN 1612 of FIG. 16) via an LPG 1910 contained in the SSH VCN 1912. The SSH VCN 1912 can include an SSH subnet 1914 (e.g., the SSH subnet 1614 of FIG. 16), and the SSH VCN 1912 can be communicatively coupled to a control plane VCN 1916 (e.g., the control plane VCN 1616 of FIG. 16) via an LPG 1910 contained in the control plane VCN 1916 and to a data plane VCN 1918 (e.g., the data plane 1618 of FIG. 16) via an LPG 1910 contained in the data plane VCN 1918. The control plane VCN 1916 and the data plane VCN 1918 can be contained in a service tenancy 1919 (e.g., the service tenancy 1619 of FIG. 16).

The control plane VCN 1916 can include a control plane DMZ tier 1920 (e.g., the control plane DMZ tier 1620 of FIG. 16) that can include LB subnet(s) 1922 (e.g., LB subnet(s) 1622 of FIG. 16), a control plane app tier 1924 (e.g., the control plane app tier 1624 of FIG. 16) that can include app subnet(s) 1926 (e.g., app subnet(s) 1626 of FIG. 16), a control plane data tier 1928 (e.g., the control plane data tier 1628 of FIG. 16) that can include DB subnet(s) 1930 (e.g., DB subnet(s) 1830 of FIG. 18). The LB subnet(s) 1922 contained in the control plane DMZ tier 1920 can be communicatively coupled to the app subnet(s) 1926 contained in the control plane app tier 1924 and to an Internet gateway 1934 (e.g., the Internet gateway 1634 of FIG. 16) that can be contained in the control plane VCN 1916, and the app subnet(s) 1926 can be communicatively coupled to the DB subnet(s) 1930 contained in the control plane data tier 1928 and to a service gateway 1936 (e.g., the service gateway of FIG. 16) and a network address translation (NAT) gateway 1938 (e.g., the NAT gateway 1638 of FIG. 16). The control plane VCN 1916 can include the service gateway 1936 and the NAT gateway 1938.

The data plane VCN 1918 can include a data plane app tier 1946 (e.g., the data plane app tier 1646 of FIG. 16), a data plane DMZ tier 1948 (e.g., the data plane DMZ tier 1648 of FIG. 16), and a data plane data tier 1950 (e.g., the data plane data tier 1650 of FIG. 16). The data plane DMZ tier 1948 can include LB subnet(s) 1922 that can be communicatively coupled to trusted app subnet(s) 1960 (e.g., trusted app subnet(s) 1860 of FIG. 18) and untrusted app subnet(s) 1962 (e.g., untrusted app subnet(s) 1862 of FIG. 18) of the data plane app tier 1946 and the Internet gateway 1934 contained in the data plane VCN 1918. The trusted app subnet(s) 1960 can be communicatively coupled to the service gateway 1936 contained in the data plane VCN 1918, the NAT gateway 1938 contained in the data plane VCN 1918, and DB subnet(s) 1930 contained in the data plane data tier 1950. The untrusted app subnet(s) 1962 can be communicatively coupled to the service gateway 1936 contained in the data plane VCN 1918 and DB subnet(s) 1930 contained in the data plane data tier 1950. The data plane data tier 1950 can include DB subnet(s) 1930 that can be communicatively coupled to the service gateway 1936 contained in the data plane VCN 1918.

The untrusted app subnet(s) 1962 can include primary VNICs 1964(1)-(N) that can be communicatively coupled to tenant virtual machines (VMs) 1966(1)-(N) residing within the untrusted app subnet(s) 1962. Each tenant VM 1966(1)-(N) can run code in a respective container 1967(1)-(N), and be communicatively coupled to an app subnet 1926 that can be contained in a data plane app tier 1946 that can be contained in a container egress VCN 1968. Respective secondary VNICs 1972(1)-(N) can facilitate communication between the untrusted app subnet(s) 1962 contained in the data plane VCN 1918 and the app subnet contained in the container egress VCN 1968. The container egress VCN can include a NAT gateway 1938 that can be communicatively coupled to public Internet 1954 (e.g., public Internet 1654 of FIG. 16).

The Internet gateway 1934 contained in the control plane VCN 1916 and contained in the data plane VCN 1918 can be communicatively coupled to a metadata management service 1952 (e.g., the metadata management system 1652 of FIG. 16) that can be communicatively coupled to public Internet 1954. Public Internet 1954 can be communicatively coupled to the NAT gateway 1938 contained in the control plane VCN 1916 and contained in the data plane VCN 1918. The service gateway 1936 contained in the control plane VCN 1916 and contained in the data plane VCN 1918 can be communicatively coupled to cloud services 1956.

In some examples, the pattern illustrated by the architecture of block diagram 1900 of FIG. 19 may be considered an exception to the pattern illustrated by the architecture of block diagram 1800 of FIG. 18 and may be desirable for a customer of the IaaS provider if the IaaS provider cannot directly communicate with the customer (e.g., a disconnected region). The respective containers 1967(1)-(N) that are contained in the VMs 1966(1)-(N) for each customer can be accessed in real-time by the customer. The containers 1967(1)-(N) may be configured to make calls to respective secondary VNICs 1972(1)-(N) contained in app subnet(s) 1926 of the data plane app tier 1946 that can be contained in the container egress VCN 1968. The secondary VNICs 1972(1)-(N) can transmit the calls to the NAT gateway 1938 that may transmit the calls to public Internet 1954. In this example, the containers 1967(1)-(N) that can be accessed in real-time by the customer can be isolated from the control plane VCN 1916 and can be isolated from other entities contained in the data plane VCN 1918. The containers 1967(1)-(N) may also be isolated from resources from other customers.

In other examples, the customer can use the containers 1967(1)-(N) to call cloud services 1956. In this example, the customer may run code in the containers 1967(1)-(N) that requests a service from cloud services 1956. The containers 1967(1)-(N) can transmit this request to the secondary VNICs 1972(1)-(N) that can transmit the request to the NAT gateway that can transmit the request to public Internet 1954. Public Internet 1954 can transmit the request to LB subnet(s) 1922 contained in the control plane VCN 1916 via the Internet gateway 1934. In response to determining the request is valid, the LB subnet(s) can transmit the request to app subnet(s) 1926 that can transmit the request to cloud services 1956 via the service gateway 1936.

It should be appreciated that IaaS architectures 1600, 1700, 1800, 1900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

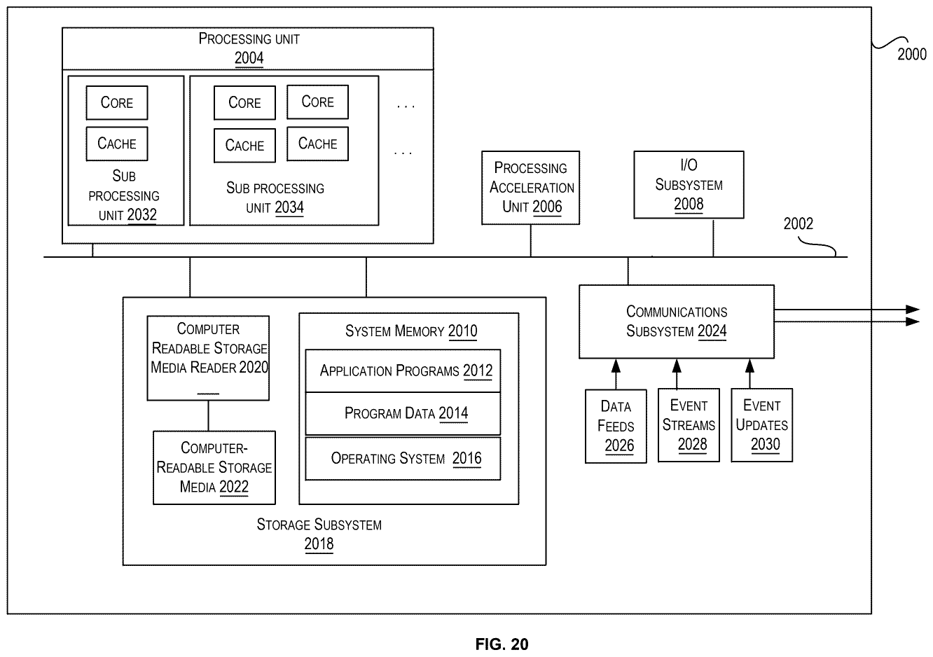

FIG. 20 illustrates an example computer system 2000, in which various embodiments may be implemented. The system 2000 may be used to implement any of the computer systems described above. As shown in the figure, computer system 2000 includes a processing unit 2004 that communicates with a number of peripheral subsystems via a bus subsystem 2002. These peripheral subsystems may include a processing acceleration unit 2006, an I/O subsystem 2008, a storage subsystem 2018 and a communications subsystem 2024. Storage subsystem 2018 includes tangible computer-readable storage media 2022 and a system memory 2010.

Bus subsystem 2002 provides a mechanism for letting the various components and subsystems of computer system 2000 communicate with each other as intended. Although bus subsystem 2002 is shown schematically as a single bus, alternative embodiments of the bus subsystem may utilize multiple buses. Bus subsystem 2002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 2004, which can be implemented as one or more integrated circuits (e.g., a conventional microprocessor or microcontroller), controls the operation of computer system 2000. One or more processors may be included in processing unit 2004. These processors may include single core or multicore processors. In certain embodiments, processing unit 2004 may be implemented as one or more independent processing units 2032 and/or 2034 with single or multicore processors included in each processing unit. In other embodiments, processing unit 2004 may also be implemented as a quad-core processing unit formed by integrating two dual-core processors into a single chip.

In various embodiments, processing unit 2004 can execute a variety of programs in response to program code and can maintain multiple concurrently executing programs or processes. At any given time, some or all of the program code to be executed can be resident in processor(s) 2004 and/or in storage subsystem 2018. Through suitable programming, processor(s) 2004 can provide various functionalities described above. Computer system 2000 may additionally include a processing acceleration unit 2006, which can include a digital signal processor (DSP), a special-purpose processor, and/or the like.

I/O subsystem 2008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 2000 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 2000 may comprise a storage subsystem 2018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 2004 provide the functionality described above. Storage subsystem 2018 may also provide a repository for storing data used in accordance with the present disclosure.

As depicted in the example in FIG. 20, storage subsystem 2018 can include various components including a system memory 2010, computer-readable storage media 2022, and a computer readable storage media reader 2020. System memory 2010 may store program instructions that are loadable and executable by processing unit 2004. System memory 2010 may also store data that is used during the execution of the instructions and/or data that is generated during the execution of the program instructions. Various different kinds of programs may be loaded into system memory 2010 including but not limited to client applications, Web browsers, mid-tier applications, relational database management systems (RDBMS), virtual machines, containers, etc.

System memory 2010 may also store an operating system 2016. Examples of operating system 2016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 2000 executes one or more virtual machines, the virtual machines along with their guest operating systems (GOSs) may be loaded into system memory 2010 and executed by one or more processors or cores of processing unit 2004.

System memory 2010 can come in different configurations depending upon the type of computer system 2000. For example, system memory 2010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 2010 may include a basic input/output system (BIOS) containing basic routines that help to transfer information between elements within computer system 2000, such as during start-up.

Computer-readable storage media 2022 may represent remote, local, fixed, and/or removable storage devices plus storage media for temporarily and/or more permanently containing, storing, computer-readable information for use by computer system 2000 including instructions executable by processing unit 2004 of computer system 2000.

Computer-readable storage media 2022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 2022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 2022 may include, but is not limited to, Zip® drives, flash memory cards, universal serial bus (USB) flash drives, secure digital (SD) cards, DVD disks, digital video tape, and the like. Computer-readable storage media 2022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 2000.

Machine-readable instructions executable by one or more processors or cores of processing unit 2004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 2024 provides an interface to other computer systems and networks. Communications subsystem 2024 serves as an interface for receiving data from and transmitting data to other systems from computer system 2000. For example, communications subsystem 2024 may enable computer system 2000 to connect to one or more devices via the Internet. In some embodiments communications subsystem 2024 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 2024 can provide wired network connectivity (e.g., Ethernet) in addition to or instead of a wireless interface.

In some embodiments, communications subsystem 2024 may also receive input communication in the form of structured and/or unstructured data feeds 2026, event streams 2028, event updates 2030, and the like on behalf of one or more users who may use computer system 2000.

By way of example, communications subsystem 2024 may be configured to receive data feeds 2026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 2024 may also be configured to receive data in the form of continuous data streams, which may include event streams 2028 of real-time events and/or event updates 2030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2024 may also be configured to output the structured and/or unstructured data feeds 2026, event streams 2028, event updates 2030, and the like to one or more databases that may be in communication with one or more streaming data source computers coupled to computer system 2000.

Computer system 2000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 2000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Exponential increase in compute demand requires larger fabrics in order to interconnect the host machines (e.g. including GPUs, CPUs, or other computing devices) within each compute cluster of the datacenter. For workloads that are executed on such fabrics (e.g., high-performance compute workloads, AI workloads, etc.,), communication between all host machines in the fabric is typically required to ensure successful workload execution. Executing AI/ML workloads on an RDMA (Remote Direct Memory Access) network clusters offers significant performance improvements, especially from the point of view of distributed deep learning and large-scale inference tasks. RDMA enables direct memory access between nodes without involving the CPU. This provides significant advantages such as low latency, high throughput, lower CPU overhead, and better scalability for distributed training. These features are particularly beneficial when training large models across multiple HOST MACHINEs/nodes. In some cases, it may be desired to have non-blocking communication, deterministic connectivity, and high aggregate bandwidth to facilitate distributed training and inference workloads. However, existing cabling and network architectures encounter significant challenges in scaling, especially when attempting to distribute high-speed interfaces, such as 800G, across multiple network tiers and planes. Traditional solutions may introduce complexity, insertion loss, and operational inefficiencies that impede the reliable expansion and maintenance of large-scale, multi-plane network fabrics.

According to some embodiments, a two tier CLOS network scales as: N²/2, where Nis the radix of a switch. The radix of a switch refers to the number of ports (or connections) a switch can handle simultaneously. Stated in another way, the radix of a switch corresponds to the number of distinct ports available for data transmission within a switch. Thus, for N=64 ports, where each port operates at a specified speed (e.g., 400G, 800G), the maximum scalability (i.e., max GPU/Host scalability at two-tiers) of an architecture is: N²/2 or 64²/2 or 2,048 attached Host-NICs (or GPU-NICs). For AI/ML applications it is beneficial to have as many GPUs as possible in the network fabric. In a non-blocking network fabric, all GPUs may communicate with one another at full line rate. Thus, scalability is a very important characteristic of such network fabrics. The present disclosure can achieve such scalability as discussed herein, for example, using shuffle cables and dividing a host machine NIC into multiple sub-interfaces to increase the radix of a switch.

To address some scaling related challenges with modern datacenters, the present disclosure provides a shuffle cable assembly that is designed to facilitate the deterministic division of a single high-speed interface or ports (e.g., 400G, 800G), into a set of distinct sub-interfaces (e.g., 100G, 200G). In at least some embodiments, the internal routing may include a crossing or X-shaped pattern to ensure deterministic mapping of sub-interface channels across the cable's endpoints. Each sub-interface (e.g., 100G, 200G) may be realized as a bidirectional channel, supporting full-duplex communication and enabling direct mapping between the split portions of the original interface (e.g., 400G, 800G) and the respective network elements to which they are assigned.

The shuffle cable assembly provides several improvements over prior approaches. For example, by enabling the physical and logical splitting of an interface (e.g., 400G, 800G) into sub-interfaces (e.g., four 100G or four 200G), the shuffle cable assembly herein facilitates higher effective switch radix and network scalability within two-tier or multi-plane data center fabrics. An order-preserving internal mapping of the shuffle cable supports predictable and reliable connectivity, simplifying both installation and validation procedures. The cable-based approach, as opposed to cassette-based or patch-panel solutions, reduces the total number of connector interfaces and associated insertion loss, thereby improving overall signal integrity and system reliability. Furthermore, the shuffle cable's specified structure allows for rapid, error-resistant deployment in high-density environments, supporting the operational advantages of large-scale host machine clusters and high-bandwidth, low-latency network infrastructures.

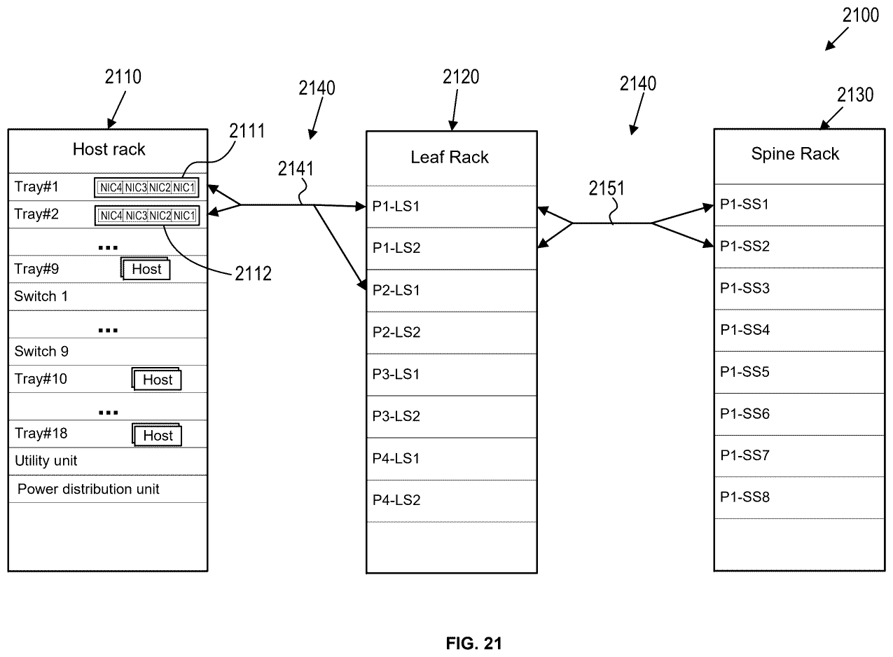

It is to be noted that the specific numbers related to line rate, number of switches in the two-tiers, etc., as used with reference to FIGS. 21-28 are for explanatory purposes only and are not intended to limit the scope of the present disclosure. Rather, the breakout and shuffle cable mechanism discussed herein is equally applicable to network fabrics of all sizes and ports operating at different line rates (e.g., 800G), where a single channel of 800G may be split into 2×400G channels, 4×200G channels, or 8×100G channels.

FIG. 21 illustrates an overview of an example cable assembly 2140 of a network system 2100, according to various embodiments. For example, the cable assembly 2140 can include a first shuffle cable 2141, and a second shuffle cable 2151. The cable assembly 2140 establishes network connections between a compute node, leaf switches, and spine switches using the shuffle cables 2141, 2151. The network 2100 can be implemented within each of the datahalls of a datacenter. For example, a datahall (e.g., a, b) can include a plurality of host machine racks 2110, a plurality of leaf racks 2120 (i.e., T0-tier), and a plurality of spine racks 2130 (i.e., T1-tier) configured to implement the network 2100 to establish redundancies and scalability between different datahalls. The network 2100 enables one or more host machines to be connected with multiple other host machines using the shuffle cables 2141, 2151, T0-tier switches, and T1-tier switches.

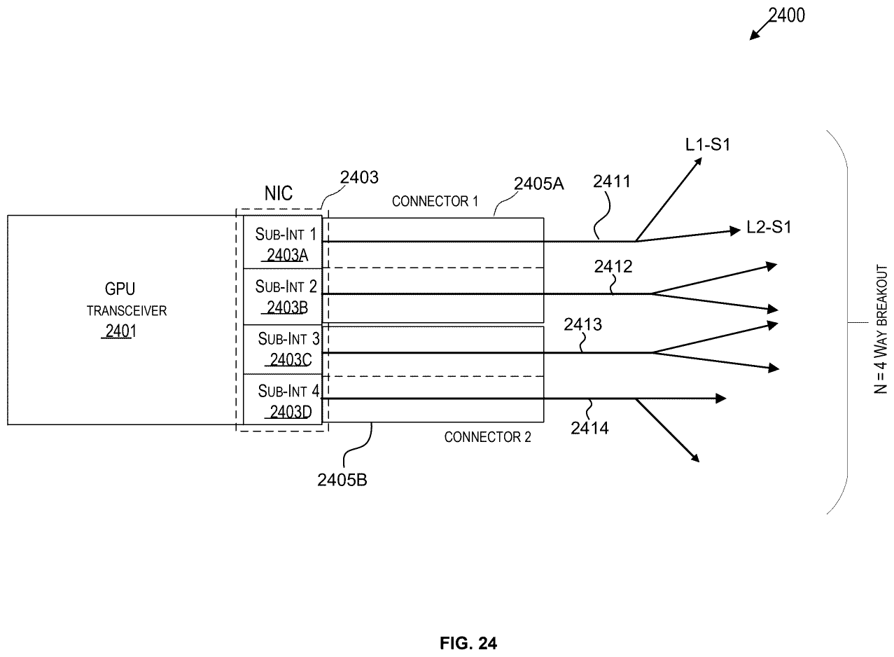

It is appreciated that each host machine (e.g., in a tray of the host machine rack) includes one or more host machines, where each host machine is associated with one or more network interface card (NIC), as shown in FIG. 21 for example. For sake of illustration, one or more NICs can be associated with a particular host machine included in the host machine (e.g., tray 1) is depicted in FIG. 21. According to some embodiments of the present disclosure, scalability is achieved in the network fabric of a datacenter system (e.g., 2100 in FIG. 21) as follows: —considering for example, a NIC attached to a particular host machine (e.g., first gpu) included in the host machine (e.g., tray 1), the interface of NIC is partitioned into a plurality of sub-interfaces. Example partitioning of the NIC is further discussed in detail with respect to FIG. 24. Each sub-interface in the plurality of sub-interfaces of NIC is addressable via a corresponding network address (e.g., unique IP address).

Each of the sub-interfaces of the partitioned interface of NIC is communicatively coupled to a different switch in the T0-tier of switches. This is achieved via the NIC incorporating a breakout cable or a shuffle cable. The shuffle cable is connected at one end to the interface of the NIC and at the other end to different T0-tier switches. For instance, the interface of NIC is partitioned into four parts (e.g., a 1:4 partition shown in FIG. 24). Each partition (i.e., sub-interface of NIC) is coupled to different T0-tier switches using shuffle cables. For example, a first partition NIC1 of the NIC is coupled to two leaf switches P1-LS1 and P2-LS1 within a leaf rack using the shuffle cable 2141. In doing so, the interface of the NIC operating at a certain line rate (e.g., 400G) is partitioned into four sub-interfaces, each of which operates at a reduced line rate e.g., 100G (i.e., four communication channels operating at 100G each). Thus, by some embodiments, by implementing breakouts at the NIC level in the network fabric in FIG. 21, a higher switch radix is achieved. Additionally, by some embodiments, it is noted that the shuffle functionality can also be applied to between switches at the T0-tier and T1-tier. Specifically, each upstream port of the switch can be partitioned into sub-ports, where each sub-port is connected to a different T1-tier switch. It is noted that in doing so, one results in utilizing more switches at the T1-tier layer e.g., 128 T1-tier switches as compared to the 32 T1-tier switches without sub-interfaces.

In some embodiments, breakout may refer to cabling for going from many lanes/fibers per connector on one side to fewer lanes/fibers but more connectors on the opposite end. For 2×2 MPO shuffles (e.g., including 8×8 bundles), connector count and fibers per each connector can be constant, and they can be rearranged within the shuffle cable. When Miniature Multi-fiber Connector (MMC) is combined with 2×MPO shuffling, such cabling can be considered a combination of a breakout and shuffle.

Thus, from a scalability perspective, it can be seen that assuming 64, 400G-port switches, where each NIC is split or partitioned into four sub-interfaces, one can obtain 4, 100G ports. Thus, the maximum GPU/Host scale at two-tiers is: N²/2 or 256²/2 (i.e., where 256 is obtained as 64×4) resulting in 32,768 100G ports or 8,192 400G-attached Host-NICs (or GPU-NICs). As such, an increase in the maximum number of hosts from e.g., 2048 to e.g., 8192 can be obtained using the sub-interfaces. It is appreciated that in the network fabric configuration of FIG. 21, a greater number of switches in each tier can be used thereby achieving a 4× increase in scale compared to a fabric configuration with GPUs having NICs without sub-interfaces and shuffle cables. It is also noted that the switches are inexpensive and thus the gains provided by the network fabric configuration of FIG. 21 provides a larger fabric size to support large sized clusters that enable better training in MI/AI applications.

In some embodiments, a host machine rack 2110 can include a plurality of host machines (e.g., 2111-2118, only few are labelled for illustration purpose). each host machine can include a NIC, which can be subdivided into four sub-interfaces NIC1-NIC4. For example, the host machine 2111 has sub-interfaces NIC1-NIC4, and the host machine 2112 has sub-interfaces NIC1-NIC4. The sub-interfaces NIC1-NIC4 enable one host machine 2111 can be connected to four other host machines. The NIC can be a high-speed interface or ports (e.g., 400G, 800G) that can be divided into the sub-interfaces NIC1-NIC4, each providing a speed of e.g., 100G, 200G. This configuration enables each NIC interface (e.g., 400G, 800G) to be physically and logically split into four separate channels (e.g., 100G, 200G). Each channel can then be routed to different network elements, such as switches or network interface cards, in a manner that preserves a specified network topology and operational characteristics. The host machine rack 2110 may also include additional components such as network switches, power distribution unit or other server related components. In some embodiments, connected host machines can be within the same datahall or in different datahalls.

In some embodiments, a leaf rack 2120 can include a plurality of leaf switches (e.g., P1-LS1 through P4-LS2) distributed among a plurality of planes. For example, the leaf rack 2120 can include four planes (denoted by P1-P4), each plane comprising two leaf switches. Accordingly, the leaf rack 2120 can include the plurality of switches P1-LS1, P1-LS2, P2-LS1, P2-LS2, P3-LS1, P3-LS2, P4-LS1, and P4-LS2. In some embodiments, the leaf rack 2120 can be a vertical cabinet housing the plurality of switches P1-LS1 through P4-LS2 distributed among different planes (P1, P2, P3, P4). Each leaf switch P1-LS1 through P4-LS2 can have multiple ports. For example, each leaf switch may have 32 ports, 64 ports shown FIG. 21, 128 ports, or other number of ports. It can be understood that other plane configurations and number of switches are possible in the leaf rack 2120 without limiting the scope of the present disclosure.

In some embodiments, a spine rack 2130 can include a plurality of spine switches (e.g., P1-SS1 through P1-SS8). In the illustrated embodiment, each spine rack 2130 can be considered as a single plane. For example, the spine rack 2130 can be a first spine plane assigned with eight spine switches P1-SS1 through P1-SS8. In some embodiments, the spine rack 2130 can be a vertical cabinet housing the plurality of switches P1-SS1 through P1-SS8 distributed among the first planes (P1). Each spine switch may have 32 ports, 64 ports shown FIG. 21, 128 ports, or other number of ports. It can be understood that other plane configurations and number of switches are possible in the spine rack 2130 without limiting the scope of the present disclosure.

In the various embodiments, a shuffle cable (e.g., 2141, 2151) can include at least two connectors at one end, and at least two connectors at an opposite end. This way, the shuffle cable can establish connection between two host machines and two switches using a single cable, or between two T0-tier switches and two T1-tier switches using a single shuffle cable. For example, as shown in FIG. 21, one end of the first shuffle cable 2141 can be connected to NIC1 of the first host machine 2111, and NIC1 of the second host machine 2112, and opposite end can be connected to a first leaf switch P1-LS1, and a second leaf switch P2-LS2. In this example, the two host machines 2111, 2112 are connected to two different planes within the leaf rack 2120. Similarly, the shuffle cable 2151 can establish connections between two leaf switches P1-LS1, P1-LS2 with two spine switches P1-SS1, P1-SS2, all of which may be distributed within one plane P1. A plane may refer to grouping of switches forming a network fabric plane. In the illustrated embodiments, 8 leaf switches can be distributed among 4 fabric planes, and 8 spine switches can be distributed within a single plane. This is only one example, and other number of switch distributions or fabric plane configurations are possible. Similarly, shuffle cables can be used to establish network connections among other similar devices depending on the network configuration.

FIG. 24 depicts a schematic 2400 illustrating partioning an interface of a network interface card (NIC) into a plurality of sub-interfaces, according to various embodiments. A host machine transceiver 2401 includes a network interface 2403 i.e., an interface of a NIC that is coupled with a host machine. For sake of illustration, the interface of the NIC 2403 is depicted as being partitioned into four sub-interfaces i.e., sub-interface 1 2403A, sub-interface 2 2403B, sub-interface 3 2403C, and sub-interface 4 2403D. One or more connectors of a shuffle cable may be directly coupled to the network interface 2403.

As shown in FIG. 24, a first connector 2405A is coupled to a subset of sub-interfaces of the NIC 2403 e.g., the first connector is coupled to sub-interface 1 2403A and sub-interface 2 2403B, while a second connector 2405B is coupled to a different subset of sub-interfaces of the NIC 2403 e.g., the second connector is coupled to sub-interface 3 2403C and sub-interface 4 2403D. Each of the connectors 2405A and 2405B may correspond to multi-fiber push on (MPO) connectors that incorporate multiple optical fibers (also referred to as links or strands) within them. For example, connector 1 2405A incorporates two MPO connectors, while connector 2 2405B incorporates two MPO connectors.

As shown in FIG. 24, each sub-interface 2403A-2403D can be connected to different shuffle cables 2411-2414, respectively. Furthermore, each shuffle cable 2411-2414 can be connected to two different leaf switches. For example, one connector at end A of the shuffle cable 2411 can be connected to the sub-interface 1 2403A and the two connectors at the end B of the shuffle cable 2411 can be connected to two different leaf switches e.g., P1-LS1, P2-LS1. This way, one NIC of the host machine can be connected to 8 different leaf switches, thereby increasing the scaling of host machine connectivity by 8 times compared to a single NIC with single host machine to switch cable.

In this manner, the interface of the NIC 2403 is partitioned into a plurality of sub-interfaces, where each sub-interface may be communicatively coupled to different entities (e.g., different T0-tier switches in the network fabric configuration (e.g., of FIGS. 7, 15, 21). Further, it is to be appreciated that although the NIC interface is designed to operate at a certain rate (e.g., 400G, 800G), the individual sub-interfaces of the NIC operate at lower rate (e.g., 100G, 200G). Additionally, it is noted that the 1:4 breakout scenario depicted in FIG. 24 is for illustrative purposes only and is not intended to limit the scope of the present disclosure. Rather, other forms of breakouts e.g., 1:8 breakout of an 800G interface into 8×100G sub-interfaces is well within the scope of the present disclosure.

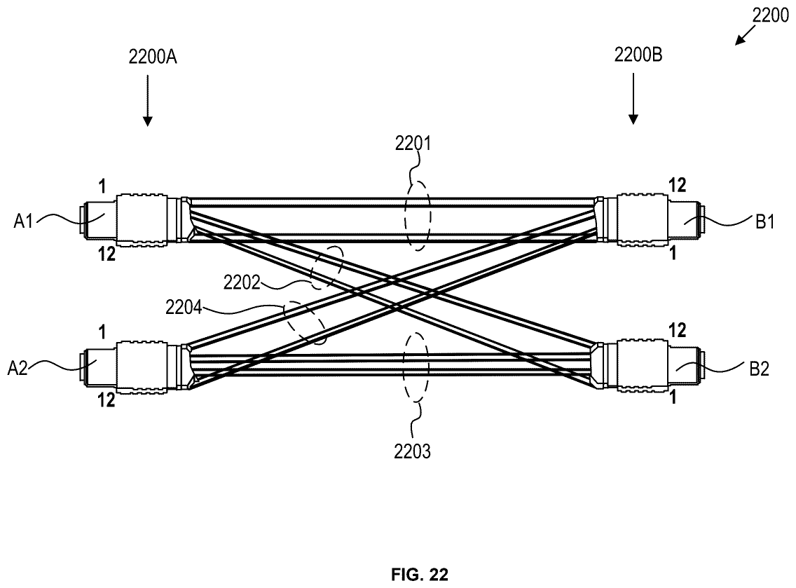

FIG. 22 illustrates an example shuffle cable 2200, according to various embodiments. The shuffle cable 2200 can be an example of the shuffle cables 2141, 2151 (in FIG. 21), or 2411-2414 (in FIG. 24). The shuffle cable 2200 includes two ends 2200A and 2200B. The first end 2200A can include a first connector A1, and a second connector A2, and the opposite second end 2200B can include a third connector B1, and a fourth connector B2. The connectors A1, A2, B1, and B2 can be multi-fiber push on connectors (MPO). For example, the connectors A1, A2, B1, and B2 can be MPO connectors having 8, 12, 16, or 24 fibers.

In the various embodiments, the internal fiber routing of the shuffle cable 2200 comprises a set of fiber optic strands (also referred as fibers, strands) configured to connect one connector with the connectors at the opposite ends. Each connector-to-connector connection may be referred to as an optical path. For example, a first set of fiber optic strands 2201 can connect the first MPO A1 to the third MPO B1. These fibers 2201 may correspond to a first optical path. A second set of fiber optic strands 2202 can connect the first MPO A1 to the fourth MPO B2. These fibers 2202 may correspond to a second optical path. A third set of fiber optic strands 2203 can connect the second MPO A2 to the third MPO B1. These fibers 2203 may correspond to a third optical path. A fourth set of fiber optic strands 2204 can connect the second MPO A2 to the fourth MPO B2. These fibers 2204 may correspond to a fourth optical path.

In at least some embodiments, the internal fiber routing may include a crossing or X-shaped pattern and configured to ensure deterministic mapping of sub-interface channels across the cable's endpoints. For example, using the shuffle cable 2200, each of the host machines sub-interface NIC1-NIC4 (e.g., 100G, 200G) may be realized as a bidirectional channel, supporting full-duplex communication and enabling direct mapping between the split portions of the original interface (e.g., 400G, 800G) and the respective network elements to which they are assigned.

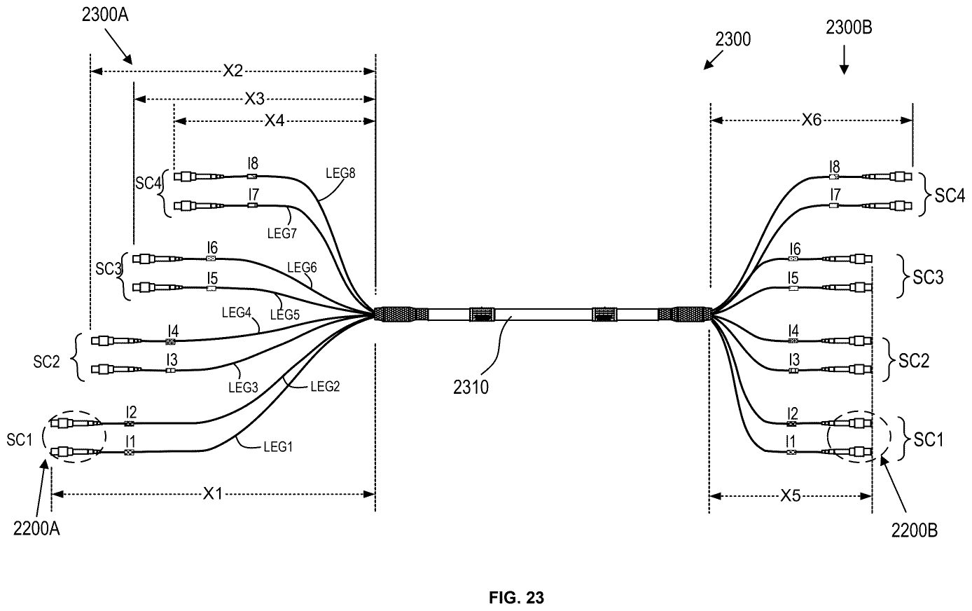

FIG. 23 illustrates an example shuffle cable harness 2300 including multiple shuffle cables (e.g., 2200 of FIG. 22). The shuffle cable harness 2300 can include a bundle portion 2310, a first end 2300A located on one side of the bundle portion 2310, and an opposite second end 2300B located on the opposite side of the bundle portion 2310. The shuffle cables may be grouped together within the bundle portion 2310, and branch out individually towards the first end 2300A and second end 2300B. As an example, the harness 2300 may include four shuffle cables SC1-SC4. Each shuffle cable SC1-SC4 can have similar configuration as the shuffle cable 2200 (in FIG. 21). For example, the shuffle cable SC1 can be configured to include connector ends 2200A, and 2200B, and related optical paths (e.g., as discussed above with respect to FIG. 22) therebetween.

In the illustrated embodiment, the optical paths of the shuffle cable SC1 may be grouped into two legs LEG1 and LEG2 extending between the ends 2200A and 2200B. With four such shuffle cables SC1-SC4, the shuffle cable harness 2300 can form eight cable legs LEG1-LEG8. Each cable leg can include connectors (e.g., MPO-12 connectors) at the ends 2300A and 2300B. Thus, the harness 2300 can facilitate connection between eight devices. The shuffle cable harness 2300 can be configured as a compact cable for easy maintenance and handling.

In some embodiments, leg lengths between each leg LEG1-LEG8 may vary at a particular end. For example, some of the legs or leg portions may be longer than others for better reachability to ports or interfaces that are spaced apart (e.g., horizontally spaced). In some embodiments, a portion at the first end 2300A may have different leg length than a portion at the second end 2300B. This can provide several advantages in terms of installations and compact cable management. In the illustrated embodiment, at the first end 2300A, the legs LEG1, LEG2 can have leg lengths X1, the legs LEG3, LEG4 can have leg lengths X2, the legs LEG5, LEG6 can have leg lengths X3, and the legs LEG7, LEG8 can have leg lengths X4. The length X1 can be greater than X2. The length X2 can be greater than X3. The length X3 can be greater than X4. While at the first end 2300B, the legs LEG1-LEG6 have the same length X5, and the legs LEG7-LEG8 can have the length X6. The length X6 can be greater than X5. These length relationships are presented only as one example and other length variation are possible depending on port locations on the devices to be connected.

In the various embodiments, the harness 2300 can include visual indicator for each cable leg and each end of the cable leg. For example, at the first end 2300A, the legs LEG1-LEG8 can have visual indicators I1-18, respectively. Similarly, at the second end 2300B, the legs LEG1-LEG8 can have counterpart visual indicators I1-18, respectively. The visual indicators I1-18 may be color codes, numerical labels, or other standard cable identification formats, or a combination thereof. This can simplify cable identification, routing and handling within a large datacenter having hundreds or thousands of connections between different devices.

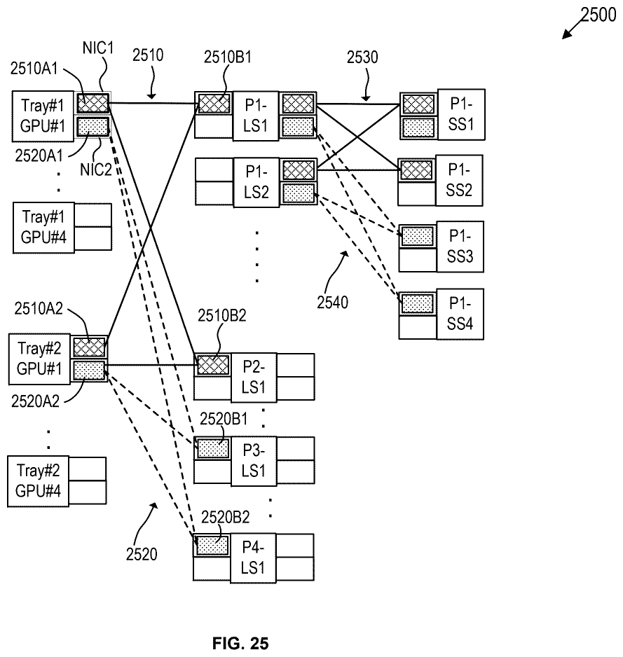

FIG. 25 illustrates an example schematic of connection between host machine NICs (e.g., similar to FIG. 24), leaf switches, and spine switches using the shuffle cables of FIG. 22, according to various embodiments. The illustration shows two shuffle cables 2510, 2520 between the host machines (e.g., in a GPU rack) and leaf switches (T0-tier) (e.g., in a leaf rack), and two shuffle cables 2530, 2540 between the leaf switches and the spine switches (T1-tier) (e.g., in a spine rack). The shuffle cables 2510, 2520, 2530, 2540 can be examples of the shuffle cable 2200 (in FIG. 22).

In an exemplary embodiment, the shuffle cable establishes host machine-to-leaf switch connectivity. The shuffle cable 2510 is configured with four connectors, referenced as 2510A1, 2510A2, 2510B1, and 2510B2. The first connector 2510A1 is adapted to operatively couple with a sub-interface NIC1 associated with a host machine #1 located within a first compute tray (tray #1). The second connector 2510A2 is similarly adapted to connect to a corresponding sub-interface NIC1 associated with a host machine #1 in a second compute tray (tray #2). On the opposite end of the shuffle cable 2510, the third connector 2510B1 is configured to couple with an input port of a first leaf switch P1-LS1 that is assigned to a first network plane P1, while the fourth connector 2510B2 is configured to couple with an input port of a first leaf switch P2-LS1 assigned to a second network plane P2. This configuration enables the deterministic breakout of a high-speed interface (e.g., 800G port) into two separate sub-interfaces (e.g., 200G), each routed to a different leaf switch in a distinct plane. As a result, data originating from host machine #1 in either tray can be simultaneously and redundantly routed across multiple network planes, enhancing both bandwidth utilization and resiliency in the data center's network fabric.

The shuffle cable 2520 establishes another host machine-to-leaf switch connectivity. For example, the shuffle cable 2520 is provided with four connectors, referenced as 2520A1, 2520A2, 2520B1, and 2520B2. The first connector 2520A1 is configured to connect to a second sub-interface NIC2 of host machine #1 in tray #1, while the second connector 2520A2 is adapted for connection to a second sub-interface NIC2 of host machine #1 in tray #2. The third connector 2520B1 is arranged to couple with an input port of a first leaf switch P3-LS1 that is assigned to a third network plane P3, and the fourth connector 2520B2 is arranged to couple with an input port of a first leaf switch P4-LS1 in a fourth network plane P4. This arrangement allows the second pair of sub-interfaces from host machine #1 to be distributed across additional, distinct network planes, further increasing the network's parallelism and fault tolerance. By employing multiple shuffle cables, each targeting different pairs of planes, each host machine's high-speed interface can be partitioned and mapped into the network fabric, supporting large-scale, multi-plane network topologies.

In the illustrated embodiment, the shuffle cable 2530 has connectors 2530A1, 2530A2, 2530B1, 2530B2. A first connector 2530A1 can be connected to an output port of the first leaf switch P1-LS1 of a first plane P1. A second connector 2530A2 can be connected to an output port of the second leaf switch P1-LS2 of the first plane P1. A third connector 2530B1 can be connected to an input port of the first spine switch P1-SS1 of a first plane P1. A fourth connector 2530B2 can be connected to an input port of the second spine switch P1-SS2 of the first plane P1.

The shuffle cable 2530 establishes leaf-to-spine switch connectivity. In the illustrated embodiment, the shuffle cable 2530 is configured to facilitate connectivity between a leaf layer and a spine layer within the same network plane without limiting the scope of the present disclosure. Connectivity between different planes is also possible. The shuffle cable 2530 also comprises four connectors 2530A1, 2530A2, 2530B1, and 2530B2. The first connector 2530A1 is adapted to connect to an output port of the first leaf switch P1-LS1 in the first network plane P1, and the second connector 2530A2 is configured to connect to an output port of a second leaf switch P1-LS2 also residing in the first plane P1. On the opposing end, the third connector 2530B1 is arranged to connect to an input port of a first spine switch (P1-SS1) in the same plane P1, while the fourth connector 2530B2 is configured for connection to an input port of a second spine switch P1-SS2 in the same plane P1. This direct mapping enables the deterministic, order-preserving transfer of data from the leaf switches to the spine switches, maintaining the logical and physical separation of each plane. The use of the shuffle cable 2530 in this context ensures that network traffic is efficiently distributed within the plane, supporting non-blocking communication and scalable, high-radix network architectures.

In the illustrated embodiment, the shuffle cable 2540 has connectors 2540A1, 2540A2, 2540B1, 2540B2. A first connector 2540A1 can be connected to another output port of the first leaf switch P1-LS1 of the first plane P1. A second connector 2540A2 can be connected to another output port of the second leaf switch P1-LS2 of the first plane P1. A third connector 2540B1 can be connected to an input port of the third spine switch P1-SS3 of the first plane P1. A fourth connector 2540B2 can be connected to an input port of the fourth spine switch P1-SS4 of the first plane P1.

The shuffle cable 2540 establishes another leaf-to-spine switch connectivity within the first network plane P1. The shuffle cable 2540 is similarly equipped with four connectors 2540A1, 2540A2, 2540B1, and 2540B2. The first connector 2540A1 is adapted to couple with another output port of the first leaf switch P1-LS1 in the first plane P1, while the second connector 2540A2 is adpated to couple with another output port of the second leaf switch P1-LS2 in the same plane P1. The third connector 2540B1 is adapted to connect to an input port of a third spine switch P1-SS3 in the first plane P1, and the fourth connector 2540B2 is arranged to connect to an input port of a fourth spine switch P1-SS4 in the first plane P1. This configuration enables further expansion of the available bandwidth and redundancy within the same network plane, allowing multiple parallel data paths between the leaf and spine layers. The systematic use of shuffle cables such as 2540 ensures that each leaf switch can distribute its traffic across multiple spine switches in an order-preserving and deterministic manner, thereby supporting the scalability, resilience, and performance objectives of the data center fabric. The cabling using the shuffle cables (e.g., 2510, 2520, 2530, 2540) enables a systematic, order-preserving, and scalable partitioning of high-speed network interfaces across multiple network planes and switch tiers. By providing deterministic mapping from hosts sub-interfaces to leaf switches in different planes, and from leaf switches to spine switches within the same plane, the shuffle cable enables high-performance, robust, and easily maintainable data center networks optimized for modern cloud and AI workloads, for example.

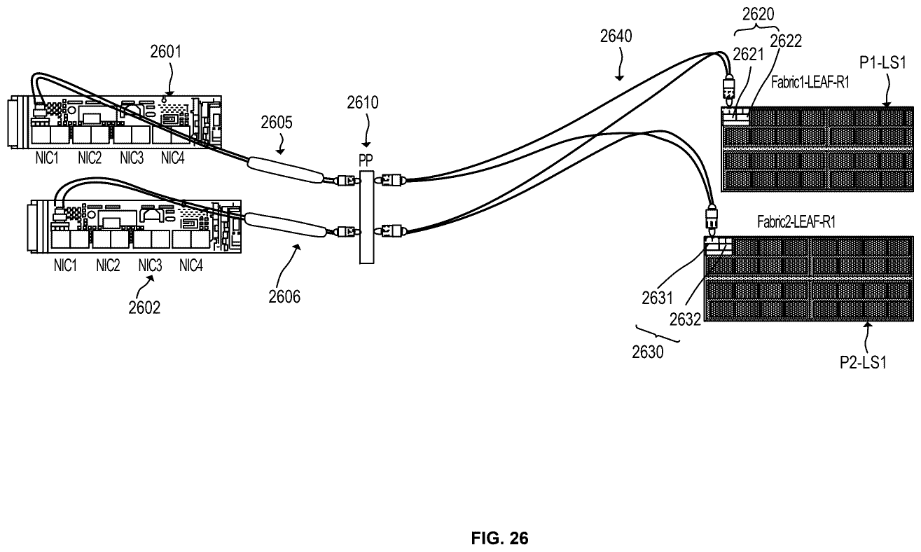

FIG. 26 illustrates example cabling between multiple hosts and multiple leaf switches using a patch panel and shuffle cables, according to various embodiments. As shown, host (e.g., GPUs) 2601, 2602 each include four sub-interfaces NIC1-NIC4. The leaf switches P1-LS1, P2-LS1 each include a plurality of ports (e.g., 2620, 2630), and each of the port may be subdivided. For example, the port 2620 may be subdivided into 2621, 2622, and the port 2630 may be subdivided into 2631, 2632. The subdivision of switch ports can facilitate the implementation of breakout architectures where a single high-speed port can be logically partitioned into sub-interfaces, improving network flexibility and scalability.

In some embodiments, a first cable 2605 having one MPO connector at opposite ends can be used to connect the host 2601 to the patch panel 2610. A second cable 2606 having one MPO connector at opposite ends can be used to connect the host machine 2602 to the patch panel 2610. As an example, each of the cables 2605 and 2606 can have multiple fiber strands (e.g., 8, 16 fiber strands) and provide 2×200G channels. The first cable 2605 provides a direct optical path from a sub-interface (e.g., NIC1) of the host 2601 to a designated port on the patch panel 2610, while the second cable 2606 provides a similar connection for a sub-interface (e.g., NIC1) of the host 2602 to a separate port on the patch panel 2610. This allows multiple hosts (e.g., GPUs or other computing devices) to be aggregated at a patch panel, simplifying subsequent cable management and supporting modular network design.

In some embodiments, a shuffle cable 2640 can be used to connect the patch panel 2610 to the leaf switches P1-LS1 and P2-LS1. The shuffle cable 2640 can be an example of the shuffle cable 2200. The shuffle cable 2640 establishes connection between two host machines 2601, 2602, and the leaf switch P1-LS1. The shuffle cable 2640 is configured such that it can simultaneously route optical signals originating from both host machines 2601 and 2602, via the patch panel 2610, to input ports on both leaf switches P1-LS1 and P2-LS1. More specifically, the shuffle cable 2640 (similar to the shuffle cable 2200) can include four connectors, where two connectors can be at the patch panel side and two connectors can be at the leaf switch side. The internal fiber arrangement of the shuffle cable 2640 enables the first connector at the patch panel side to optically couple to both the first and second connectors at the leaf switch side, enabling a sub-interface from host machine 2601 to reach both leaf switches P1-LS1 and P2-LS1. Similarly, the second connector at the patch panel side enables to optically couple with both leaf switch-side connectors, enabling a sub-interface from host machine 2602 to similarly reach both P1-LS1 and P2-LS1.

The cable configuration in FIG. 26 allows each host machine to communicate with multiple leaf switches in different planes or logical groupings, thereby providing redundancy and load balancing at the physical layer. The use of the patch panel 2610 as an intermediate aggregation point also offers enhanced flexibility in cable management, facilitating maintenance, upgrades, or reconfiguration of the network without disturbing direct host machine-to-switch connections. This embodiment also exemplifies the use of a patch panel in conjunction with shuffle cables to provide modular, scalable, and reliable interconnects between host machines and leaf switches. By leveraging deterministic internal fiber routing within the shuffle cable and supporting multi-plane connectivity, the architecture enables robust, high-performance communication paths suitable for next-generation data center networks.

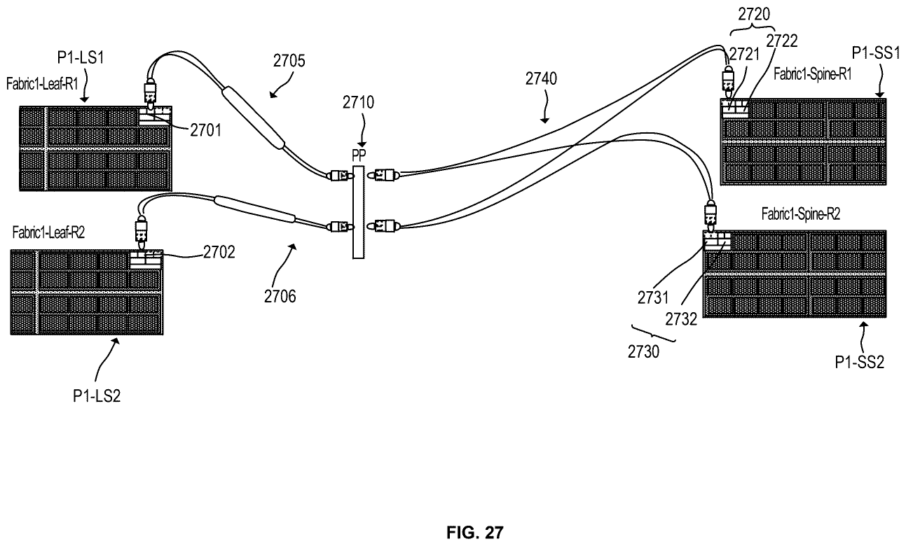

FIG. 27 illustrates example cabling between multiple leaf switches and multiple spine switches using a patch panel and shuffle cables, according to various embodiments. For example, leaf switches P1-LS1, P1-LS2 each include a plurality of ports (e.g., 2701, 2702), and spine switches P1-SS1, P1-SS2 each include a plurality of ports (e.g., 2720, 2730). The cabling configuration in FIG. 27 can be similar to that in FIG. 26.

In some embodiments, a first cable 2705 having one MPO connector at opposite ends can be used to connect the leaf switch P1-LS1 to the patch panel 2710. A second cable 2706 having one MPO connector at opposite ends can be used to connect the leaf switch P1-LS2 to the patch panel 2710. As an example, each of the cables 2605 and 2606 can have multiple fiber strands (e.g., 8, 16 fiber strands) and provide 2×200G channels. The first cable 2705 provides a direct optical path from the first leaf switch P1-LS1 to a designated port on the patch panel 2710, while the second cable 2706 provides a similar connection for the second leaf switch P1-LS2 to a separate port on the patch panel 2710. This allows multiple leaf switches to be aggregated at a patch panel, simplifying subsequent cable management and supporting modular network design.

In some embodiments, a shuffle cable 2740 can be used to connect the patch panel 2710 to the spine switches P1-SS1 and P1-SS2. The shuffle cable 2740 can be an example of the shuffle cable 2200. The shuffle cable 2740 establishes connection between the two leaf switches P1-LS1, P1-LS2, and the two spine switches P1-SS1, P1-SS2. The shuffle cable 2740 (similar to the shuffle cable 2640) is configured such that it can simultaneously route optical signals originating from the leaf switches 2701 and 2702, via the patch panel 2710, to input ports on both spine switches P1-SS1 and P1-SS2. More specifically, the shuffle cable 2740 can include four connectors, where two connectors can be at the patch panel side and two connectors can be at the spine switch side. The internal fiber arrangement of the shuffle cable 2740 enables the first connector at the patch panel side to optically couple to both the first and second connectors at the spine switch side, enabling traffic from one leaf switch (e.g., P1-LS1) to reach both spine switches P1-SS1 and P1-SS2. Similarly, the second connector at the patch panel side enables to optically couple with both spine switch-side connectors, enabling the leaf switch (e.g., P1-LS2) to similarly reach both the spine switches P1-SS1 and P1-SS2.

The cable configuration in FIG. 27 (similar to FIG. 26) allows network traffic from each leaf switch to be distributed across multiple spine switches within the same plane (or different planes), supporting parallel data paths, increased bandwidth, and enhanced redundancy. The use of the patch panel 2710 as an intermediate aggregation point further allows for modular and flexible network deployment, facilitating maintenance, upgrades, and scaling without disruption to the direct leaf-to-spine connections. This embodiment also demonstrates how patch panels and shuffle cables can be used in tandem to provide robust, scalable, and deterministic interconnects between leaf and spine switches. By leveraging order-preserving internal fiber routing and supporting multi-plane connectivity, the architecture enables high-performance communication paths, modular network management, and future-ready scalability for advanced data center deployments.

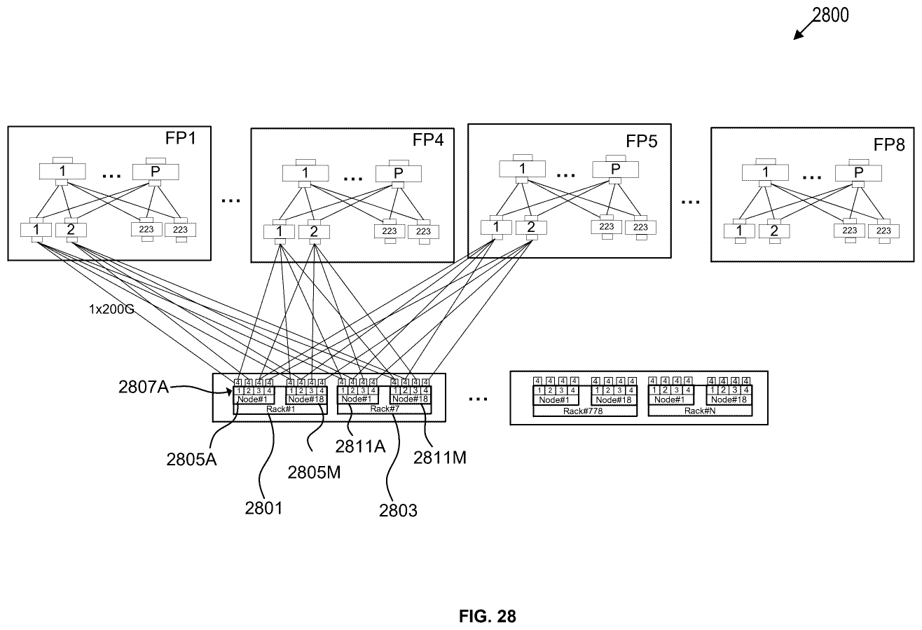

FIG. 28 illustrates an example backend network fabric 2800, according to various embodiments. FIG. 28 depicts a plurality of racks (e.g., host rack 1 2801, host rack K 2803), where each rack houses a plurality of host machines (or hosts). For instance, rack 1 2801 includes M host machines 2805A-2805M whereas rack K 2803 includes M host machines 2811A-2811M. It is noted that the number of host machines included in each rack need not be the same. For instance, a particular rack may have a higher (or lower) number of host machines as compared to another rack. Further, each host machine includes one or more host machines, where each host machine is associated with (or coupled to) a corresponding NIC. It is appreciated that in FIG. 28 each host machine is depicted as being associated with four NIC. This is done for illustration purposes only and does not limit the scope of the present disclosure. As shown in FIG. 28, host machine 1 (2805A) in rack 1 (2801) is associated with four NIC 2807A (individually labelled 1-4), and the host machine M (2805M) in rack 1 (2801) is associated with four NIC (individually labelled 1-4). Similarly, host machine 1 (2811A) in rack K (2803) is associated with four NIC (individually labelled 1-4) and host machine M (2811M) in rack K (2803) is associated with four NIC (individually labelled 1-4).

Further, as shown in FIG. 28, the network environment 2800 includes a plurality of network fabrics (also referred to herein as fabric planes or planes) e.g., fabric plane 1 (FP1), fabric plane 2 (FP2), fabric plane 3 (FP3), and fabric plane 4 (FP4). Each fabric plane FP1-FP8 includes a network of switches arranged in a hierarchical two-tier fashion (including T0-tier of switches and a T1-tier of switches). The T0-tier of switches includes L switches that are coupled to P switches included in the T1-tier of switches. Exemplary values of L and P may be L=256 switches and P=128 switches.

For each host machine included in the network environment 2800, an interface of a NIC connected to a GPU (included in the host machine) is partitioned into a plurality of sub-interfaces. This is performed similar to the partitioning of the interface of NIC 2403 as described previously with reference to FIG. 24. As shown in FIG. 28, the interface of each NIC is partitioned into four sub-interfaces (indicated by label 4 on top of each NIC 1-4). It is noted that each sub-interface in the plurality of sub-interfaces is addressable via a corresponding network address (e.g., unique IP address).

In FIG. 28, each sub-interface of a NIC is communicatively coupled to a different network fabric of the plurality of network fabrics. For instance, a first sub-interface of NIC 2807 is coupled to network fabric plane 1 (FP1), a second sub-interface is coupled to network fabric plane 2 (FP2), a third sub-interface is coupled to network fabric plane 3 (FP3), and a fourth sub-interface is coupled to network fabric plane 4 (FP4). It is appreciated that each of the sub-interfaces is coupled to a switch included in the T0-tier of switches in the respective fabric planes.

The network configuration of FIG. 28 results in the plurality of fabric planes being disjoint from one another i.e., a particular fabric plane is not directly coupled with another fabric plane. Further, each fabric plane can be thought of as being associated with a specific address space i.e., the addresses of sub-interfaces of the different NICs that are coupled to T0-tier switches included in that fabric plane. Thus, the multiple disjoint fabric plane configuration of FIG. 28 can utilize the advantages of scalability of the two-tier CLOS network with the added constraint that a NIC is now to be capable of making forwarding decisions so as not to communicate packets across fabric planes.

Furthermore, the fabric planes in one datahall (e.g., A) can be connected to the fabric planes in a second datahall (e.g., B) isolated from each other. For example, the cables from each fabric planes FP1-FP8 can be aggregated and routed into the second datahall to connect with similar fabric planes of the second datahall (e.g., B). This way, host machines from one datahall can communicate with host machines in the second datahall via the network fabric therebetween. Such network fabric configuration allows to scaling a datacenter by 2×, 3×, or other multiples. As each host machine is connected to each other host machine, redundancies can be established between two datacenters to improve availability of the datacenter as a whole.

Specifically, when a first host machine included in a particular host machine (e.g., first host machine) has a packet that is to be transmitted to a second host machine (e.g., included in a second host machine), a selection of a particular sub-interface (e.g., first sub-interface) of the plurality of sub-interfaces of the NIC (connected to the first GPU) is to be made on which the packet is to be transmitted. It is noted that selection of the particular sub-interface in turn, identifies a second sub-interface of a second NIC that is connected to the second host machine on which the packet is received by the second host machine. Further, the packet transmitted by the first host machine to the second host machine only traverses the network fabric plane (of the plurality of network fabric planes) to which the first sub-interface and the second sub-interface are coupled to. Additionally, it is noted that the connections from the different sub-interfaces of the NICs in FIG. 28 may be achieved via utilizing the shuffle cables as previously described with reference to FIGS. 22-24.

Additionally, it is noted that the network configuration of FIG. 28 provides for the following advantages-achieving differentiated services via the different fabric planes. For instance, a particular fabric plane may be dedicated for RDMA workloads, whereas another fabric plane may be dedicated for storage services. Thus, workloads related to a particular service may be directed towards a specific fabric plane.

The present disclosure provides an Optical Circuit Switch (OCS) to facilitate customized (e.g., user-specified) interconnectivity between different buildings and their respective datahalls. The buildings can be spaced from each other by a distance upto 10 kms. The OCS herein enables remotely reconfigurable fiber optic mesh connectivity between spine layers (i.e., T1-tier switches) of different building. In some embodiments, a set of OCS can be housed in a separate building, and interconnectivity between different building is routed through the set of OCS. In some embodiments, connection mapping between different building can be established via an Application Programming Interface (API). Using the API, dynamic network topology can be defined and bandwidth can be partitioned. Accordingly, a user-specified network map can be implemented without having to physically change or rewire the network connections.

The OCS design herein provides several advantages. For example, the OCS herein enables redundancy, fiber management at extreme scale, vendor and technology agnosticism for OCS, and an optical transceiver configured to meet loss budgets and reach constraints introduced by OCS insertion loss. The network topology established via the OCS can be controlled by a customer and adjusted per changing customer requirements. This way, the infrastructure provider does not have to keep track of a specific customer topology or changing connectivity requirements between different buildings.

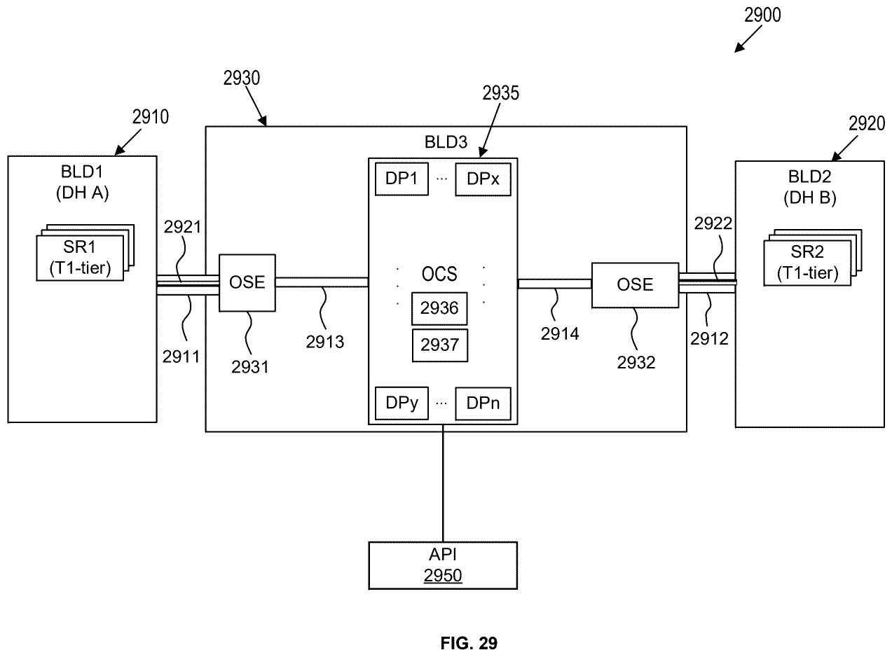

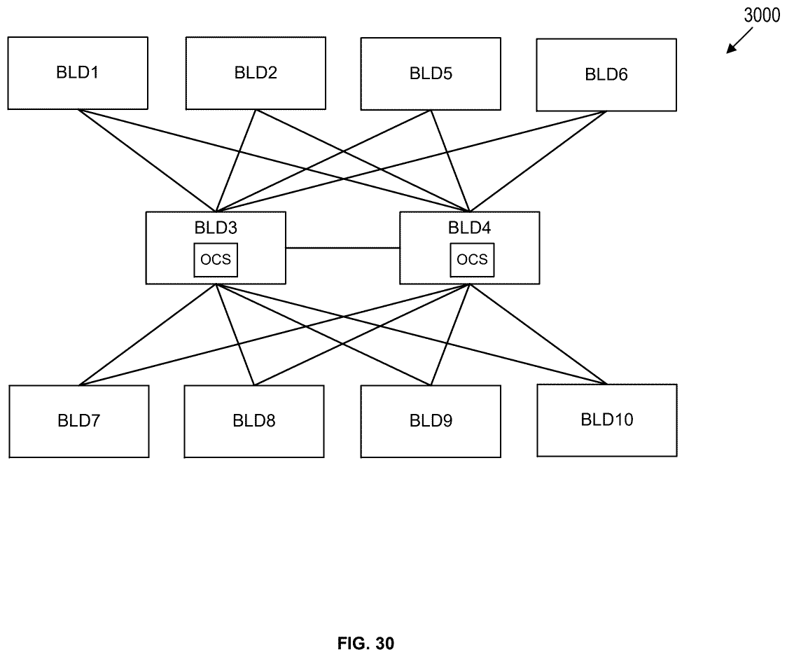

FIG. 29 illustrates an example interconnectivity between two different buildings: a first building BLD1, and a second building BLD2 using an OCS 2935. For example, a network system 2900 can be established to facilitate inter-building connectivity. In some embodiments, the OCS 2935 can be located within one of the buildings BLD1, BLD2 or in a separate building e.g., a third building BLD3 (as shown in FIGS. 29 and 30). Each building can include one or more datahalls, for example, datahalls DH A, DH B with spine racks housing spine switches as shown in FIG. 7. In some embodiments, the OCS 2935 may be located in datahall DH E (see FIG. 7). As shown in FIG. 29, the first building BLD1 can include a first set of spine switches SR1 (i.e., T1-tier) housed within a spine rack, and the second building BLD2 can include a second set of spine switches SR2 housed within a spine rack. The spine switches may be located in different datahalls such as datahall DH A and/or datahall DH B. Example cabling within the datahalls and between different datahalls of a building is discussed in detail above, and omitted here for brevity.

In some embodiments, the third building BLD3 can include the OCS 2935, and one or more optical splice enclosures (OSEs). For example, OSE 2931, 2932 can serve as a connection interface between bulk cables extending over long distances and internal cables within a building. The OSE 2931, 2932 aggregates all the optical strands from different buildings and provides easy access to specific fibers to establish interbuilding connectivity. At each OSE (e.g., 2931, 2932), fibers from one building can be fusion spliced. From the OSE 2931, 2932, cabling with connectors can be provided to connect OCS 2935. In some embodiments, the OSE 2931, 2932, the OCS 2935, and interbuilding cabling can be provided as part of a preinstalled infrastructure. Within this infrastructure, customized connections between spine switches distributed across multiple buildings can be easily established and the datacenter can be brought online quickly or on-demand.

In some embodiments, the network system 2900 can include the spine switches SR1, SR2, one or more reconfigurable OCS 2935, and cabling 2911, 2912, 2913, and 2914, OSE 2931 and 2932 for interconnecting the spine switches SR1, SR2 and OCS 2935. In some embodiments, a first cable 2911 and a second cable 2912 can be bulk cable trunks. For example, the first cable 2911 and the second cable 2912 can include a large number of optic fiber strands (e.g., 6,912-strands) with spliced ends. The spliced ends reduce insertion dB losses associated with connectors. This improves the end-to-end optical link budget (e.g., power budget), enables higher data rates, and lowers error rates during data transmission. One end of the first cable 2911 can be fusion spliced to OSE within the first building BLD1 and the opposite end can be connected to the OSE 2931 within the building BLD3. One end of the second cable 2912 can be fusion spliced to OSE within the second building BLD2 and the opposite end can be connected to the OSE 2932 within the building BLD3. In some embodiments, the connections within each the building BLD2 and BLD3 may also be made with pre-terminated cable trunks.

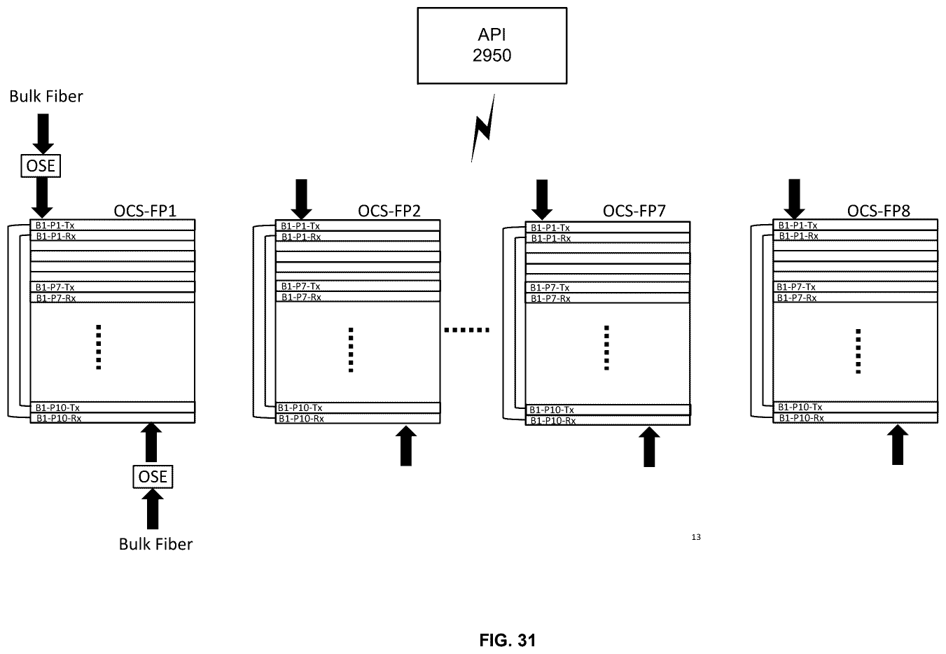

The first cable 2911 can include a first set of optical fibers 2921 extending from the first set of spine switches SR1 in the first building BLD1. The second cable 2912 can include a second set of optical fibers 2922 extending from the second set of spine switches SR2 in the second building BLDG2. The first set of optical fibers 2921, and the second set of optical fibers 2922 can be connected to the OCS. Further, the OCS can be configured to connect these set of optical fibers 2921, 2922 to establish spine-to-spine connectivity between the two buildings BLD1 and BLD2. The OCS is remotely reconfigurable to establish a user-specified network topology between the first set of spine switches SR1, the second set of spine switches SR2, and/or other spine switches in different buildings (e.g., see FIG. 31). In some embodiments, the first set of spine switches SR1 and the second set of spine switches SR2 can be part of a back-end network. Accordingly, back-end spine-to-spine connections can be established via the OCS 2935. Additionally or alternatively, spine switches may be part of a front-end network, and the OCS can be configured (similar to the switches SR1, SR2) to establish a user-specified network topology in the front-end network.

In some embodiments, internal building cables from OSE to OCS can be structurally different from the bulk cable trunks between different buildings. For example, a third cable 2913, and a fourth cable 2914 between the respective OSE 2931, 2932 and the OCS 2935 can be smaller in size than the bulk cable trunk, can include less number of optical fibers than the bulk cable trunk, and can include connectors at one end connecting the OCS 2935. In some embodiments, the third cable 2913 and the fourth cable 2914 can be spliced at an OSE end and include connectors (e.g., Multi-fiber Push On (MPO) connectors, or Miniature Multi-Fiber Connector (MMC)) at an OCS connecting end. These cables 2913, 2914 enable ease of connections e.g., plug and play.

The OCS 2935 can include a plurality of OCS ports DP1 through DPn. The OCS port can be configured as two-dimension port matrix. Each of the OCS ports DP1 through DPn can be a simplex port. In various embodiments, the simplex ports can be used in pairs to form duplex channels through the OCS. For example, each duplex channel uses one ingress simplex port and one egress simplex port to create a duplex channel. Additionally, or alternatively, the OCS port can be a duplex port. The OCS port configuration provides a bidirectional optical interface comprising adjacent transmit and receive ports, which are treated as a single logical port. Each duplex channel configuration facilitates signals flow simultaneously in both directions. Each duplex channel configuration can be physically realized as two adjacent LC connectors that mate to a duplex fiber pair. Each OCS port can be presented as a unit within the OCS's two-dimensional port matrix, enabling per-link capacities such as 800 Gbps realized as two independent 400 Gbps lanes. The spine switches can include OCS facing ports configured to receive OSFP-based transceivers with upto 3 dB insertion loss compensation.

The OCS 2935 can provide deterministic, reconfigurable, optical interconnections by selectively coupling duplex fiber pairs across the OCS ports DP1-DPn. In some embodiments, the OCS ports DP1-DPn can include 600 or more simplex ports arranged as programmable ingress and egress arrays. For example, the 600 ports of an OCS can be organized as 300 ingress arrays and 300 egress arrays. Each duplex channel uses one ingress simplex port and one egress simplex port, to create 300 duplex channels. These OCS ports DP1-DPn can be operable to connect any selected input duplex pair to any selected output duplex pair subject to configuration constraints such as port-set groupings aligned to the number of interconnected buildings. The OCS 2935 can include a control plane including a OCS controller 2936 and memory 2937 storing connection mapping tables. The connection mapping tables can specify for each OCS port (e.g., DP1 or DPx), which destination OCS port (e.g., DPy, or DPn) it must be optically coupled to, and in which direction. This way, the OCS controller 2936 can deterministically establish T1-tier paths without optical-electrical conversion. The OCS 2935 serves as the intermediate representation between customer control requests and device-specific actuation commands, enabling rapid, validated setup of point-to-point links across large port arrays.

The OCS 2935 can further include monitoring logic to confirm completion of requested mappings and a recovery mechanism that restores the last-known-good configuration upon power events. The OCS 2935 may exhibit a characteristic insertion loss on the order of about 3 dB that is accounted for in the end-to-end link budget and optics selection. The OCS 2935 can be used to interconnect spine tiers across buildings, allowing customers to dynamically form point-to-point connections between buildings and to partition bandwidth by selecting how many OCS ports to allocate per inter-building path. Each duplex link can provide high-capacity service (for example, approximately 800 Gbps realized as two independent 400 Gbps LC pairs). This OCS-based architecture supports flexible, customer-programmable network topologies. In some embodiments, for ease of operations, reconfigurability of the OCS ports DP1-DPn can be constrained within defined port sets and by providing symmetric redundancy across multiple buildings with OCS, so that connectivity persists with reduced capacity if a building fails.

The OCS 2935 can include a switching fabric realized using different underlying technologies. For example, the switching fabric can include micro-electromechanical mirror arrays (MEMS), liquid-crystal optical elements, or fiber-actuated mechanisms. The OCS controller 2936 comprises a programming model which is translated into configuration syntax specific to each vendor platform.

In some embodiments, an Application Programming Interface (API) 2950 can be provided to facilitate configuration and reconfiguration of one or more OCS. The API can be configured to accepts customer specified network topology requests and translates them into OCS device specific actuation commands to establish point-to-point optical paths. For example, the API 2950 can be configured to assign a subset of first spine switches (e.g., SR1) to a first set of OCS ports (e.g., DP1-DPx), and a subset of second spine switches (e.g., SR2) to a second set of OCS ports (e.g., DPy-DPn). Based on the mapping, the OCS controller 2936 can establish a connection between the selected subsets of the spine switches SR1 and SR2. In some embodiments, the API 2950 or the OCS controller 2936 can be configured to translate the mappings into devices specific actuation commands.

In some embodiments, the API 2950 provides an abstraction of OCS ports DP1-DPn as addressable OCS ports organized into “port sets”. Each port set can be associated with a building. The API 2950 supports any-to-any point-to-point mappings within the set while preventing cross set mixing to preserve deterministic behavior. The API 2950 enables user-specified bandwidth allocation. For example, a user may assign a specified number of OCS ports per inter building pair, thereby partitioning bandwidth deterministically. For example, allocating MOCS ports yields M×800 Gbps of nominal capacity. The API 2950 permits symmetric distribution of connections across multiple buildings housing OCS, and supports reallocation to rebalance bandwidth when a building with OCS experiences failure, maintaining connectivity although with reduced capacity. Example port mapping between multiple buildings is discussed with respect to FIG. 31.

In some embodiments, the OSEs 2931, 2932 can be a wall-mounted or a rack-mounted housing that terminates high-count bulk fiber cables at building demarcation points and protects, organizes, and manages the fusion splices that join those trunks to distribution cables and patch panels. In some embodiments, the OSE can accept very high-count bulk cables (for example, 6912-strand trunks) and use splice trays (e.g., 48 fibers per tray) to structure mass splicing of groups of sixteen fibers from 288-fiber MPO/MMC trunks to the bulk cable. In various embodiments, each inter-building cable run terminates in an OSE on both ends, where the bulk cable trunk (e.g., 6912-strand cable) is spliced to a reduced number of (e.g., 288-fiber) MPO fanouts that feed MPO/MMC panels. On the hub side, MPO/MMC-to-LC cables breakout for LC-based equipment such as the OCS racks, providing strain relief, labeling, slack storage, and a protected environment that preserves optical performance and serviceability at scale.

The present disclosure provides several advantages. For example, the OCS 2935 and the API 2950 herein allows implementation of user-specified network topology without revealing the detailed mapping to an infrastructure provider. In other words, the OCS 2935 allow implementation of a dynamic network topology controllable by a user via API calls. This way, all-to-all spine switches in all the buildings can be connected, selected spines in one building can be connected selected spines in one or more building, or other combination of connections between different buildings can be established without intervention of the infrastructure provider. Accordingly, a customer can have control over implementing use-specific network topology. This can advantageously allow the customer to control its own security and privacy, as even the infrastructure provider may not have knowledge of the network topology implemented by the customer. In some embodiments, mapping of spines, network planes, floors, or buildings to sets of OCSs can be established based on the intended tradeoffs between cost, bandwidth partitioning, supply chain, and blast radius specific to the user.

The present disclosure can allow multiple-vendor and multiple OCS design. In other words, the API can make the network configuration agnostic OCS technology so that OCS implementation can be vendor independent and its technology independent. For example, switching within an OCS can be based on a Digital Liquid Crystal (DLX) technology, optomechanical switches, Micro-Electro-Mechanical Systems (MEMS) technology, Liquid Crystal beam-steering technology to connect optical fibers, Piezoelectric Actuator technology, or other technologies. In some embodiments, the OCS technology can employ all-optical switching (OOO) method that provides a fully non-blocking matrix, wherein any input can be connected to any output without blocking other connections.

FIG. 30 illustrates an overview of an example interconnectivity between spine switches in different buildings using optical circuit switches located in two different buildings. The building interconnectivity that includes user-specifiable network connections can be established in a similar way as shown and discussed with respect to FIG. 29. In FIG. 30, interconnectivity between ten buildings is shown as an example. It can be understood that OCS setup can be adopted to establish user-specified interconnectivity between less than 10 buildings, or more than 10 buildings as the datacenter scales up.

In the illustrated configuration, buildings BLD3 and BLD4 operate as hub sites that each house one or more OCS (e.g., 2935) and associated OSE (e.g., 2931, 2932) to terminate bulk inter-building cable trunks and fan out to equipment-side cabling. Spine tiers in buildings BLD1, BLD2, and BLD5 through BLD10 are pre-cabled to both hubs so that a network topology 3000 can be established by software rather than by physical recabling. In some embodiments, an operator deploys and maintains the physical optical fiber cabling and OCS infrastructure, while a customer uses the API 2950 to submit user-specified topology requests. The control plane validates the requested mappings, commits them across the OCS appliances (e.g., 2935) in BLD3 and BLD4, and establishes the end-to-end optical paths. In some embodiments, connectivity for each building can be symmetrically distributed across the two hubs to achieve path diversity and predictable failover characteristics. For example, spine connectivity from each building can be split 50%-50% between the building BLD3 and BLD4. In other examples, an asymmetric split (e.g., 30%-70%, 40%-60%, or other percentage) can be implemented based on a user needs or other events. For example, if one hub experiences a service event, connectivity persists through the other hub with a proportional reduction in capacity.

In representative embodiments tailored to a ten-building campus, each OCS appliance (e.g., 2935) exposes a high duplex-port count that is organized into port sets aligned to the number of interconnected buildings. For example, approximately 300 OCS ports can be divided into thirty port sets, with each set containing one addressable OCS port for each of BLD1 through BLD10. The API 2950 permits specified point-to-point mapping within a given set while enforcing exclusivity so that a given building's OCS port participates in at most one active connection per set. Bandwidth can be deterministically partitioned at T1-tier by the number of OCS ports allocated to a given inter-building pair across one or more sets. The same mappings can be committed in both hub buildings to realize full capacity or intentionally skewed between BLD3 and BLD4 to match workload placement, power domains, or maintenance windows. The API 2950 can further enables time-based or demand-based reconfiguration, such that sets assigned to one inter-building pair during a first interval can be reassigned to a different pair during a second interval, with rapid actuation and restoration to a last-known-good state after power events.

FIG. 31 illustrates a set of optical circuit switches (OCS) and their respective port configuration to facilitate interbuilding connectivity. In the illustrated embodiment, the set of OCS can be assigned to a plurality of fabric planes FP1-FP8 of a network. For example, a first OCS can be assigned to FP1, a second OCS can be assigned to FP2, . . . , a seventh OCS can be assigned to FP7, and an eight OCS can be assigned to FP8. The ports of each OCS can be divided between a total number of buildings. For example, an OCS can have 300 OCS duplex pair ports, which can be divided among 10 buildings. Accordingly, 10 ports pairs of the OCS may be assigned for 10 building. In this example, one OCS can have 30 such port groups. To establish a connection between selected buildings, the ports may be connected accordingly. A bank OCS can be pre-cabled to all 10 buildings, but the internal cross-connection is only created upon API request. Once the mapping is supplied to the OCS, data can be transferred between the specified buildings. Without such mapping between the buildings, there is no connection across the OCS for data transfer across different buildings.

In the illustrated embodiment, each port can be a OCS port having a transceiver port (denoted by Tx) and a receiver port (denoted by Rx). The API 2950 can be used to define port mapping between the buildings BLD1-BLD10, and/or change the mapping. For example, API 2950 can be used to establish (i) a star topology centered on one building (e.g., BLD1), (ii) a topology that split bandwidth allocation by splitting ports assigned for one building (e.g., BLD1) to connect with multiple buildings (e.g., BLD7 and BLD10), (iii) a partitioned cluster mappings, (iv) a time-based reconfiguration for workload scheduling (e.g., during daytime, allocate more sets between Buildings 1 and 2 for a latency-sensitive workload; during nighttime, reassign those sets to Buildings 1 and 5 for a different batch workload), and (v) plane-aware mapping (e.g., leaf and spine tiers may be organized into different fabric planes that feed OCS-facing spine ports. Port set assignments can be balanced across planes to align with power and path diversity (A/B paths)).

In the illustrated example, in FIG. 31, OCS ports can be grouped across building. For example, a first set of ports B1-P1 to B10-P1 of OCS can be assigned to building BLD1, a seventh set of ports B1-P7 to B10-P7, and a tenth set of ports B1-P10 to B10-P10 of OCS can be assigned to building BLD10. A mapping such as between the first set of ports B1-P1 to B10-P1 and the tenth set of ports B1-P10 to B10-P10 can be specified via the API 2950. Based on the mapping, an OCS controller of the respective OCS can connect, for example, a transceiver B1-P1-Tx of the first set of ports B1-P1 to a receiver B1-P10-Rx of the tenth set of ports B1-P10. Similarly, a receiver B1-P1-Rx of the first set of ports B1-P1 can be connected with a transceiver B1-P10-Tx of the tenth set of ports B1-P10. Once the mapping is established, the OCS-FP1 can allow traffic to flow between the set of ports B1-P1 and B10-P10. Such connection mapping can be specified for each OCS, or a selected number of OCS. This way, building BLD1 can be connected to building BLD10 via any of the OCS-FP1 through OCS-FP8.

As another example, a user may establish balanced bandwidth partitioning between two peers. For example, the partitioning can involve connecting building BLD1 to buildings BLD7 and BLD10 with split bandwidth allocations by assigning different counts of port sets to each pair. An example mapping table is provided below:

| Port Set ID | Building Pair (Duplex Mapping) |
|---|---|
| Set 1 | BLD1 ↔ BLD10 |
| Set 2 | BLD1 ↔ BLD10 |
| Set 3 | BLD1 ↔ BLD10 |
| Set 4 | BLD1 ↔ BLD7 |
| Set 5 | BLD1 ↔ BLD7 |
| Set 6 | BLD1 ↔ BLD7 |

In some embodiments, an example of portioned cluster mapping may be specified as follows shown in mapping table below. Buildings BLD1-BLD5 can form Supercluster A, and buildings BLD6-BLD10 can form Supercluster B. OCS port sets can be used to connect buildings only within each partition, enforcing isolation while allowing internal high-bandwidth mappings. No set maps a port between the clusters A and B. The control plane's mapping tables maintain per-tenant or per-cluster exclusivity as contemplated for future multi-tenant segmentation

| Port Set | Building Pair (Duplex Mapping) | Cluster |
|---|---|---|
| Set 1 | BLD1 ↔ BLD2 | A |
| Set 2 | BLD1 ↔ BLD3 | A |
| Set 3 | BLD4 ↔ BLD5 | A |
| Set 4 | BLD6 ↔ BLD7 | B |
| Set 5 | BLD8 ↔ BLD9 | B |
| Set 6 | BLD6 ↔ BLD10 | B |

As discussed above, customers can submit network topology requests to a unified, network-accessible API 2950 specifying building pairs and desired bandwidth in units of duplex links. The API 2950 can translate requests into mapping table entries confined to port sets, perform collision checks. Based on the mapping, the OCS controller of each OCS can actuate device-specific switching technologies (e.g., MEMS, liquid-crystal, fiber-actuated). In some embodiments, the OCS bank can be configured to restore a previous state without random reconnections. This preserves deterministic behavior across large port arrays and multiple hubs.

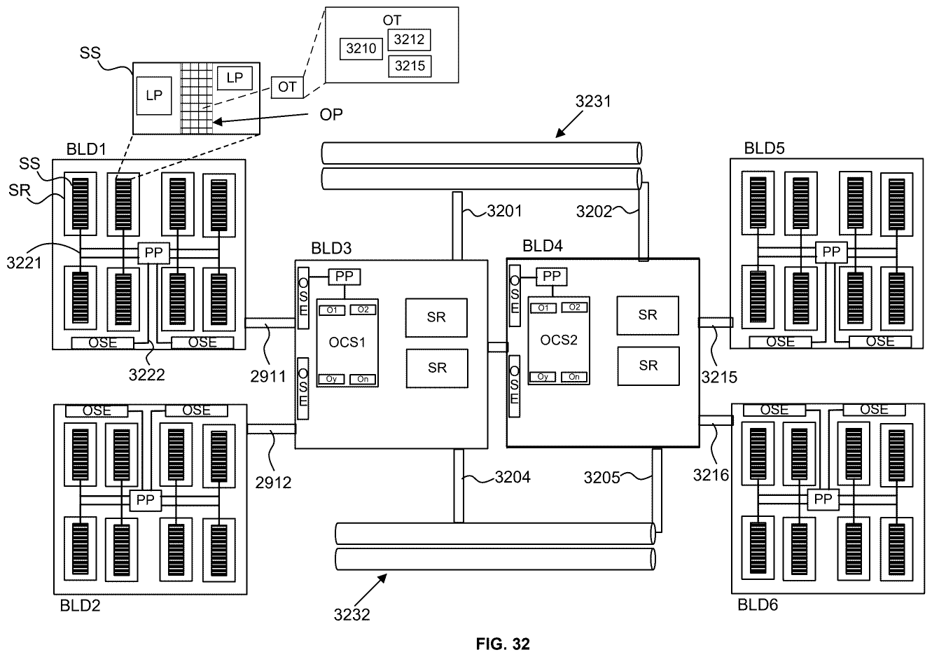

FIG. 32 illustrates a datacenter 3200 with a detailed view of an example interconnectivity between spine switches (i.e., T1-tier) located in different buildings via optical circuit switches located in separate buildings. As illustrated, a datacenter 3200 can include a first building BLD1, a second building BLD1, a third building BLD3, a fourth building BLD4, a fifth building, and a sixth building BLD6. Each of the buildings BLD1, BLD2, BLD5, and BLD6 can include a set of spine switches SS arranged in spine racks SR, and OSEs arranged at a boundary wall of the respective buildings. The locations of the spine switches SS are for illustration purposes only and may not be the exact location within the respective buildings. The locations of the spine switches SS may represent a portion of the datahall (e.g., DH A of FIG. 7).

In some embodiments, the buildings BLD3 and BLD4 can house a bank of OCS. For example, a first bank of OCS OCS1 is housed in the third building BLD3, and a second bank of OCS OCS2 is housed in the fourth building BLD4. The back of OCS can include a plurality of OCS (e.g., O1, O2, . . . , Oy, On). The buildings BLD3 and BLD4 can also include spine racks SR with spine switches, and OSE to receive bulk cable trunks 2911, 2912, 3201, 3202, 3204, 3205, 3215, 3216 between the buildings. In some embodiments, these bulk cable trunks between the buildings may be routed from OSE-to-OSE through conduits 3231, 3232.

In some embodiments, the spine switches SS can include OCS-facing ports OP in addition to leaf-facing switches LP. The leaf-facing ports LP refers to ports used to connect to leaf switches (e.g., BE-L in FIG. 7). Each of the OCS-facing ports OP refers to ports used to connect to OCS. As an example, each spine switch SS can have 64 ports, of which a set of ports (e.g., 8) can be dedicated to OCS-facing ports. The OCS-facing ports OP can have an Octal Small Form-Factor Pluggable (OSFP) configured on the switch end (e.g., at T1-tier switch) to receive an optical transceiver OT. The optical transceiver OT can plug into the OSFP on the spine switches and can be paired to duplex LC connectors that interface to the LC-based OCS via MPO-to-LC breakouts in the hub racks.

In some embodiments, the optical transceiver OT is configured to compensate for an OCS insertion loss. The OCS insertion loss compensation can be 3 dB, or less than 3 dB. For example, the OSFP LR4 optical transceiver can be built to a higher spec to compensate for the OCS signal loss. Manufacturers can build versions of LR4 modules strong enough to handle 3 dB loss. In some embodiments, the optical transceiver OT can include an OSFP module 3210 and an LR4 optic 3212, and an OCS insertion loss compensator 3215. In some embodiments, the OCS compensator 3215 can be configured to control operating parameters of the LR4 optic to compensate for up to 3 dB loss. In some embodiments, the compensation can be achieved by increasing the intensity of light source at the transceiver, increasing sensitivity of the receiver, or a combination of thereof.

In some embodiments, the OSFP module 3210 is a hot-pluggable optical transceiver form factor designed for high aggregate data rates (for example, 400 Gbps and 800 Gbps) that integrates optical engines, driver/receiver electronics, and standardized electrical host interfaces into a single replaceable unit. The OSFP module 3210 supports direct attachment to single-mode fiber via standardized connector interfaces (for example, duplex LC), provides thermal management compatible with high-power optics, and exposes a digital management interface for control, telemetry, and diagnostics suitable for carrier and data center environments. In some embodiments, the LR4 optic 3212 denote a class of single-mode optical interfaces that multiplex four optical wavelengths (e.g., around spaced around 1310 nm) to transport aggregated electrical lanes over duplex fiber with long-reach performance (commonly up to approximately 10 km), using duplex LC connectors and standardized electrical host interfaces. In the present disclosure standard 2 km FR4 optics may be insufficient for the datacenter that can spans approximately 6 km, and off-the-shelf 10 km LR4 optics may not satisfy the end-to-end loss budget associated with OCS insertion loss (about 3 dB). Hence, the optical transceiver OT herein can be configured to satisfy the end-to-end loss budget over 6 km distance with OCS insertion loss compensation (e.g., 3 dB). The optical transceiver OT may be modified by modestly increasing launch power and improving receiver sensitivity (for example, on the order of roughly 3 dB of additional margin) while retaining OSFP mechanical and electrical compatibility and duplex LC interfaces, thereby achieving robust inter-building links that traverse the OCS fabric.

In some embodiments, the spine switches SS within a building can be connected to OSE via a bank of patch panels. From the patch panels, cabling 3221 from the spine switches SS to the patch panels PP can include MPO/MMC connectors at opposite ends. Cabling 3222 can extend from the patch panel PP to OSE. The cabling 3222 can include fiber optics cables with a connector at patch panel end, and spliced at an OSE end.

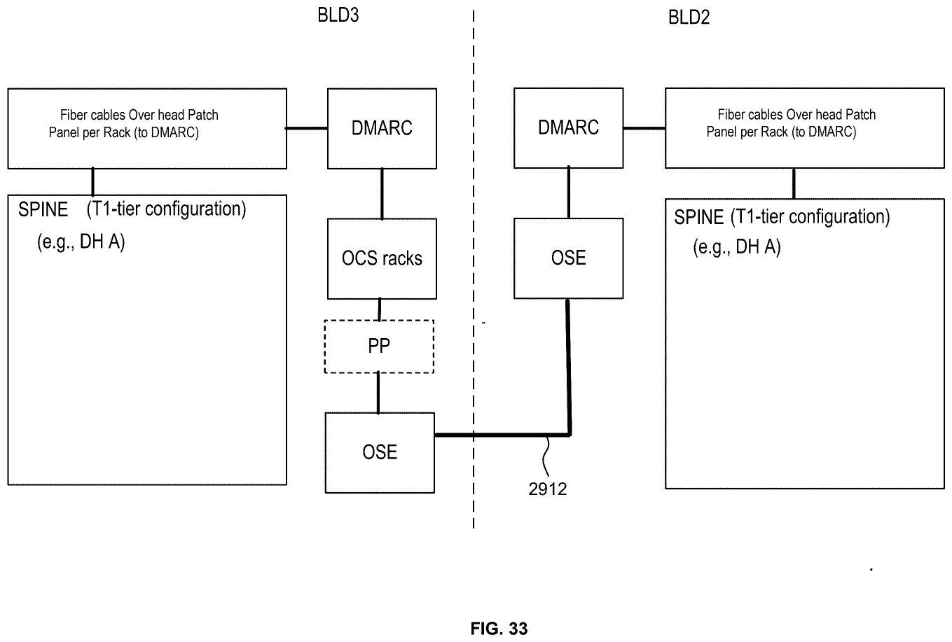

FIG. 33 illustrates an example cabling path between T1-tier switches using an optical circuit switch and patch panels. In the illustrated embodiments, a demarcation panel DMARC can be provided inside a building to terminate and organize incoming fiber trunks from OSE or OCS. The demarcation panel can be similar to a passive fiber patch panel. The demarcation panel DMARC presents serviceable connector ports for short jumper connections to equipment such as OCS or spine switch racks. In the present disclosure, the demarcation panel DMARC may be employed when the distance between the OSE and the OCS requires an intermediate termination point for fiber management, allowing technicians to land higher-count trunks on the panel and then complete the run to the OCS with short LC jumpers. The demarcation DMARC panel functions as a structured interface that improves fiber routing, bend radius control, labeling, and serviceability.

In some embodiments, the banks of such OCS racks may be deployed alongside passive racks that provide the fiber connectivity between the OCS and the OSE. The passive racks can function as patch panel PP racks for trunk aggregation and breakouts that feed the LC-based OCS ports. Where the OSE-to-OCS path is short or where trunk routing would be impractical directly into the OCS row, an LC-LC panel can be placed between the OSE aggregation (e.g., MPO/MMC panels) and the OCS, so that long runs are terminated and strain-relieved at the panel and only short LC jumpers are routed into the OCS racks.

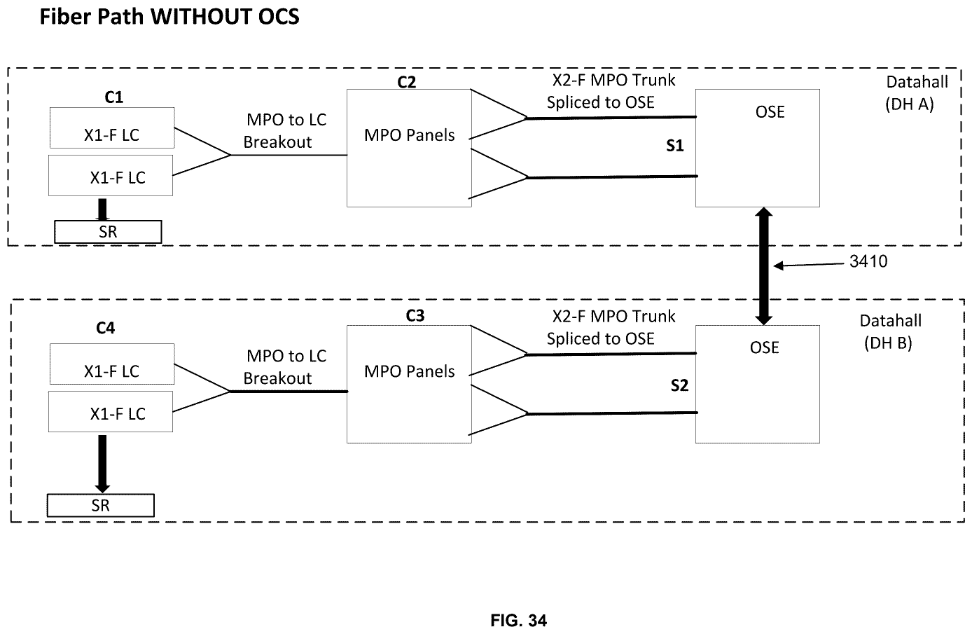

FIG. 34 illustrates an example cabling path between spine racks SR within the datahall DH A and spine racks SR within the datahall DH B using MPO/MMC panels and without using an optical circuit switch. In FIG. 34, connection points are represented by labels C1, C2, C3, and C4. Within each data hall (for example, DH A or DH B), a fiber path between the spine racks SR and the building's optical splice enclosure OSE is segmented into two serviceable connection points: a first connection point C1 near the spine racks and a second connection point C2 that aggregates multiple LC circuits into MPO/MMC trunks for handoff toward the OSE. This segmentation balances equipment-side serviceability with low-loss, high-count trunking to the building demarcation for inter-building splicing.

In some embodiments, equipment-side interfaces are LC because the OCS-facing transceivers installed in OSFP cages on the spine switches in the spine racks SR use duplex LC pairs. While upstream aggregation at the second connection point C2 leverages MPO/MMC panels to collect many LC pairs into higher-count MPO/MMC trunks that run to the OSE for mass splicing into very high-count bulk cables.

In some embodiments, the first connection point C1 is an LC-based connection zone positioned adjacent to the spine racks SR, and where short LC jumpers from OCS-facing OSFP transceivers are landed and organized before aggregation. This first connection point C1 localizes connectorized interfaces to the equipment row, easing moves, adds, changes, inspection, or cleaning routines associated with LC terminations. In some embodiments, for the first connection point C1, fiber trunks X1-F may be used. The fiber trunks X1-F may include 144 fibers, or other number of fibers.

In some embodiments, the second connection point C2 is an aggregation zone that receives the LC fibers from the first connection point C1 and consolidates them onto MPO/MMC panels. At the second connection point C2, LC pairs are transitioned to MPO/MMC harnesses in groupings (for example, eight-fiber or sixteen-fiber ferrules), which are then organized for handoff onto larger-count MPO/MMC trunks. This LC-to-MPO/MMC transition simplifies high-density fiber management and prepares cabling for efficient mass splicing at the building demarcation. From the second connection point C2, multiple MPO/MMC harnesses are consolidated into higher-count trunks X2-F (e.g., 288-fiber MPO/MMC trunks), sized for structured termination and transport from the equipment row to the OSE. This step replaces large numbers of individual LC runs with a small number of multi-fiber cables, significantly improving routing, labeling, and serviceability. MPO/MMC aggregation at the second connection point C2 also reduces field labor during installation and changes by enabling sixteen-fiber splicing increments downstream, rather than two-fiber (LC-pair) increments.

In some embodiments, from the second connection point C2, the fiber MPO/MMC trunks X2-F run to the OSE, where they are mass-spliced S1 into very high-count bulk cables 3410 (e.g., 6,912-strand trunks) that form the building-to-hub or building-to-building cabling infrastructure. As an example, the OSE houses splice trays that organize splicing in sixteen-fiber increments, making it practical to mate twenty-four 288-fiber trunks to a single 6,912-strand bulk cable.

In the second datahall DH B, the fourth connection point C4 and the third connection point C3 are similar to the first connection point C1, and the second connection point C2, respectively. Cable paths and aggregations related to C4 and C3 are same as above, hence omitted here for brevity.

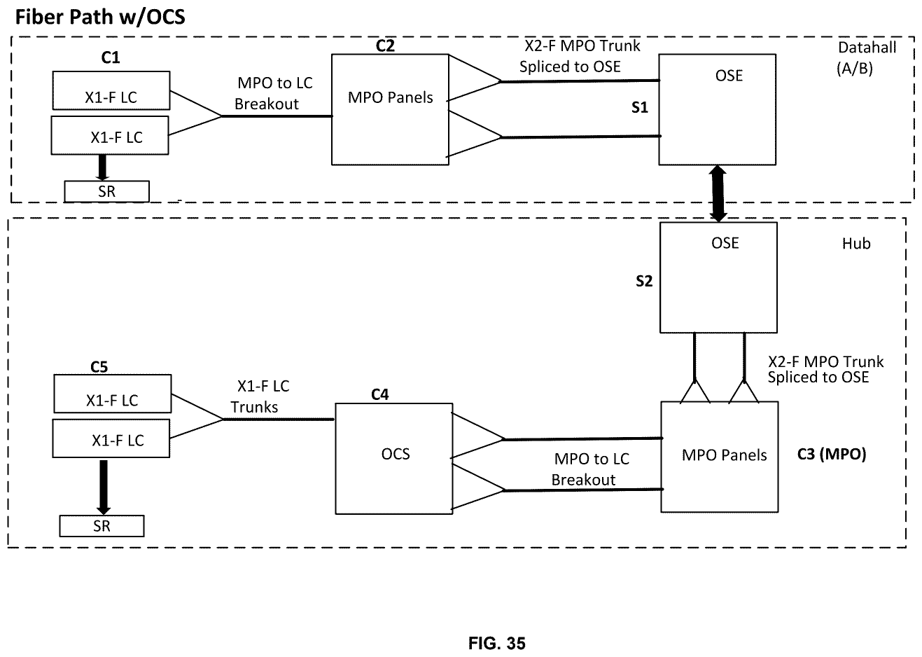

FIG. 35 illustrates an example cabling path between T1-tier switches using MPO/MMC panels and without using an optical circuit switch OCS. Similar to FIG. 34, the cabling architecture within a datahall DHA of a building can include the first connection point C1, the second connection point C2, and OSE. The cabling and aggregation related discussion is same as that discussed with FIG. 34, hence omitted here for brevity.

The cabling architecture within the hub i.e., a building with the OCS includes OSE, a third connection point C3, a fourth connection point C4, and a fifth connection point C5. The third connection point C3 can be same as the second connection point C2, as discussed above. Furthermore, the cabling between OSE and the connection point C3 can be same as between the connection point C2 and OSE, as discussed above. The fourth connection point C4 is the OCS connection, which receives the mapping from API, as discussed above+. The fifth connection point C5 can be located near the spine rack SR, similar to the first connection point C1.

The cabling between the third connection point C3 and the OCS can be similar as that between the first connection point C1 and the second connection point C2, as discussed above. The cabling between the third connection point C3 and the OCS can be implemented as an MPO-to-LC transition followed by short LC jumper runs into the LC-based front-panel ports of the OCS. For example, X2-fiber MPO/MMC trunks arriving from the OSE are landed on MPO/MMC aggregation panels at the third connection point C3. Further, MPO-to-LC breakout harnesses present duplex LC pairs that correspond one-to-one with OCS ports. Each LC pair is then connected to the OCS with short LC-to-LC jumpers. Cable management features (e.g., strain relief, labeling, bend-radius control, and slack storage) can be applied to maintain serviceability and optical performance at scale. In illustrated embodiment, LC breakouts at C3 may be organized in groups of eight or sixteen fibers to align with MPO/MMC ferrule counts, simplifying high-density fanout and enabling deterministic mapping of building-associated fibers to designated OCS port groups. Each LC-connected OCS port remains a duplex interface used to form bidirectional T1-tier connections under control of the connection mapping established via the API.

The cabling between the OCS and the fifth connection point C5 (located proximate to the spine racks SR) can be implemented as direct LC-to-LC runs. Each OCS duplex LC port can be connected via a short LC jumper to an LC presentation at the fifth connection point C5 for equipment-side termination. At the fifth connection point C5, the LC pairs are aligned to the spine-port plan so that short LC-to-LC jumpers can mate directly into OSFP cages on the T1-tier spine switches, preserving a uniform LC interface on the equipment side.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Various embodiments of this disclosure are described herein, including the best mode known for carrying out the disclosure. Variations of those embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Based on the disclosure and teachings provided herein, a person of ordinary skill in the art will appreciate other ways and/or methods to implement the various embodiments. The specification and drawings are, accordingly, to be regarded in an illustrative rather than a restrictive sense. It will, however, be evident that various modifications and changes may be made thereunto without departing from the broader spirit and scope of the disclosure as set forth in the claims.

What is claimed is:

1. A method for building a datacenter, the method comprising:
providing, in a first datahall DH1, a location for a first set of computing devices;
providing, in a second datahall DH2, a location for a second set of computing devices, the second datahall DH2 being isolated from the first datahall DH1, routing a first set of cabling trunks along a first predefined path extending within the first datahall DH1, between the first datahall DH1 and the second datahall DH2, and within the second datahall DH2, wherein the first set of cabling trunks convey cables for connecting the first set of computing devices within the datahall DH1 and the second set of computing devices within the datahall DH2;
providing, in a third datahall DH3, a location for a third set of computing devices, the third datahall DH3 being isolated from the first datahall DH1 and the second datahall DH2;
routing a second set of cabling trunks along a second predefined path extending within the third datahall DH3, between the first datahall DH1 and the third datahall DH3, and within the datahall DH1, wherein the second set of cabling trunks convey cables for connecting the first set of computing devices and the third set of computing devices; and
routing a third set of cabling trunks along a third predefined path extending within the third datahall DH3, between the second datahall DH2 and the third datahall DH3, and within the second datahall DH2, wherein the third set of cabling trunks convey cables for connecting the second set of computing devices and the third set of computing devices.

2. The method of claim 1, further comprising:
providing, in a fourth datahall DH4, a location for a fourth set of computing devices, the fourth datahall DH4 being isolated from the first datahall DH1, the second datahall DH2, and the third datahall DH3;
routing a fourth set of cabling trunks along a fourth predefined path extending within the fourth datahall DH4, between the first datahall DH1 and the fourth datahall DH4, and within the first datahall DH1, wherein the fourth set of cabling trunks convey cables for connecting the first set of computing devices and the fourth set of computing devices; and
routing a fifth set of cabling trunks along a fifth predefined path extending within the fourth datahall DH4, between the second datahall DH2 and the fourth datahall DH4, and within the second datahall DH2, wherein the fifth set of cabling trunks convey cables for connecting the first set of computing devices and the fourth set of computing devices.

3. The method of claim 1, wherein each of the first set of cabling trunks, the second set cabling trunks, and the third set of cabling trunks comprises:
at least one set of fiber optic cables spliced together to form a single cabling.

4. The method of claim 3, wherein each of the first set of cabling trunks, the second set cabling trunks, and the third set of cabling trunks comprises:
an outside cable portion of the single cabling that extends in an outside space between two datahalls of the datahalls DH1 through DH3 is inaccessible and secured within a closed conduit, the outside cable portion comprising higher fiber count than fiber count of each of the first set of cabling trunks, the second set of cabling trunks, and the third set of cabling trunks.

5. The method of claim 1, further comprising:
providing (i) a first set of leaf switches (T0-tier) within a first location adjacent to the location of the first set of computing devices, and (ii) a first set of spine switches (T1-tier) within a second location adjacent to the location of the first set of leaf switches within the first datahall DH1;
providing (i) a first set of network cables connected to the first leaf switches and extending to the location of the first set of computing devices, and (ii) a second set of network cables connected to the first leaf switches and extending to the location of the first set of spine switches;
providing (i) a second set of leaf switches (T0-tier) within a first location adjacent to the location of the second set of computing devices, and (ii) a second set of spine switches (T1-tier) within a second location adjacent to the location of the second set of leaf switches within the second datahall DH2; and
providing (i) a third set of network cables connected to the second leaf switches and extending to the location of the second set of computing devices, and (ii) a fourth set of network cables connected to the second leaf switches and extending to the location of the second set of spine switches.

6. The method of claim 5, wherein:
the first set of leaf switches are distributed within a first plurality of network fabric plane in the first datahall DH1, wherein the first plurality of network fabric planes comprises at least 4 planes;
the first set of spine switches are distributed within a second plurality of network fabric planes within the first datahall DH1, wherein the second plurality of network fabric plane comprises at least 8 planes;
the second set of leaf switches are distributed within the first plurality of network fabric planes in the second datahall DH2; and
the second set of spine switches are distributed within the second plurality of network fabric planes in the second datahall DH2,
wherein leaf switches in each plane is connected to spine switches in eight planes.

7. The method of claim 6, wherein:
each computing device of the first set of computing devices is connected to at least two leaf switches of the first set of leaf switches in two different planes of the first plurality of network fabric planes;
each leaf switch of the first set of leaf switches is connected to at least two spine switches of the first set of spine switches within the same plane of the second plurality of planes;
each computing device of the second set of computing devices is connected to at least two leaf switches of the second set of leaf switches in two different planes of the first plurality of network fabric planes; and
each leaf switch of the second set of leaf switches is connected to at least two spine switches of the second set of spine switches within the same plane of the second plurality of planes.

8. The method of claim 5, further comprising:
connecting a first subset of the first set of cabling trunks to the first set of leaf switches in the first datahall DH1 with the second set of spine switches in the second datahall DH2 thereby establishing a networked connection between the first set of computing devices in the first datahall DH1 and the second set of computing devices in the second datahall DH2; and
connecting a second subset of the first set of cabling trunks to the second set of leaf switches in the second datahall DH2 with the first set of spine switches in the first datahall DH1 thereby establishing another networked connection between the first set of computing devices in the first datahall DH1 and the second set of computing devices in the second datahall DH2.

9. The method of claim 1, further comprising:
providing a third set of leaf switches (T0-tier) within the third datahall DH3; and
providing a fifth set of network cables connected to the third leaf switches and extending to the location of the third set of computing devices.

10. The method of claim 7, further comprising:
connecting the second set of cabling trunks to the first set of spine switches in the first datahall DH1 with the third set of leaf switches in the third datahall DH3 thereby establishing a networked connection between the first set of computing devices in the first datahall DH1 and the third set of computing devices in the second datahall DH3;
connecting the third set of cabling trunks to the second set of spine switches in the second datahall DH2 with the third set of leaf switches in the third datahall DH3 thereby establishing a networked connection between the second set of computing devices in the second datahall DH2 and the third set of computing devices in the second datahall DH3.

11. A datacenter comprising:
a first datahall DH1 including a location for a first set of computing devices;
a second datahall DH2 including a location for a second set of computing devices, the second datahall DH2 being isolated from the first datahall DH1;
a first set of cabling trunks along a first predefined path extending within the first datahall DH1, between the first datahall DH1 and the second datahall DH2, and within the second datahall DH2, wherein the first set of cabling trunks convey cables for connecting the first set of computing devices within the datahall DH1 and the second set of computing devices within the datahall DH2;
a third datahall DH3 including a location for a third set of computing devices, the third datahall DH3 being isolated from the first datahall DH1 and the second datahall DH2;
a second set of cabling trunks along a second predefined path extending within the third datahall DH3, between the first datahall DH1 and the third datahall DH3, and within the datahall DH1, wherein the second set of cabling trunks convey cables for connecting the first set of computing devices and the third set of computing devices; and
a third set of cabling trunks along a third predefined path extending within the third datahall DH3, between the second datahall DH2 and the third datahall DH3, and within the second datahall DH2, wherein the third set of cabling trunks convey cables for connecting the second set of computing devices and the third set of computing devices.

12. The datacenter of claim 11, wherein each of the first set of cabling trunks, the second set cabling trunks, and the third set of cabling trunks comprises:
at least one set of fiber optic cables spliced together to form a single cabling.

13. The datacenter of claim 12, wherein each of the first set of cabling trunks, the second set cabling trunks, and the third set of cabling trunks comprises:
an outside cable portion of the single cabling that extends in an outside space between two datahalls of the datahalls DH1 through DH3 is inaccessible, wherein the outside cable portion passes through a closed conduit, the outside cable portion comprising higher fiber count than fiber count of each of the first set of cabling trunks, the second set of cabling trunks, and the third set of cabling trunks.

14. The datacenter of claim 11, wherein:
the first datahall DH1 further comprises:
a first set of leaf switches (T0-tier) within a first location adjacent to the location of the first set of computing devices;
a first set of spine switches (T1-tier) within a second location adjacent to the location of the first set of leaf switches within the first datahall DH1;
a first set of network cables connected to the first leaf switches and extending to the location of the first set of computing devices; and
a second set of network cables connected to the first leaf switches and extending to the location of the first set of spine switches; and
the second datahall DH2 further comprises:
a second set of leaf switches (T0-tier) within a first location adjacent to the location of the second set of computing devices;
a second set of spine switches (T1-tier) within a second location adjacent to the location of the second set of leaf switches within the second datahall DH2;
a third set of network cables connected to the second leaf switches and extending to the location of the second set of computing devices; and
a fourth set of network cables connected to the second leaf switches and extending to the location of the second set of spine switches.

15. The datacenter of claim 14, wherein:
the first set of leaf switches are distributed within a first plurality of network fabric plane in the first datahall DH1, wherein the first plurality of network fabric planes comprises at least 4 planes;
the first set of spine switches are distributed within a second plurality of network fabric planes within the first datahall DH1, wherein the second plurality of network fabric plane comprises at least 8 planes;
the second set of leaf switches are distributed within the first plurality of network fabric planes in the second datahall DH2; and
the second set of spine switches are distributed within the second plurality of network fabric planes in the second datahall DH2,
wherein leaf switches in each plane is connected to spine switches in eight planes.

16. The datacenter of claim 15, wherein:
each computing device of the first set of computing devices is connected to at least two leaf switches of the first set of leaf switches in two different planes of the first plurality of network fabric planes;
each leaf switch of the first set of leaf switches is connected to at least two spine switches of the first set of spine switches within the same plane of the second plurality of planes;
each computing device of the second set of computing devices is connected to at least two leaf switches of the second set of leaf switches in two different planes of the first plurality of network fabric planes; and
each leaf switch of the second set of leaf switches is connected to at least two spine switches of the second set of spine switches within the same plane of the second plurality of planes.

17. The datacenter of claim 15, further comprises a network fabric comprising a single patch point between a first set of leaf switches and a first set of spine switches.

18. The datacenter of claim 14, further comprising:
a first subset of the first set of cabling trunks connected to the first set of leaf switches in the first datahall DH1 and the second set of spine switches in the second datahall DH2 thereby establishing a networked connection between the first set of computing devices in the first datahall DH1 and the second set of computing devices in the second datahall DH2; and
a second subset of the first set of cabling trunks connected to the second set of leaf switches in the second datahall DH2 with the first set of spine switches in the first datahall DH1 thereby establishing another networked connection between the first set of computing devices in the first datahall DH1 and the second set of computing devices in the second datahall DH2.

19. The datacenter of claim 11, wherein
the third datahall DH3 comprises:
a third set of leaf switches (T0-tier) within the third datahall DH3; and
a fifth set of network cables connected to the third leaf switches and extending to the location of the third set of computing devices.

20. The method of claim 19, further comprising:
the second set of cabling trunks connected to the first set of spine switches in the first datahall DH1 with the third set of leaf switches in the third datahall DH3 thereby establishing a networked connection between the first set of computing devices in the first datahall DH1 and the third set of computing devices in the second datahall DH3; and
the third set of cabling trunks connected to the second set of spine switches in the second datahall DH2 with the third set of leaf switches in the third datahall DH3 thereby establishing a networked connection between the second set of computing devices in the second datahall DH2 and the third set of computing devices in the second datahall DH3.

21. The datacenter of claim 11, further comprises the cabling within each of the datahalls DH1, DH2, DH3 is configured to have the same installation design for both north-south connectivity direction, and east-west connectivity direction.

22. The datacenter of claim 11, further comprises at least one computing device, wherein, the at least one computing device includes one or more of: Graphic Process Unit (GPU), central processing unit (CPU), Tensor Processing Unit (TPU), SoC (System on a Chip), or any combination thereof.
